(19) United States
(12) Patent Application Publication
(10) Pub. No.: US 2017/0295783 A1
(43) Pub. Date: Oct. 19, 2017

(54) COMPOSITIONS AND METHODS TO SELECTIVELY CONTROL SPECIES

(71) Applicant: STEPHEN F. AUSTIN STATE UNIVERSITY, Nacogdoches, TX (US)

(72) Inventors: Shiyou LI, Nacogdoches, TX (US); Ping WANG, Nacogdoches, TX (US); Wei YUAN, Nacogdoches, TX (US); Zushang SU, Nacogdoches, TX (US); Steven H. BULLARD, Nacogdoches, TX (US)

(21) Appl. No.: 15/523,576

(22) PCT Filed: Nov. 3, 2015
(86) PCT No.: PCT/US15/58817

§ 371 Date: May 1, 2017

Related U.S. Application Data
(60) Provisional application No. 62/074,426, filed on Nov. 3, 2014.

(51) Int. Cl. A01N 35/02; A01N 65/18; A01N 65/04; A01N 35/06; A01N 65/03; A01N 43/20; A01N 65/40; A01N 65/06

(52) U.S. Cl. CPC A01N 35/02; A01N 65/40; A01N 65/18; A01N 65/06; A01N 35/06; A01N 65/03; A01N 43/20; A01N 65/04

(57) ABSTRACT

Methods and compositions for controlling an invasive or unwanted species by application of a composition comprised of an endocide derived from the same species or a closely-related species.

### BACKGROUND OF THE INVENTION

### 1. Field of the Invention

The present invention relates generally to the fields of biology and chemistry. More particularly, it concerns compositions and methods for controlling an unwanted species via processes of elimination, inhibition, and prevention by endocides.

### 2. Description of Related Art

Invasive species have caused significant environmental, economic, and human health problems, particularly loss of native ecosystems and biodiversity and major economic losses in agriculture, forestry, and fishery and wildlife management. Invasive species are major threats to agriculture, natural environments, and public health (Ascunce, et al., 2011). Conventional pesticide and biological and mechanical control methods of invasive species are costly and either ineffective or not environmentally friendly. These methods are used to primarily eliminate and sometimes inhibit the growth and reproduction of the invasive species but have no prevention function.

In a recent patent application (PCT/US2014/0036837), the inventors described the application of endocides to control invasive species by using five of the most aggressive and noxious species in the southeastern United States as representative of different groups of invasive species: giant salvinia (Salvinia molesta D. S. Mitchell) (family Salviniaceae) from the phylum Pteridophyta (ferns) of the kingdom Plantae; two flowering plant species—Brazilian pepper tree (Schinus terebinthifolius Raddi) (family Anacardiaceae) from the order Sapindales and Chinese tallow (Triadica sebifera (L.) Small) (family Eurphorbiaceae) from the order Malpighiales of the phylum Anthophyta (flowering plants, angiosperms) of the kingdom Plantae; and two insect species—the red imported fire ant (Solenopsis invicta Buren) (family Formicidae) from the superorder Endopterygota and the subterranean termite (Reticulitermes flavipes (Kollar)) (family Rhinotermitidae) of superorder Exopterygota of the phylum Arthropoda of the kingdom Animalia. Of these species, giant salvinia is an aquatic species and the others are terrestrial species. The invasive species described therein were species that were either native or non-native (exotic) to the ecosystem and whose presence or introduction causes or likely causes economical or environmental harm or harm to human health.

### SUMMARY OF THE INVENTION

The inventors herein disclose solutions to the problems associated with conventional pesticide and biological and mechanical control methods of invasive or unwanted species. The solutions include methods and compositions for controlling an invasive and/or unwanted species by application of a composition comprising an endocide derived from the same species or a closely-related species. In some instances, the disclosed methods and compositions eliminate, inhibit, and/or prevent growth, reproduction, and/or spread of a target species. In some instances, the disclosed methods and compositions eliminate, inhibit, and/or prevent growth, reproduction, and/or spread of multiple target species by application of a mixture of endocides from these species and/or their closely related species. These methods and compositions can be selective for a single species or a species and closely-related species. In some instances, the single species can be the species from which the endocide is derived. The methods and compositions disclosed herein are cost effective, easily produced, and/or environmentally friendly.

In some embodiments, prevention of an invasive or unwanted species is achieved through enhancing the endocidal concentration in a system (e.g., a body or part of water, soil, or other physical system) by accumulating adequate amounts of dead individuals or tissues of the organism or its closely-related species. In some embodiments, prevention of invasive or unwanted species is achieved through enhancing its endocidal concentration in a system by reducing the population of associated non-closely related species that have antidotal action on the endocidal effects on the producing species or its closely-related species. In some embodiments, prevention of invasive or unwanted species is achieved through enhancing its endocidal concentration in a system by external application of endocide.

In some embodiments, provided are methods of controlling an invasive or unwanted species comprising applying a composition comprising an endocide to the invasive or unwanted species, wherein the endocide is derived from an invasive or unwanted species. Any measure of decreased growth or reproduction of the invasive or unwanted species is contemplated. In some embodiments, the growth of the invasive or unwanted species may be slowed or halted. In some embodiments, the invasive or unwanted species may be eliminated. In some embodiments, the reproduction of the invasive or unwanted species may be inhibited. In some embodiments, viability of propagules may be reduced or lost. In some embodiments, the growth or reproduction of the invasive or unwanted species is halted within 1, 2, 3, 4, 5, 6, 7 days, 1, 2, 3, 4, or 5 weeks, 1, 2, 3, 4, 5, 6, 7, 8, 9, 10, 11, or 12 months or more. In some embodiments, the growth or reproduction of the invasive or unwanted species is halted within 1 week or 1 month. In some embodiments, the growth or reproduction of the invasive or unwanted species is halted for at least 1, 2, 3, 4, or 5 weeks, 1, 2, 3, 4, 5, 6, 7, 8, 9, 10, 11, or 12 months, 1, 2, 3, 4, 5, 6, 7, 8, 9, 10 years or more. In some embodiments, the growth or reproduction of the invasive or unwanted species is halted for at least 1 year.

In some embodiments, the endocide may be a natural pesticide. In some embodiments, the endocide is not a pesticide. An endocide (endogenous biocide) is a biocide derived from an endogenous bioactive agent (e.g., a secondary metabolite) that does not cause apparent poison during normal growth of the producing species but will poison or inhibit and even eliminate the parent species when induced in the producing species. It can selectively eliminate the parent species (and possibly its closely-related species) when externally applied. The dead tissues of the species caused by an endocide will enhance the endocidal function to the species. The endocide may have effects especially in species with glands which act as accumulation sites of autotoxic chemicals. The endocide may have effects especially in herbicide-, pesticide-, or drug-resistant species. An endocide may have effects in all or some growth stages of the species (e.g., primary, secondary, and tertiary stages) and in all or selective tissues (e.g., vegetative or reproductive tissues).

In some embodiments, the endocide is a compound isolated from the invasive or unwanted species to be controlled. In some embodiments, the endocide is an extract from the species of invasive or unwanted species to be controlled. In some embodiments, the endocide is a fraction of extract from the invasive or unwanted species to be controlled. In some embodiments, the endocide is a liquid part or water extracts from the invasive or unwanted species to be controlled. In some embodiments, the endocide is dry matter from the invasive or unwanted species to be controlled. In some embodiments, the endocide is fresh matter from the invasive or unwanted species to be controlled. In some embodiments, the endocide is the combination of two or more endocides from the different invasive or unwanted species to be controlled. The endocide “derived from a species” may be any composition or compound originally obtained from a species, even if further modified. It also encompasses synthetic compounds that are equivalent to the compounds derived from the species or derivatives thereof.

In some embodiments, the endocide is derived from a second species. In some embodiments, the second species is a closely-related species. In some embodiments, the endocide is a compound isolated from the second species.

The endocide may be any appropriate material. In some embodiments, the endocide is dry, fresh, or decomposed matter. In some embodiments, the endocide is a liquid part or water extracts from fresh or decomposed matter thereof. In some embodiments, the endocide is an extract or fraction thereof. In some embodiments, the extract is an aqueous or organic extract or fraction thereof. In some embodiments, the extract is a dry or solubilized extract. In some embodiments, the endocide is dry matter. In some embodiments, the intact dry matter is used for production of the endocide. In some embodiments, the dry matter is ground or processed. In some embodiments, the endocide is a concentrated extract or fraction from dry matter. In some embodiments, the endocide is fresh matter. In some embodiments, the intact fresh matter is used for production of the endocides. In some embodiments, the fresh matter is chopped or blended.

In some embodiments, the endocide is an extract or liquid part or water extracts obtained directly from chopped, blended, or/and expressed fresh or decomposed matter. In some embodiments, the endocide is a diluted extract or liquid part or water extracts from chopped, blended, or/and expressed fresh or decomposed matter. In some embodiments, the endocide is a compound isolated from the species of invasive species to be controlled. In some embodiments, the endocide is a compound isolated from a second species of invasive or unwanted species.

In some embodiments, the endocide is ground dried matter in a water-penetrating bag. In some embodiments, the bag material is fabric, nylon, plastic, compostable, or biodegradable. In some embodiments, the endocide is ground dried species matter in compressed form (e.g., compressed brick or pie (“tea brick”)) without a bag. The tea brick can be prepared under appropriate moisture (7-15%), temperature (50-90° C.), and pressure (250-500 kPa). It may float around or on the surface of the invasive or unwanted species to be controlled and may break down and dissolve in the water within a few minutes after contact with water is made. It may mix with local soils to prepare a sinkable tea brick which can contact water quickly and be more effective.

In some embodiments, production of extract from the dried species matter may include processes of fresh or decomposed matter collection of harvest, drying, grounding, extraction, filtration, concentrating, formula preparation, and spray or injection application. In some embodiments, extraction is aqueous or organic solvent extraction, distillation, infusion, decoction, or percolation.

In some embodiments, production of extract or liquid part or water extracts from fresh species matter may include the processes of fresh or decomposed matter collection or harvest, shredding or pulping, extraction, filtration, formula preparation, and spray application. In some embodiments, extraction is an expression method (e.g., hydraulic pressing, screw pressing, expeller pressing, sponge expression, abrasion, and Écuelle á piquer).

In some embodiments, the endocide is applied in its natural form. In some embodiments, the endocide is modified or derived from its natural form. In some embodiments, the endocide is applied in the form of nanomaterial developed by nanotechnology.

In some embodiments, the natural pesticide is a compound of formula:

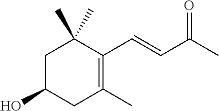

In some embodiments, the natural pesticide is 5,6,7,8-tetramethoxycoumarin.

The endocide may have selective activity against the invasive or unwanted species to be controlled over other non-closely related species. In some embodiments, the endocide may have selective activity against the invasive or unwanted species to be controlled and its closely-related species over other non-closely related species. In some embodiments, the closely-related species is a species within the same genus (e.g., in phylum Coniferophyta (gymnosperms) or Anthophyta (angiosperms)). In some embodiments, the closely-related species is a species within the same family. In some embodiments, the closely-related species is a species within the same order (e.g., in phylum Pteridophyta (ferns and allied plants)). In some embodiments, the closely-related species is a species within the same class. In some embodiments, the closely-related species is a species within the same phylum (e.g., in phylum Brophyta (mosses)). In some embodiments, the closely-related species is a species of different phylum with the producing species (e.g., in green algal species of phylum Chlorophyta or Charophyta). In some embodiments, a composition comprising the endocide can eliminate or inhibit the invasive or unwanted species. In some embodiments, a composition comprising the endocide can eliminate or inhibit the invasive or unwanted species and its closely-related species (e.g., a species of the same order) of the invasive or unwanted species. In some embodiments, a composition comprising the endocide does not inhibit or slightly inhibit a native species that is not in the genus, family, order, class, or phylum of the invasive or unwanted species. In some embodiments, a composition comprising the endocide does not inhibit or slightly inhibit an invasive or unwanted species that is not in the genus, family, order, class, or phylum of the invasive or unwanted species.

In some embodiments, the efficacy and selectivity of the endocide may be improved or enhanced by combination of two or more endocides from the same and/or different invasive or unwanted species to be controlled.

In some embodiments, elimination of species other than the target species in an environment that contains more than one species may improve the endocide's control and/or preventing effects of re-growth of an target species in the environment.

The invasive or unwanted species may be any appropriate invasive or unwanted plant and fungus.

In some embodiments, the invasive or unwanted plant or fungus is an aquatic species. In some embodiments, the invasive or unwanted aquatic species is Alternanthera acaulis Andersson, A. adscendens Suess., A. albida (Moq.) Griseb., A. albosquarrosa Suess., A. albotomentosa Suess., A. altacruzensis Suess., A. aniospoda Standl., A. aquatica (Parodi) Chodat, A. arequipensis Suess., A. areschougii R.E. Fr., A. aristata (Danguy & Cherm.) Suess., A. asterotricha Uline, A. aurata Moq., A. austrotrinitatis (Suesseng.) Pedersen, A. bahiensis Pedersen, A. bettzickiana (Regel) G.Nicholson, A. bettzickiana (Regel) Standl., A. boliviana Rusby, A. brasiliana (L.) Kuntze, A. brasiliana var. brasiliana, A. broadwayi Standl., A. calcicola Standl., A. cana Suess., A. canescens Kunth, A. capituliflora (Bertero) Schinz, A. caracasana Kunth, A. caribaea Moq., A. chacoensis Morong, A. cinerella Suess., A. collina Pedersen, A. congesta Suess. & O. Stützer, A. cordobensis (Standl.) Standl., A. coriacea Herzog, A. corymbiformis Eliasson, A. costaricensis Kuntze,A. crassifolia (Standl.) Alain, A. crucis (Moq.) Bold., A. decurrens J. C.Siqueira, A. dendrotricha C. C.Towns., A. dominii Schinz, A. dubia Kunth, A. dunaliana Griseb., A. echinata Fisch. & C. A.Mey., A. echinocephala (Hook.f.) Christoph., A. elegans Moq., A. erecta Rchb. ex Moq., A. eupatorioides Remy, A. fasciculata Suess., A. fastigiata Suess., A. felipponei Beauverd, A. ficoidea (L.) Sm., A. ficoidea f. aberrans (Pedersen) Pedersen, A. ficoidea subsp. chacoensis (Morong) Pedersen, A. ficoidea subsp. pilosa (Moq.) Pedersen, A. ficoidea f. pilosa (Moq.) Pedersen,A. filaginoides Desv. ex Ham., A. filifolia (Hook.f.) J. T. Howell, A. filifolia subsp. filifolia, A. flava (L.) Mears,A. flavescens Kunth,A. flavicoma (Andersson) J. T.Howell, A. flavida Suess., A. flosculosa J. T. Howell, A. frutescens (L'Hér.) R. Br. ex Spreng., A. galapagensis (A.Stewart) J. T. Howell, A. geniculata Urb., A. glauca (Mart.) Hosseus, A. glaucescens (Hook.f.) J. T. Howell, A. glaziovii R. E. Fr., A. gomphrenoides Kunth, A. gracilis M. Martens & Galeotti, A. grandis Eliasson, A. halimifolia (Lam.) Standl. ex Pittier, A. helleri (B. L.Rob.) J. T. Howell, A. herniarioides Beurl., A. hirtula (Mart.) R. E. Fr., A. inaccessa Pedersen, A. ingramiana (Standl.) Schinz, A. januarensis J. C. Siqueira, A. kuntheana Klotzsch, A. kuntzii Schinz, A. kuntzii Schinz ex Pedersen, A. lactea Hieron., A. laguroides (Standl.) Standl., A. lanceolata (Benth.) Schinz, A. lanuginosa (Nutt.) Moq., A. laxa Suess., A. linearis Bello, A. longipes (Moq.) Benth., A. losseni Burret, A. lupulina Kunth, A. macbridei Standl., A. macrorhiza Hauman, A. malmeana R. E. Fr., A. maritima (Mart.) A. St.-Hil., A. maritima var. sparmannii (Moq.) Mears, A. markgrafii Suess., A. martii (Moq.) R. E. Fr., A. mexicana Moq., A. micrantha R. E. Fr., A. microphylla R. E. Fr, A. minutiflora (Seub.) Suess., A. mollendoana Suess., A. mollis (B. L. Rob.) Loes., A. morongii Uline, A. multicaulis (Mart.) Kuntze, A. multiflora (Seub.) Schinz, A. muscoides Benth. & Hook.f., A. nesiotes I. M. Johnst., A. nigriceps Hook., A. nodifera (Moq.) Griseb., A. nudicaulis (Hook.f.) Christoph., A. obovata (M. Martens & Galeotti) Millsp., A. obovata (M. Martens & Galeotti) Standl., A. olivacea (Urb.) Urb., A. panamensis (Standl.) Standl., A. paronichyoides A. St.-Hil., A. paronychioides A. St.-Hil., A. paronychioides f. aberrans Pedersen, A. paronychioides var. boliviana (Rusby) Pedersen, A. parviflora Moq., A. pennelliana Mears ex Pedersen, A. peruviana (Moq.) Suess., A. philippo-coburgii (Zahlbr.) Suess, A. philoxeroides (Matt.) Griseb., A. pilosa Moq, A. piptantha Pedersen, A. polycephala Benth., A. porrigens (Jacq.) Kuntze, A. praelonga A.St.-Hil., A. procumbens Schult., A. puberula (Mart.) D.Dietr., A. pulchella Kunth, A. pulverulenta Moq., A. pumila O. Stützer, A. pungens Kunth, A. pycnantha (Benth.) Standl., A. radicata Hook.f., A. raimondii Suess., A. ramosissima (Mart.) Chodat & Hassl., A. regelii (Seub.) Schinz, A. reineckii Brig., A. rigida B. L. Rob. & Greenm., A. robinsonii Suess., A. rufa (Mart.) D. Dietr., A. rugulosa (B. L.Rob.) J. T. Howell, A. scandens Hallier f, .A. scirpoides Hook.f., A. sericea Kunth, A. serpens Pedersen, A. serpyllifolia (Poir.) Urb., A. sessilis (L.) R. Br. ex DC., A. snodgrassii (B. L.Rob.) J. T. Howell, A. spinosa (Hornem.) Schult., A. stellata Uline & W. L. Bray, A. strictiuscula (Andersson) Schinz, A. subscaposa Hook.f., A. suessenguthii Covas, A. suffruticosa Torr., A. tetramera R. E. Fr., A. truxillensis Kunth, A. tubulosa Suess., A. tucumana Lillo, A. vestita (Andersson) J. T. Howell, A. villosa Kunth (family Amaranthaceae), Arundo donax L. (family Poaceae), Azolla caroliniana Willd. (family Azollaceae, sometimes the genus Azolla Lam. was placed in the family Salviniace), A. circinate Oltz & Hall, A. cristata Kaulf., A. filiculoides Lam., A. japonica Franch. & Say., A mexicana C. Presl, A. microphylla Kaulf., A. nilotica Decne. ex Mett., A. pinnata R. Br., A. rubra R. Br. (family Azollaceae), Batrachochytrium dendrobatidis Longcore, Pessier & D. K. Nichols (Order Chytridiales), Brasenia schreberi J. F. Gmel. (family Cabombaceae), Cephalanthus occidentalis L. (family Rubiaceae), Chara vulgaris L. (family Characae), Cladophora sp. (Cladophoraceae), Colocasia esculenta (L.) Schott, C. esculenta (L.) Schott (family Araceae), Cyperus odoratus L. (family Cyperaceae), Dulichium arundinaceum (L.) Britton (family Cyperaceae), Egeria densa Planch. (family Hydrocharitaceae), Eichhornia azurea (Sw.) Kunth, E. crassipes (Mart.) Solms, E. diversifolia (Vahl) Urb., E. heterosperma Alexander, E. paniculata (Spreng.) Solms, E. paradoxa (Mart. ex Schult. & Schult.f.) Solms, E. cordata Kunth, E. durangensis (Greenm.) Cruden. (family Pontederiaceae), Gomphonema geminata (Lyngb.) C. Agardh (family Gomphonemataceae), Hedychium gardnerianum Sheppard ex Ker Gawl. (family Zingiberaceae), Hydrilla verticillate (L. f.) Royle (family Hydrocharitaceae), Hygrophila polysperma Anderson (family Acanthaceae), Hymenachne amplexicaulis (Rudge) Nees (family Poaceae), Ipomoea aquatica Forssk (family Convolvulaceae), Isolepis prolifera (Rottb.) R. Br. (Cyperaceae), Lemna minuta Kunth (family Araceae), Limnobium spongia (Bosc) Rich. ex Steud. (family Hydrocharitaceae), Melaleuca quinquenervia (Cay.) S. T. Blake (family Myrtaceae), Micranthemum umbrosum (J. F. Gmel.) S. F. Blake (family Linderniaceae), Microstegium vimineum (Trin.) A. Camus (family Poaceae), Myriophyllum aquaticum (Vell.) Verdc., M. spicatum L. (family Haloragaceae), Najas minor All. (family Najadaceae), Nelumbo lutea Willd. (family Nelumbonaceae), Nuphar advena (Aiton) W. T. Aiton (family Nymphaeaceae), Nymphaea odorata Aiton (family Nymphaeaceae), Nymphoides aquatica (J. F. Gmel.) Kuntze, N. aquaticum Kuntze, N. aurantiaca (Dalzell) Kuntze, N. beaglensis Aston, N. bosseri A. Raynal, N. brevipedicellata (Vatke) A. Raynal, N. cordata (Elliott) Fernald, N. coreana (H. Lév.) H. Hara, N. crenata (F. Muell.) Kuntze, N. cristata (Roxb.) Kuntze, N. disperma Aston, N. eckloniana (Griseb.) Kuntze, N. elegans A. Raynal, N. elliptica Aston, N. europaea Fisch. ex Steud., N. exiliflora (F. Muell.) Kuntze, N. ezannoi Berhaut, N. fallax Ornduff, N. flaccida L. B. Sm., N. flava Hill, N. forbesiana (Griseb.) Kuntze, N. furculifolia Specht, N. geminata (R. Br.) Kuntze, N. grayana (Griseb.) Kuntze, N. grayanum Arthur, N. guincensis A. Raynal, N. hastata (Dop) Kerr, N. herzogii A. Galán & G. Navarro, N. humilis A. Raynal, N. hydrocharoides (F. Muell.) Kuntze, N. hydrophylla (Lour.) Kuntze, N. indica (L.) Kuntze, N. krishnakesara K. T. Joseph & Sivar., N. lacunosa (Vent.) Fernald, N. lungtanensis S. P. Li, T. H. Hsieh & C. C. Lin, N. macrospermum Vasud.Nair, N. microphylla (A. St.-Hil.) Kuntze, N. milnei A. Raynal, N. minima (F. Muell.) Kuntze, N. minor (D. Don ex G. Don) S.Gupta, A. K. Mukh. & M. Mondal, N. montana Aston, N. nilotica (Kotschy & Peyr.) J.Léonard, N. nymphaeoides Britton, N. orbiculatum (Lam.) Kuntze, N. parvifolia Kuntze, N. peltata (S. G. Gmel.) Kuntze, N. peltatum (S. G. Gmel.) Britten & Rendle, N. planosperma Aston, N. quadriloba Aston, N. rautanenii (N. E. Br.) A. Raynal, N. siamensis (Ostenf.) Kerr, N. simulans Aston, N. sivarajanii K. T. Joseph, N. spinulosperma Aston, N. stygia (J. M. Black) H. Eichler, N. subacuta Aston, N. tenuissima A. Raynal, N. tonkinensis (Dop) P. H. Hô, N. triangularis Aston, N. verrucosum (R. E. Fr.) A. Galan & G. Navarro (family Menyanthaceae), Oxycaryum cubense (Poepp. & Kunth) (family Cyperaceae), Panicum hemitomon Schult., P. repens L. (family Poaceae), Peltandra virginica (L.) Schott (family Araceae), Pennisetum purpureum Schumach (family Poaceae), Phragmites australis (Cav.) Trin. ex Steud (family Poaceae), Pistia stratiotes L. (family Araceae), Pithophora roettleri (Roth) Wittrock (Cladophoraceae), Potamogeton crispus L. (family Potamogetonaceae), Salvinia adnata Desvaux, S. auriculata Aublet, S. biloba Raddi, S. cucullata Roxb. ex Bory, S. cyathiformis Maxon, S. hastate Desvaux, S. herzogii de la Sota, S. martynii Kopp, S. minima Baker, S. molesta D. S. Mitchell, S. natans (L.) Allioni, S. nymphellula Desvaux, S. oblongifolia Martius, S. radula Baker, S. rotundifolia Willd., S. sprucei Kuhn (family Salviniaceae), Scirpus pungens Vahl (family Cyperaceae), Spartina anglica C. E. Hubb. (family Poaceae), Trapa natans L. T. angustifolia L. (family Lyphaceae), Urochloa mutica (Forssk.) T. Q. Nguyen (family Poaceae), Wolffiella gladiata (Hegelm.) Hegelm. (family Araceae). In particular embodiments, the invasive or unwanted plant is S. molesta, S. minima, A. caroliniana, L. minuta, E. crassipes, or P. stratiotes.

In some embodiments, the invasive or unwanted plant or fungus is a terrestrial plant or fungus. In some embodiments, the invasive or unwanted terrestrial plant or fungus is Acacia mearnsii De Wild. (family Fabaceae), Acalpha rhomboidea Raf. (family Euphorbiaceae), Acer rubrum L. (family Aceraceae), Ailanthus altissima (Mill.) Swingle, A. altissima var. altissima, A. altissima var. sutchuenensis (Dode) Rehder & E. H. Wilson, A. altissima var. tanakae (Hayata) Kaneh. & Sasaki, A. esquirolii H. Lév., A. excelsa Roxb., A. fauveliana Pierre ex Laness., A. fordii Noot., A. imberbiflora F. Muell., A. integrifolia Lam., A. integrifolia subsp. calycina (Pierre) Noot., A. kurzii Prain, A. philippinensis Merr., A. phyllanthoides Müll. Arg., A. punctata F. Muell., A. scripta Gagnep., A. triphysa (Dennst.) Alston, A. vietnamensis H. V.Sam & Noot., A. wightii Tiegh. (family Simaroubaceae), Akebia quinata (Houtt.) Decne. (family Lardizabalaceae), Albizia julibrissin Durazz. (family Fabaceae), Alliaria petiolata (M. Bieb.) Cavara & Grande, A. petiolata (M. Bieb.) Cavara & Grande (family Brassicaceae), Amaranthus×adulterinus Thell., A.×aellenii Cacciato, A.×alleizettei Aellen, A.×artineanus Muschl., A.×braunii Thell., A.×budensis Priszter, A.×caturus B.Heyne ex Hook.f., A.×dobrogensis Morariu, A.×edouardii Sennen, A.×filicaulis Sennen, A.×galii Sennen & Gonzalo, A.×hungaricus Soó, A.×jansen-wachterianus Thell., A.×mauritii Sennen, A.×monteluccii Cacciato, A.×moquinii Sennen, A.×ozanonii Piszter, A.×parodii Thell., A.×polgarianus Priszter & Kárpáti, A.×probstii Thell., A.×ruebelii Thell., A.×soproniensis Priszter & Kárpáti, A.×tarraconensis Sennen & Pau, A.×texensis Henrickson, A.×thevenoei Degen & Thell., A.×tremolsii Sennen, A.×turcicensis Domin, A.×turicensis Priszter, A.×wilczekii Sennen, A. acanthobracteatus Henr., A. acanthochiton Sauer, A. aeneus Besser, A. alaco Thell., A. albiflorus Moq., A. albus L., A. anderssonii J. T. Howell, A. angustifolius var. silvester Thell., A. antillensis Millsp., A. aragonensis Sennen, A. arenicola I. M. Johnst., A. ascendens Hornem., A. asplundii Thell., A. atropurpureus Roxb., A. aureus F. Dietr., A. australis (A.Gray) Sauer, A. bahiensis Mart., A. bigelowii Uline & W. L. Bray, A. blitoides S. Watson, A. blitum L., A. blitum Rchb. ex Steud., A. blitum subsp. emarginatus (Salzm. ex Uline & Bray) Carretero, Mũnoz Garm. & Pedrol, A. blitum subsp. oleraceus (L.) Costea, A. blitum var. blitum, A. blitum var. pseudogracilis (Thell.) Costea, A. bracteosus Uline & W. L. Bray, A. brandegeei Standl., A. brasiliensis Moq., A. brisbanii Kov., A. brownii Christoph. & Caum, A. californicus (Moq.) S.Watson, A. campestris Willd., A. canariensis Besser, A. cannabinus (L.) Sauer, A. capensis Thell., A. capitatus Besser, A. caracasanus Kunth, A. canaria Besser, A. cararu Jacq. ex Zuccagni, A. cardenasianus Hunz., A. carneus Greene, A. carolinae Kov., A. carura Jacq. ex Zuccagni, A. caturus Roxb., A. caudatus L., A. celosioides Kunth, A. cernuus Besser, A. chihuahensis S.Watson, A. chipendalei Kov., A. clementii Domin, A. cochleitepalus Domin, A. coesius F.Dietr. ex Moq., A. commutatus A.Kern., A. congestus C. C.Towns., A. crassipes Schltdl., A. crassipes var. warnockii (I. M. Johnst.) Henrickson, A. crispus (Lesp. & Thévenau) A. Terrace., A. crispus Lesp. & Thev., A. crocatus Besser, A. cruentus L., A. cuspidifolius Domin, A. deflexus L., A. desfontanii Kov., A. diacanthus Raf., A. dinteri Schinz, A. dioicus Michx. ex Moq., A. divaricatus Andrz. ex Lindem., A. dubius K. Krause, A. dubius Mart. ex Thell., A. edulis Michx. ex Moq., A. fatine Mart., A. fimbriatus (Ton.) Benth., A. floridanus (S. Watson) Sauer, A. frutescens Dum.Cours., A. furcatus J. T. Howell, A. giganteus Besser, A. giganteus L'Hér. ex Moq., A. globosa L., A. glomeratus Posp., A. graecizans L., A. graecizans subsp. silvestris (Vill.) Brenan, A. grandiflorus (J. M. Black) J. M.Black, A. greggii S.Watson, A. haughtii Standl., A. hunzikeri N.Bayón, A. hybridus K.Krause, A. hybridus L., A. hybridus subsp. quitensis (Kunth) Costea & Carretero, A. hypochondriacus L., A. hypochondriacus var. powellii (S. Watson) Pedersen, A. interruptus R. Br., A. kloosianus Hunz., A. leptostachyus Benth., A. lepturus S. F. Blake, A. leucanthus Raf., A. lombardoi Hunz., A. looseri Suess., A. macrocarpus Benth., A. major Salzm. ex Moq., A. mangostanus L., A. margaritae Dammer, A. microphyllus Shinners, A. minimus Standl., A. mitchellii Benth., A. morosus Rchb., A. muricatus (Gillies ex Moq.) Hieron., A. nettii Kov., A. obcordatus (A. Gray) Standl., A. pallidiflorus F. Muell., A. palmeri S. Watson, A. paolii Chiov., A. paraguayensis Parodi, A. parisiensis Schenk, A. parvulus Peter, A. persimilis Hunz., A. peruvianus (Schauer) Standl., A. polychroa Raeusch., A. polyflagellus Spreng. ex Moq., A. polygamus L., A. polygonoides L., A. polygonoides subsp. berlandieri (Moq.) Thell., A. polystachyus Willd., A. powellii S. Watson, A. powellii subsp. bouchonii (Thell.) Costea & Carretero, A. praetermissus Brenan, A. pringlei S. Watson, A. pumilus Raf., A. retroflexus L., A. retroflexus×rudis, A. rosengurttii Hunz., A. roxburghianus H. W.Kung, A. rubra K.Krause, A. rudis×hybridus, A. rugulosus (J. T. Howell) Kov., A. sanguineus Vell., A. scandens L. F., A. scariosus Benth., A. schinzianus Thell., A. scleranthoides (Andersson) Andersson, A. scleropoides Uline & W. L.Bray, A. sparganicephalus Thell., A. spinosus L., A. squamulatus (Andersson) B. L. Rob., A. standleyanus Parodi ex Covas, A. tamariscinus Nutt., A. tamaulipensis Henrickson, A. tenuifolius Willd., A. tenuis Benth., A. terminatum Miq., A. thellungianus Nevski, A. thunbergii Moq., A. tortuosus Hornem., A. tricolor L., A. tuberculatus (Moq.) Sauer, A. tuberculatus×rudis, A. tucsonensis Henrickson, A. turcomanicus Gand., A. ulinei Kov., A. undulatus Lindl., A. urceolatus Benth., A. venulosus S.Watson, A. verticillatus Sessé& Moç., A. viridis L., A. viscidulus Greene, A. vulgatissimus Speg., A. watsonii Standl., A. wrightii S.Watson, A. zanensis Hornem. ex Moq. (family Amaranthaceae), Ambrosia trifida L. (family Asteraceae), Ampelopsis brevipedunculata (Maxim.) Trautv. (family Vitaceae), Ardisia crenata Sims, A. elliptica Thunb. (family Myrsinaceae), Arundo donax L. (family Poaceae), Atrichum angustatum (Bridel) Bruch & Schimper (Polytrichaceae), Atriplex patula L. (family Amaranthaceae), Avena barbata Pott ex Link (family Poaceae), Berberis thunbergii DC. (family Berberidaceae), Berberis thunbergii DC. (family Berberidaceae), Bromus tectorum L. (family Poaceae), Bromus tectorum L. (family Poaceae), Broussonetia papyrifera (L.) L'Hér. ex Vent. (family Moraceae), Capsella bursa-pastoris (L.) Medik. (family Brassicaceae), Cardaria pubescens (C. A. Mey.) Jarmolenko (family Brassicaceae), Carduus nutans L. (family Asteraceae), Celastrus orbiculatus Thunb. (family Celastraceae), Centaurea stoebe L. spp. micranthos (Gugler) Hayek (family Asteraceae), Centaurea stoebe L. spp. micranthos (Gugler) Hayek, C. solstitialis L., C. diffusa Lam., C. calcitrapa L. (family Asteraceae), Cecropia peltata L. (family Urticaceae), Chamaesyce hypericifolia (L.) Millsp. (family Euphorbiaceae), Chenopodium album L. (family Chenopodiaceae), Chromolaena odorata (L.) King & H. E. Robins (family Asteraceae), Cinchona pubescens Vahl (family Rubiaceae), Cinnamomum camphora (L.) J. Presl (family Lauraceae), Cirsium arvense (L.) Scop. (family Asteraceae), Clematis terniflora D C. (family Ranunculaceae), Clidemia hirta (L.) D. Don (family Melastomataceae), Croton capitatus Michx., C. capitatus Michx. var. lindheimeri (Engelm. & Gray) Muell.-Arg. (Euphorbiaceae), Cryphonectria parasitica (Murrill) Barr (Cryphonectriaceae), Cynoglossum officinale L. (family Boraginaceae), Cytisus scoparius (L.) Link (family Fabaceae), Dioscorea alata L., D. bulbifera L., D. oppositifolia L. (family Dioscoreaceae), Dipsacus fullonum L. (family Dipsacaceae), Elaeagnus angustifolia L., E. pungens Thunb., E. umbellata Thunb. (family Elaeagnaceae), Elymus repens (L.) Gould (family Poaceae), Entodon seductrix (Hedw.) Mull. Hal. (family Entodontaceae), Eragrostis curvula (Schrad.) Nees (family Poaceae), Euonymus alatus (Thunb.) Sieb. E. fortunei (Tursz.) Hand.-Maz. (family Celastraceae), Euphorbia esula L. (family Euphorbiaceae), Firmiana simplex (L.) W. Wright (family Sterculiaceae), Frangula alnus Mill. (family Rhamnaceae), Hedera colchica (K. Koch) K. Koch, H. helix L. H. hibernica (G. Kirchn.) Bean (family Araliaceae), Hedychium gardnerianum Sheppard ex Ker Gawl (family Zingiberaceae), Heracleum mantegazzianum Sommier & Levier (family Apiaceae), Hiptage benghalensis (L.) Kurz (family Malpighiaceae), Ilex vomitoria Sol. ex Aiton (family Aquifoliaceae), Imperata cylindrica (L.) P. Beauv. (family Poaceae), Lantana camara L. (family Verbenaceae), Lespedeza bicolor Turcz. L. cuneata (Dum. Cours.) G. Don, or. L. thunbergii (DC.) Nakai (family Fabaceae), Leucaena leucocephala (Lam.) de Wit. (family Fabaceae), Ligustrum japonicum Thunb., L. lucidum Ait., L. obtusifolium Sieb. & Zucc., L. ovalifolium Hassk., L. sinense Lour., L. vulgare L. (family Oleaceae), Linaria dalmatica (L.) Mill., L. vulgaris Mill. (family Scrophulariaceae), Liriope muscari (Decne.) L. H. Bailey (family Liliaceae), Lonicera×bella Zabel, L. fragantissima Lindl. & Paxon, L. japonica Thunb., L. maackii (Rupr.) Herder, L. morrowii A. Gray, L. tatarica L. (family Caprifoliaceae), Lygodium japonicum (Thunb.) Sw. and L. microphyllum (Cay.) R. Br. (family Lygodiaceae), Leucaena leucocephala (Lam.) de Wit. (family Fabaceae), Liquidambar styraciflua L. (family Altingiaceae), Lonicera×bella Zabel, L. fragrantissima Lindl. & Paxon, L. japonica Thunb., L. maackii (Rupr.) Herder, L. morrowii A. Gray, L. tatarica L. (family Caprifoliaceae), Lygodium japonicum (Thunb.) S w., L. microphyllum (Cay.) R. Br. (family Lygodiaceae), Lythrum salicaria L. (family Lythraceae), Mahonia bealei (Fortune) Carrière (family Berberidaceae), Melia azedarach L. (family Meliaceae), Miconia calvescens D C. (family Melastomataceae), Microstegium vimineum (Trin.) A. Camus (family Poaceae), Mikania micrantha Kunth (family Asteraceae), Mimosa pigra L. (family Fabaceae), Miscanthus sinensis Andersson (family Poaceae), Morella faya Aiton (family Myricaceae), Nandina domestica Thunb. (family Berberidaceae), Onopordum acanthium L. (family Asteraceae), Ophiostoma ulmi (Buisman) Melin & Nannf. (family Ophiostomataceae, Opuntia ficus-indica (L.) Mill., O. stricta (Haw.) Haw (family Cactaceae), O. stricta (Haw.) Haw, Paulownia tomentosa (Thnb.) Sieb. & Zucc. ex Zucc. (family Paulowniaceae), Phyllostachys aurea Can. ex A.& C. Riviére (family Poaceae), Phytophthora cinnamomi Rands (family Pythiaceae), Pinus pinaster Aiton (family Pinaceae), Polygonum cuspidatum Siebold & Zucc, P. perfoliatum L. (family Polygonaceae), Poncirus trifoliata (L.) Raf (family Rutaceae), Prosopis glandulosa Ton. (family Fabaceae), Psidium cattleianum Sabine (family Myrtaceae), Prosopis glandulosa Ton. (family Rutaceae), Pueraria alopecuroides Craib, P. bella Prain, P. bouffordii H. Ohashi, P. calycina Franch., P. candollei Benth., P. candollei var. mirifica (Airy Shaw & Suvat.) Niyomdham, P. composita Graham, P. edulis Pamp., P. garhwalensis L. R. Dangwal & D. S. Rawat, P. imbricate Maesen, P. lacei Craib, Pueraria montana (Lour.) Men. (P. lobata (Wild.) Ohwi or P. montana (Lour.) Men. var. lobata (Willd.) Maesen & S. Almeida) (family Fabaceae), P. maclurei (F. P. Metcalf) F. J. Herm., P. montana (Lour.) Men., P. montana var. chinensis (Ohwi) Sanjappa & Pradeep, P. montana var. lobata (Willd.) Sanjappa & Pradeep, P. montana var. montana (Lour.) Men., P. peduncularis (Benth.) Benth., P. peduncularis Graham, P. phaseoloides (Roxb.) Benth., P. phaseoloides var. javanica (Benth.) Baker, P. phaseoloides var. phaseoloides (Roxb.) Benth., P. phaseoloides var. subspicata (Benth.) Maesen, P. pulcherrima (Koord.) Koord.-Schum., P. pulcherrima (Koord.) Men. ex Koorders-Schumacher, P. sikkimensis Prain, P. stracheyi Baker, P. stricta Kurz, P. tuberosa (Willd.) D C., P. wallichii D C., P. xyzhuii H. Ohashi & Iokawa. (family Fabaceae), Pyrus calleryana Decne. (family Rosaceae), Quercus acutissima Carruth. (family Fagaceae), Ranunculus ficaria L. (family Ranunculaceae), Rhamnus cathartics L. (family Rhamnaceae), Rosa bracteata J. C. Wendl., R. laevigata, R. multiflora Thunb., ex Murr. (family Rosaceae), Rubus ellipticus Sm. (family Rosaceae), Schedonorus phoenix (Scop.) Holub. (family Poaceae), Schinus terebinthifolius Raddi (family Anacardiaceae), Securigera varia (L.) Lassen (family Fabaceae), Solanium viarum Dunal (family Solanaceae), Solidago canadensis L. (family Asteraceae), Sorghum halepense (L.) Pers., S.×almum Parodi, S.×derzhavinii Tzvelev, S.×drummondii (Steud.) Millsp. & Chase, S.×randolphianum Parodi, S. amplum Lazarides, S. angustum S. T.Blake, S. annuum Trab., S. arduini var. bicolor (Körn.) Snowden, S. arundinaceum (Desv.) Stapf, S. aterrimum Stapf, S. aterrimum var. transiens (Hack.) Snowden, S. bicolor (L.) Moench, S. bicolor var. charisianum (Busse & Pilg.) Snowden, S. bicolor var. transiens (Hack.) Fosberg & Sachet, S. brachypodum Lazarides, S. bulbosum Lazarides, S. burmahicum Raizada, S. caffrorum var. albidum (Körn.) Snowden, S. caffrorum var. densissimum (Busse & Pilg.) Snowden, S. caffrorum var. lasiorhachis (Hack.) Snowden, S. caffrorum var. ondongae (Körn.) Snowden, S. caudatum var. colorans (Pilg.) Snowden, S. caudatum var. kerstingianum (Busse & Pilg.) Snowden, S. caudatum var. natae (Körn.) Snowden, S. cernuum var. agricolarum (Brukill ex Benson & Subba Rao) Snowden, S. conspicuum var. callomelan (K. Schum.) Snowden, S. conspicuum var. usaramense (Busse & Pilg.) Snowden, S. controversum (Steud.) Snowden, S. durra var. aegyptiacum (Körn.) Snowden, S. durra var. coimbatoricum (Burkill ex Benson & Subba Rao) Snowden, S. durra var. javanicum (Hack.) Snowden, S. durra var. mediocre (Burkill ex Benson & Subba Rao) Snowden, S. durra var. niloticum (Körn.) Snowden, S. durra var. rutilum (Stapf) Snowden, S. ecarinatum Lazarides, S. elegans var. baumannii (Körn. ex K. Schum.) Snowden, S. elegans var. holstii (Busse & Pilg.) Snowden, S. elegans var. schumannii Snowden, S. elegans var. ziegleri (Busse & Pilg.) Snowden, S. elliotii Stapf, S. exstans Lazarides, S. grande Lazarides, S. guineense var. amphilobum (Busse & Pilg.) S. F. Blake, S. guineense var. intermedium (Busse & Pilg.) Snowden, S. halepense (L.) Pers., S. halepense var. sudanense (Piper) Soó, S. hewisonii (Piper) Longley, S. interjectum Lazarides, S. intrans F. Muell. ex Benth., S. laxiflorum F. M. Bailey, S. leiocladum (Hack.) C. E. Hubb., S. macrospermum Garber, S. margaritiferum var. ovaliferum (Hack.) Snowden, S. margaritiferum var. tremulans (Stapf) Snowden, S. matarankense Garber & Snyder, S. membranaceum var. ehrenbergianum (Korn.) Snowden, S. membranaceum var. lateritium (Stapf) Snowden, S. miliaceum (Roxb.) Snowden, S. mucronatum (Hack.) Kuntze, S. negrosense Nesom, S. nigricans var. calcaneum (Busse & Pilg.) Snowden, S. nigricans var. cerevisiae (Stapf) Snowden, S. nigricans var. concolor (K. Schum. ex Engl.) Snowden, S. nigricans var. peruvianum (Hack.) Snowden, S. nigricans var. stuhlmannii (Korn. ex K. Schum.) Snowden, S. nigricans var. ussiense (Körn.) Snowden, S. niloticum (Stapf ex Piper) Snowden, S. nitens (Busse & Pilg.) Snowden, S. nitidum (Vahl) Pers., S. plumosum (R. Br.) P. Beauv., S. propinquum (Kunth) Hitchc., S. purpureosericeum (A. Rich.) Schweinf. & Asch., S. roxburghii (Hack.) Stapf, S. roxburghii var. fulvum (Hack.) Snowden, S. roxburghii var. hirsutum (Busse & Pilg.) Snowden, S. roxburghii var. jucundum (Busse & Pilg.) Snowden, S. saccharatum (L.) Moench, S. saccharatum var. sudanense (Piper) Kergúelen, S. scoparium Cavadas, S. stipoideum (Ewart & Jean White) C. A. Gardner & C. E. Hubb., S. subglabrescens var. compactum (Burkill ex Benson & Subba Rao) Snowden, S. subglabrescens var. irungiforme (Burkill ex Benson & Subba Rao) Snowden, S. subglabrescens var. leucocarpum (Chiov.) Snowden, S. subglabrescens var. rugulosum (Hack.) Snowden, S. subglabrescens var. umbonatum (Stapf) Snowden, S. sudanense (Piper) Stapf, S. thonizzii Pasq., S. timorense (Kunth) Buse, S. trichocladum (Hack.) Kuntze, S. versicolor Andersson, S. virgatum (Hack.) Stapf, S. vulgare var. drummondii (Steud.) Chiov., S. vulgare var. sudanense (Piper) Hitchc., S. zeae (Roem. & Schult.) Kuntze. (family Poaceae), Spathodea campanulata P. Beauv. (family Bignoniaceae), Sphagneticola trilobata L. (family Asteraceae), Spiraea japonica L. F. (family Rosaceae), Tamarix ramosissima Ledeb. (family Tamaricaceae), Striga asiatica (L.) Kuntze (family Scrophulariaceae), Taeniatherum caput-medusae (L.) Nevski (family Poaceae), Triadica sebifera (L.) Small (synonym: Sepium sebiferum (L.) Roxb. (family Euphorbiaceae), Tussiliago farfara L. (family Asteraceae), Ulex europaeus L. (family Fabaceae), Ulmus parvifolia Jacq. (family Ulmaceae), Vernicia fordii (Hemsl.) Airy-Shaw (family Euphorbiaceae), Vinca major L., V. minor L. (family Apocynaceae), Vitex rotundifolia L. F. (family Lamiaceae), Wisteria floribunda (Willd.) D C. or W. sinensis (Sims) D C. (family Fabaceae).

The invasive or unwanted species may be any appropriate invasive or unwanted animal.

In some embodiments, the invasive or unwanted species is an animal species. In some embodiments, the invasive or unwanted species is Acrolepiopsis assectella (family Acrolepiidae), Achatina fulica (family Acrolepiidae), Acridotheres tristis (family Sturnidae), Adelges tsugae (family Adelgidae), Aedes albopicus (family Culicidae), Agrilus planipennis (family Buprestidae), Anomala orientalis (family Scarabaeidae), Anopheles quadrimaculatus (family Culicidae), Anoplolepis gracilipes (family Formicidae), Anoplophora chinensis, A. glabripennis (family Cerambycidae), Apis mellifera (family Apidae), Autographa gamma (family Noctuidae), Alosa pseudoharengus (family Clupeidae), Ampullaria gigas (family Ampullariidae), Anoplophora glabripennis (family Cerambycidae), Aristichthys nobilis (family Cyprinidae), Asterias amurensis (family Asteriidae), Bactrocera oleae (family Tephritidae), Bemisia tabaci (family Aleyrodidae), Boiga irregularis (family Colubridae), Bombus terrestris (family Apidae), Bruchus rufimanus (family Chrysomelidae), Bufo marinus (Rhinella marina) (family Bufonidae), Bursaphelenchus xylophilus (family Parasitaphelenchidae), Bythotrephes longimanus (family Cercopagididae), Cactoblastis cactorum (family Pyralidae), Callosobruchus maculatus (family Chrysomelidae), Capra hircus (family Bovidae), Carcinus meanas (family Portunidae), Cercopagis pengoi (family Cercopagididae), Ceratitis capitata (family Tephritidae), Cervus elaphus (family Cervidae), Channa argus (family Channidae), Cinara cupressi (family Aphididae), Clarias batrachus (family Clariidae), Coptotermes formosanus, C. gestroi (family Rhinotermitidae), Corbicula fluminea (family Corbiculidae), Corbula amurensis (family Corbulidae), Crepidula onyx (family Calyptraeidae), Ctenopharyngodon idellus (family Cyprinidae), Curculio nucum, C. occidentis (family Curculionidae), Cyprinus carpio (family Cyprinidae), Dendroctonus valens (family Scolytidae), Didemnum vexillum (family Didemnidae), Diuraphis noxia (family Aphididae), Dreissena bugensis (family Dreissenidae), Dreissena polymorpha (family Dreissenidae), Dryocosmus kuriphilus (family Cynipidae), Eleutherodactylus coqui (family Leptodactylidae), Epiphyas postvittana (family Tortricidae), Eriocheir sinensis (family Varunidae), Eriosoma lanigerum (family Aphididae), Eristalis tenax (family Syrphidae), Euglandina rosea (family Spiraxidae), Felis catus (family Felidae), Gambusia affinis (family Poeciliidae), Gymnocephalus cernuus (family Percidae), Halyomorpha halys (family Pentatomidae), Helicoverpa armigera (family Noctuidae), Homalodisca vitripennis (family Coccinellidae), Hylotrupes bajulus (family Cerambycidae), Hyphantria cunea (family Arctiidae), Hemiberlesia pitysophila (family Diaspididae), Hemigrapsus sanguineus (family Herpestidae), Incisitermes minor (family Kalotermitidae), Lasius neglectus or L. neoniger (family Formicidae), Lates niloticus (family Latidae), Leptinotarsa decemlineata (family Chrysomelidae), Leptoglossus occidentalis (family Coreidae), Linepithema humile (family Formicidae), Liriomyza sativae (family Agromyzidae), Lithobates catesbeianus (Rana catesbeiana) (family Ranidae), Lymantria dispar dispar (family Erebidae), Macaca fascicularis (family Cercopithecidae), Mamestra brassicae (family Noctuidae), Monomorium destructor, M. pharaonis (family Formicidae), Monopterus albus (family Synbranchidae), Mus musculus (family Muridae), Mustela erminea (family Mustelidae), Myocastor coypus (family Myocastoridae), Myrmica rubra (family Formicidae), Mytilus galloprovincialis (family Mytillidaee), Mytilopsis sallei (family Dreissenidae), Neogobius melanostomus (family Gobiidae), Nylanderia fulva (family Formicidae), Oncorhynchus mykiss (family Salmonidae), Operophtera brumata (family Geometridae), Opogona sacchari (family Tineidae), Oracella acuta (family Pseudococcidae), Orconectes rusticus (family Cambaridae), Oreochromis mossambicus (family Cichlidae), Oryctolagus cuniculus (family Leporidae), Ostrinia nubilalis (family Crambidae), Oxycarenus hyalinipennis (family Lygaeidae), Pectinophora gossypiella (family Gelechiidae), Periplaneta americana (family Blattidae), Petromyzon marinus (family Petromyzontidae), Pheidole megacephala (family Formicidae), Pieris brassicae (family Pieridae), Platydemus manokwari (family Geoplanidae), Polistes dominula (family Vespidae), Pomacea canaliculata (family Ampullariidae), Potamopyrgus antipodarum (family Hydrobiidae), Procambarus clarkii (family Cambaridae), Pseudorasbora parva (family Cyprinidae), Pycnonotus cafer (family Pycnonotidae), Pylodictis olivaris (family Ictaluridae), Rana catesbeiana (family Ranidae), Rapana venosa (family Muridae), Rattus rattus (family Muridae), Reticulitermes flavipes (Kollar) (Rhinotermitidae), Rhinella marina (family Bufonidae), Rhinogobius giurinus (family Gobiidae), Rhizotrogus majalis (family Scarabaeidae), Rhynchophorus ferrugineus (family Curculionidae), Salmo trutta (family Salmonidae), Schistocerca americana, S. nitens (family Acrididae), Scirtothrips dorsalis (family Thripidae), Sirex noctilio (family Siricidae), Sitophilus zeamais (family Curculionidae), Solenopsis invicta or S. mandibularis, S. saevissima (family Formicidae), Sturnus vulgaris (family Sturnidae), Sus scrofa (family Suidae), Tenebrio molitor L. (Rhinotermitidae), Tetrops praeustus (family Cerambycidae), Trachemys scripta elegans (family Emydidae), Trichosurus vulpecula (family Phalangeridae), Thrips palmi (family Thripidae), Tremex fuscicornis (family Siricidae), Trogoderma granarium (family Dermestidae), Vespula germanica, V. vulgaris (family Vespidae), Viteus vitifoliae (family Phylloxeridae), Vulpes vulpes (family Canidae), Wasmannia auropunctata (family Formicidae), Xyleborus glabratus (family Curculionidae), Zabrotes subfasciatus (family Bruchidae), or Zophobas mono Fabricius (family Tenebrionidae).

The endocide may be applied in any appropriate manner. In some embodiments, a composition comprising the endocide or endocide is applied to a water body and its adjacent wetland areas infested with invasive or unwanted aquatic species. In some embodiments, a composition comprising the endocide or endocide is applied to a structure (e.g., boats) to control invasive or unwanted aquatic species. In some embodiments, a composition comprising the endocide or endocide is applied to a subject or structure (e.g., boats) to prevent infestation of invasive or unwanted aquatic species. In some embodiments, a composition comprising the endocide is applied topically. In some embodiments, the endocide is applied to the surface of the invasive or unwanted plant or fungus. In some embodiments, the composition is sprayed onto the invasive or unwanted plant or fungus. In some embodiments, the composition is spread around the invasive or unwanted plant or fungus. In some embodiments, the composition is dissolved in water surrounding the invasive or unwanted plant or fungus. In some embodiments, the composition is injected into water surrounding the invasive or unwanted plant or fungus.

In some embodiments, a composition comprising the endocide or endocide is applied to a structure (e.g., fences) to control invasive or unwanted terrestrial species. In some embodiments, a composition comprising the endocide is applied topically. In some embodiments, the endocide is applied to the surface of an invasive or unwanted plant or fungus. In some embodiments, the composition is sprayed onto the invasive or unwanted plant or fungus. In some embodiments, the composition is spread around the invasive or unwanted plant or fungus.

In some embodiments, a composition comprising the endocide or endocide is applied to a structure (e.g., fences) to control invasive or unwanted woody species. In some embodiments, a composition comprising the endocide is applied topically. In some embodiments, the endocide is applied to the surface of the invasive or unwanted plant. In some embodiments, the endocide is used by foliar application. In some embodiments, the endocide is used by basal bark applications. In some embodiments, the composition is sprayed or injected into the invasive or unwanted plant. In some embodiments, the endocide is used by cut stump treatments. In some embodiments, the endocide is used by hack and squirt applications. In some embodiments, the composition is spread around the invasive or unwanted plant.

In some embodiments, the application of the endocide may not add any exotic chemicals to the ecosystem of the invasive or unwanted species. In some embodiments, a composition comprising the endocide can be prepared by chopping, shredding, blending, and/or pressing fresh or decomposed matter of the target invasive or unwanted species without solvent. In some embodiments, a composition comprising the endocide can be prepared by using the water in the treating water bodies and/or their adjacent wetland areas as the solvent for the extraction of dried plant or fungus matter. In some embodiments, a composition comprising the endocide can be added with non-bioactive surfactants.

The endocide may be applied manually or mechanically.

In some embodiments, the endocide may be preferably applied to control the invasive or unwanted species soon after it is produced. In some embodiments, the endocide is best applied to control the invasive or unwanted species immediately or within several hours of its production. In some embodiments, the endocide is preferably applied to control the invasive or unwanted species within a week of its production. In some embodiments, the endocide especially in its aqueous form may be stored under refrigeration (4° C.) for months and effectively inhibit the invasive or unwanted species. In some embodiments, the endocide especially in its solid form may be stored under room temperature (RT) for months and can effectively inhibit the invasive or unwanted species.

In some embodiments, the endocide may be applied alone. In some embodiments, the endocide may be applied in combination with one or more secondary agents. In some embodiments, the secondary agent may be an endocide from another species to be controlled. In some embodiments, the secondary agent may be formic acid, acetic acid, diquat (diquat dibromide), glyphosate, contact herbicides, other biocides, the salvinia weevil, or biocontrol agents. In some embodiments the secondary agent is a preservative, and antioxidant, a stabilizer, a binder, a surfactant, an emulsifier, an effervescent, a wetting agent, a carrier, a diluent, etc.

The endocide may be present in any appropriate concentration in the composition. In some embodiments, the composition contains 0.001, 0.01, 0.1, 1, 2, 3, 4, 5, 6, 7, 8, 9, 10, 15, 20, 25, 30, 35, 40, 45, 50, 55, 60, 65, 70, 75, 80, 85, 90, 95, 96, 97, 98, 99, or 100% by weight or more of the endocide. In some embodiments, the composition contains about 0.01 to about 0.5% by weight of the endocide. In some embodiments, the composition contains about 0.1% by weight of endocide. In some embodiments, the target species is contacted by a composition containing an amount of endocide equal or less than the amount of endocide that is contained in the amount of species matter and/or organisms to be treated.

Also disclosed are the compositions as described herein, as well as kits containing the same.

The term “invasive species” means a species (e.g., plants including fungi and animals including insects) that is either native or non-native (exotic) to the ecosystem and whose presence or introduction causes or likely causes economical or environmental harm or harm to human health.

“Invasive plant species” or “invasive plant” means either a non-native (exotic) or native invasive plant species.

“Invasive aquatic species” or “aquatic invasive species” means an invasive species that has living in, on, or next to water.

“Invasive aquatic plant” means an invasive plant species that has adapted to living in, on, or next to water, and that can grow either submerged or partially submerged in water.

“Unwanted species” means a species (e.g., plants, fungi, Protista, Monera, and animals including insects) that is not wanted or desired. It can be either native or non-native (exotic) to the ecosystem. In some embodiments, it is an invasive species. In some embodiments, it is a weed. In some embodiments, it is a nuisance species. In some embodiments, it is a noxious species. In some embodiments, it is a species that is unwanted in a particular location. The location can be, but is not limited to, a geographic region, a park or recreational area, a field for crops, a body of water, a garden, a landscaped yard, a flower bed, a building, and/or an area around such locations. In some embodiments, the species is not an invasive species. In some embodiments, the species presence or introduction does not cause or likely causes economical or environmental harm or harm to human health.

“Weed” means a plant considered undesirable in a particular situation.

“Water body” or “body of water” means any significant accumulation of water on a planet's surface, including but not limited to a lake, pond, river, canal, creek, stream, brook, channel, ditch, bay, bayou, swamp, marsh, slough, bog, fen, wetland, harbor, inlet, lagoon, puddle, reservoir, strait, spring, swimming pool, or any container or structure with permanent or seasonal water.

“Salvinias” means aquatic or semi-aquatic fern species of the order Salviniales, including families Salviniaceae Reichenbach (Salvinia Séguier), Azollaceae Wettstein (Azolla Lamarck) (sometimes, Azolla is treated as a genus of the family Salviniaceae), and Marsileaceae Mirbel (Mar silea L., Pilularia L., and Regnellidium Lindm).

“Primary stage” or “primary growth stage” of a plant means the plant growth occurs in the early stages of an infestation. As a non-limiting example, the primary stage of giant salvinia can be when the small, flat, and oval-shaped floating leaves are less than 15 mm in width.

“Secondary stage” or “secondary growth stage” of a plant means the plant growth occurs in the secondary stages of an infestation. As a non-limiting example, the secondary stage of giant salvinia can be when the floating leaves become slightly cupped and are more than 15 mm but less than 50 mm in width.

“Tertiary stage” or “tertiary growth stage” of a plant means the plant growth occurs in the mature stages of an infestation. As a non-limiting example, the tertiary stage of giant salvinia can be when the floating leaves become tightly folded and are more than 50 mm in width when forced open. Tertiary plants may form a multilayered mat on the surface of the infested water body.

“Gland” means a cell, group of cells, or organ producing a secretion. “Exocrine gland” means any gland that secretes its products through a duct onto an epithelial surface.

“Trichome” refers to “glandular trichome” or plant gland in this invention and means glandular unicellular or multicellular appendages on the surface of various plant organs.

“Effective” amount or concentration means that amount or concentration which, when applied to a place or subject for controlling an invasive or unwanted species, is sufficient to affect the growth, reproduction, or spread of the species.

“Control” or “controlling” means one or all of the following three actions or processes: elimination or eliminating, inhibition or inhibiting, and/or prevention or preventing. (1) “Elimination” or “eliminating” refers to eradicating, killing, or destroying completely one or all propagules or whole individuals of an invasive or unwanted species in a place or subject. (2) “Inhibition” or “inhibiting” refers to slowing, interrupting, or arresting growth, reproduction, or spread of an invasive or unwanted species in a place or subject. As used herein, the term “inhibition” or “inhibiting” does not necessarily indicate a total elimination of the species. (3) “Prevention” or “preventing” refers to the action or process of stopping growth, reproduction, or spread of an invasive or unwanted species in a place or subject or keeping an invasive or unwanted species from happening in a place or subject.

“Analogue” and “analog,” when referring to a compound, refers to a modified compound wherein one or more atoms have been substituted by other atoms, or wherein one or more atoms have been deleted from the compound, or wherein one or more atoms have been added to the compound, or any combination of such modifications. Such addition, deletion or substitution of atoms can take place at any point, or multiple points, along the primary structure comprising the compound.

“Derivative,” in relation to a parent compound, refers to a chemically modified parent compound or an analogue thereof, wherein at least one substituent is not present in the parent compound or an analogue thereof. One such non-limiting example is a parent compound which has been covalently modified. Typical modifications are amides, carbohydrates, alkyl groups, acyl groups, esters, pegylations and the like.

Some abbreviations used herein are as follows: ¹H-NMR is proton nuclear magnetic resonance, ¹³C-NMR is carbon nuclear magnetic resonance, CH₂Cl₂ is dichloromethane or methylene chloride, CH₃CN is acetonitrile, DMSO is dimethyl sulfoxide, EtOAc is ethyl acetate, EtOH is ethanol, g is gram(s), h is hour(s), H₂O is water, HPLC is high performance liquid chromatography, HRESIMS is High-resolution electrospray ionization mass spectrometry, kg is kilogram(s), kPa is kilopascal(s), L is liter(s), m is meter(s), MEOH is methanol, mg is milligram, min. is minute(s)mL is milliliter(s), mm is millimeter(s), NMR is nuclear magnetic resonance, ppm is parts per million, RT is room temperature (approximately at 20° C.), “tea bag” is a bag of ground dried plant, animal, or fungus matter, “tea brick” is compressed brick or pie of ground dried plant, animal, or fungus matter without a bag, μg is microgram(s), and μL is microliter(s).

The terms “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1—(+)-3-Hydroxy-β-ionone, a pure compound isolated from giant salvinia (Salvinia molesta) can quickly kill the contact tissues. The left photograph shows that the lower surface tissues were dead (the dark spot) within 12 h after the compound was applied on the lower surface of the leaf blade. The right photograph shows that the trichomes were damaged by the compound at the same time.

FIG. 2—HPLC chromatograms show that the changes of the chemical contents in the water extracts of the whole fresh matter of crested floating heart (Nymphoides cristata) during the nine days of the experiment. A. daily HPLC chromatograms of the water extracts at 254 nm, B. daily change of the total HPLC peak area of the water extracts at 254 nm, C. daily HPLC chromatograms of the water extracts at 280 nm, and D. daily change of the total HPLC peak area the water extracts at 280 nm.

FIG. 3—HPLC chromatograms show that the changes of the chemical contents in the water extracts of the shredded fresh matter of crested floating heart (Nymphoides cristata) during the nine days of experiment. A. daily HPLC chromatograms of the water extracts at 254 nm, B. daily change of the total HPLC peak area of the water extracts at 254 nm, C. daily HPLC chromatograms of the water extracts at 280 nm, and D. daily change of the total HPLC peak area of the water extracts at 280 nm.

FIG. 4—Leaf changes of crested floating heart (Nymphoides cristata) after the application of 10 μL fraction A of ethanol extracts of N. cristata (from top to bottom: day 2, 4, 11, and 12, respectively).

### DESCRIPTION OF ILLUSTRATIVE EMBODIMENTS

The inventors disclose herein methods and compositions for controlling an invasive or unwanted species by application of a composition comprised of an endocide derived from the same species or a closely-related species. In some instances, the endocides are selective for the species from which they are derived and/or a closely-related species.

The non-limiting examples disclosed herein by the inventors address elimination and inhibition of whole organisms or tissues of aquatic or terrestrial species (examples 1-4, 7-17, 19-31, 35, 38, 40, and 42-48), inhibition of seed germination and decrease viability (examples 6, 18, 23, 32-34, 36, 37, and 41), inhibition of other propaguals (e.g., cactus stems, chaya stems, garlic cloves (bulbs), and bulrush clumps) (examples 17, 26, 39, and 46), and prevention (e.g., aquatic plants muskgrass, giant salvinia, and crested floating heart) (examples 1, 5, and 7). Also, as demonstrated herein, the application of endocides can effectively control herbicide-resistant plants (examples 14 and 15). The examples further demonstrate that an endocide of one species can effectively eliminate, inhibit, and prevent one or more closely-related species. As demonstrated herein, the application of the endocide can eliminate, inhibit, and prevent the target one or more species quickly, such as within one week. Further, application of a mixture of endocides from different species can be used to control multiple species. Further disclosed are examples wherein the endocides can selectively control the producing species over other species especially non-closely related species (examples 1, 11-16, 19, 24, 25, 35, 42, 43, 45, and 48). In addition, the application demonstrates that in some instances, a mixed culture with non-closely related plant species can reduce the effectiveness of endocides against the target species (example 49).

The invention disclosed herein is further applied to applications of endocides at low concentrations (dosages) to control partial growth or reproduction of an individual (e.g., a specific cell(s), tissue(s), or organ(s)) of the target species rather than killing or eliminating the individual or species.

The invention disclosed herein is further applied to methods, compositions, and/or applications that release endocidal chemicals and thus control the target species and/or destroy tissue of the target species. As a non-limiting example, a surfactant that may not have phytotoxicity to cause any injury or damage to a plant tissue when directly applied to the plant surfaces without trichomes may cause significantly damage when applied to the trichomes, which can release the endocidal chemicals in the plant and thus eventually inhibit growth and even destroy the plant tissues. Any agents (e.g., non-toxic surfactants) or practices that can release the endocidal chemicals from the species (such as by release from the trichomes of a plant) can induce or enhance the endocidal effects in control invasive or unwanted species.

It is disclosed herein that an effective applied dosages of endocides in some species can be lower or close to the amount of endocide that can be extracted from the amount of target species matter to be treated. As non-limiting examples, all of 30 Korean pine seeds lost viability after treatment by 0.75 g pine seed extracts for five weeks while these 30 pine seeds can produce 1.21 g EtOH extracts. 99.8% of 300 broccoli seeds lost viability after treatment with 0.5 g of EtOH extracts of broccoli seeds for two weeks and these seeds can produce 0.1 g extracts. 80% of 60 Chinese tallow seeds lost viability after being soaked in 1.5 g EtOH extracts of tallow seeds for six weeks while these seeds can produce 2.11 g extracts. More than 70% of 30 beans lost viability after being soaked in 1.5 g bean extracts for four days and 0.9 g extracts can be produced by 30 beans. All of 30 peanut seeds treated by 3 g peanut seed EtOH extracts for a week lost viability while these seeds can produce 12.47 g seed extracts. Oak acorns lost their viability after being soaked in a solution of the acorn/embryo extracts at a dosage less than the acorns contain. 54.3% of 30 Shumard oak acorns lost viability after soaking treatment with 7.5 g of the Shumard acorn extracts for 48 h while those acorns can produce 18.96 g extracts. 50% of 30 Nuttall oak acorns lost viability after soaking treatment with 7.5 g of the Shumard acorn extracts for 48 h. 51.1% of 15 Nuttall oak acorns lost viability when treated with 0.75 g Nuttall oak acorn extracts for 48 h while 15 acorns yielded 0.8 g extracts. About 96% of sawtooth oak acorns soaked in 10 g EtOH extracts of sawtooth acorns for two weeks lost viability but 11.69 g extracts can be extracted from these acorns. Also, four of the six stems of nopal cactus were killed after being soaked in 5 g extracts for 12 days while the six cactus stems can produce 4.93 g extracts. Similar results were found in insect treatments. A larva of mealworm or superworm can be killed by its own EtOH extracts at a dosage of less endocide than the chemical of contents a single worm can produce. Because only a percentage of the actual chemical constituents in an organism can be extracted by water or an organic solvent limited by the extraction techniques, the yield of extracts from an organism or its part is always much lower than its actual chemical contents. Further, only a small portion of the extracts in a soaking solution became available to the plant matter to be treated. The inventors thus concluded that the individual or propagule of an organism usually contains adequate endocides to kill itself.

In some instances, the inventors disclose that longer period of application of endocides and/or higher dosage of endocides are more effective in controlling the target species. As a non-limiting example, 99.8% of broccoli seeds soaked in a 5% broccoli seed extracts for two weeks lost viability in comparison with 32.2% of broccoli seeds soaked in the same extracts for 48 h. As another non-limiting example, 43.9% of sorghum seeds lost viability after treated by 5% EtOH extracts of sorghum seeds (1 g) for 72 h and 82% of the seeds lost viability after treated by 10% EtOH extracts (2 g) for the same time period.

As non-limiting examples, the inventors herein described applications of endocides to control 34 different organisms of different kingdoms. These organisms include species within the kingdom Plantae: species of phylum Charophyta (green algae), Bryophyta (mosses), Pteridophyta (ferns), Coniferophyta (gymnosperms), both dicots and monocots of the phylum Anthophyta (flowering plants, angiosperms), and species within the kingdom Animalia. Most examples disclosed in this application are fast-growing or fast-reproducing species including invasive species, but some are slow-growing species like Korean pine. The experimental plants represent almost all groups in many other classification systems such as: life cycle or longevity—four are annuals (e.g., hogwort), one biennial (e.g., broccoli), and 27 are perennials (e.g., pine) including muskgrass with both annual and perennial forms; habits—12 woody plants (nine tree species: e.g., Chinese tallow; four shrubby species: e.g., yaupon), one vines (e.g., kudzu), and 18 herbaceous and other species (e.g., peanut); loss of leaves—seven deciduous (e.g., Chinese tallow) and five evergreen (e.g., yaupon); habitats—seven are aquatic species and 24 are terrestrial species; water content of the environment—seven hydrophytes (e.g., salvinias), and one xerophyte (succulent cactus), and 14 mesophytes (e.g., broccoli). For insects, some examples address larvae, and others deal with adults. Therefore, the endocide concept and approach claimed herein have broad uses in a variety of different organisms.

The green alga species disclosed in the present invention is muskgrass (Chara vulgaris L.), an aquatic species of the family Chraraceae of the phyllum Charophyta.

The two moss species disclosed in the present invention are seductive entodon moss (Entodon seductrix (Hedw.) Mull. Hal.) (family Entodontaceae) of the order Hypnales and atrichum moss (Atrichum angustatum (Bridel) Bruch & Schimper) (family Polytrichaceae) of the order Polytrichales of the phylum Bryophyta.

The fern species disclosed in the present invention is giant salvinia (Salvinia molesta D. S. Mitchell), an aquatic fern species of the family Salviniaceae of the phylum Pteridophyta.

The gymnosperm species disclosed in the present invention is Korean pine (Pinus koraiensis Siebold & Zucc.) of the family Pinaceae of the phylum Coniferophyta.

The 18 dicot species of the phylum Anthophyta (flowering plants, angiosperms) disclosed in the present invention include crested floating heart (Nymphoides cristata (Roxb.) Kuntze) (family Menyanthaceae) of the order Asterales; Palmer's pigweed (Amaranthus palmeri S. Wats.) (family Amaranthaceae); alligator weed (Alternanthera philoxeroides Griseb.) (family Amaranthaceae), and nopal cactus (Opuntia ficus-indica (L.) Mill.) (family Cactaceae) of the order Caryophyllales; broccoli (Brassica oleracea L.) (family Brassicaceae) of Brassicales; Kudzu (Pueraria montana (Lour.) Merr., also known as P. lobata (Willd.) Ohwi or P. montana (Lour.) Merr. var. lobata (Willd.) Maesen & S. Almeida) (family Fabaceae), red kidney bean (Phaseolus vulgaris L.) (family Fabaceae), and peanut (Arachis hypogaea L.) (family Fabaceae) of the order Fabales; Chinese tallow (Triadica sebifera), hogwort (Croton capitatus Michx. var. lindheimeri (Engelm. & Gray) Muell.-Arg.) (family Euphorbiaceae), and chaya (Cnidoscolus aconitifolius (Mill.) I. M. Johnst.) (family Euphorbiaceae) of the order Malpighiales; yaupon (Ilex vomitoria Sol. Ex Alton) (family Aquifoliaceae) of the order Aquifoliales; sweetgum (Liquidambar styraciflua L.) (family Altingiaceae) of the order Saxifragales; tree of heaven (Ailanthus altissima (P. Mill.) Swingle) (family Simaroubaceae) of the order Sapindales; Nuttall oak (Quercus texana Buckley), Shumard oak (Q. shumardii Buckley), and sawtooth oak (Q. acutissima Carruth.) (family Fagaceae) of the order Fagales; and Chinese privet (Ligustrum sinense Lour.) (family Oleaceae) of the order Lamiales.

The eight monocot species of the phylum Anthophyta disclosed in the present invention are water lettuce (Pistia stratiotes L.) (family Araceae) of the order Alismatales; garlic (Allium sativum L.) (family Amaryllidaceae) of the order Asparagales; water hyacinth (Eichhornia crassipes (Mart.) Solms) (family Pontederiaceae) of the order Commelinales; sorghum (Sorghum bicolor (L.) Moench) (family Poaceae), Johnsongrass ( S. halepense (L.) Pers.) (family Poaceae), giant reed (Arundo donax L.) (family Poaceae), golden bamboo (Phyllostachys aurea Carr. ex A. & C. Rivière) (family Poaceae), and proliferating bulrush (Isolepis prolifera (Rottb.) R. Br.) (family Cyperaceae) of the order Poales.

The three insect species (the phylum Arthropoda) of the kingdom Animalia disclosed in the present invention are American grasshopper (Schistocerca americana Drury) (family Acrididae) of the order Orthoptera; mealworm (Tenebrio molitor L.) (family Tenebrionidae); and superworm (Zophobas morio Fabricius) (family Tenebrionidae) of the order Coleoptera.

Some of these species are exotic invasive or potentially invasive species in North America. Some of these species are, or may be, unwanted species in some situations. Seductive entodon moss, atrichum moss, hogwort, yaupon, sweetgum, and American grasshopper are native to North America but they are often unwanted species. Pine, broccoli, red kidney bean, peanut, chaya, Nutall oak, Shumard oak, swamp chestnut oak, garlic, and sorghum are primarily cultivated as crops but sometimes escape from cultivation and become potentially unwanted and even invasive in some situations. Inclusion of these randomly selected crop species in this invention also indicates that the present invention can be broadly applied in diverse groups of species.

The green algae are eukaryotic organisms of the kingdom Plantae consist of phyllum Chlorophyta and Charophyta. Filamentous algae of Chlorophya, often referred to as green hair algae, pond scum, or pond moss, are the most common type of noxious algae in ponds. The attached (epiphytic) or free floating filamentous algae often interfere with recreational activities and are accused of damaging the fishing industry. Cotton-like Cladophora Kütz. and horse-hair-like Pithophora Wittrock of the family Cladophoraceae are two commonly seen genera of filamentous algae. Muskgrass or skunkweed (Chara vulgaris) is an advanced multicellular macroalgae species of the family Chraraceae of Charophyta. The species found in fresh water may have given rise to land plants because it has stem-like and leaf-like structures. The fast-growing species with mucky or garlicky odor can be undesirable in ponds and lakes. Common algaecides containing copper can kill algal cells that the copper contacts directly but must be sprayed or broadcasted over the entire area where algae are growing to provide adequate control.

Seductive entodon moss or glossy moss (Entodon seductrix) is a common, straggling moss found throughout eastern North America, as far north as Ontario, and extending westward from Florida to Texas. Atrichum moss (Atrichum angustatum) is another common small moss species in North America (Merrill, 2007). These two moss species are not invasive species, but may be unwanted by some people. Because the mosses often grow on bricks, roofs, walls, decks, patios, sidewalks, lawns, or trees and shrubs and because they may be viewed as unattractive or destructive to their properties, some homeowners are interested in controlling them.

Giant salvinia (Salvinia molesta), a native fern of Brazil, is one of the most destructive invasive species in the world. The fern is able to double in number and biomass in less than three days under optimal conditions and forms dense mats over still waters (Barrett, 1989). Biological, mechanical, and herbicidal control of invasive giant salvinia is very expensive and has not been successful. 50 compounds were isolated from giant salvinia including four apocarotenoids (Li, et al., 2013). These apocarotenoids, namely (+)-3-hydroxy-β-ionone, (3R,6R,7E)-3-hydroxy-4,7-megastigmadien-9-one, annuionone D, and dehydrovomifoliol did not show any cytotoxicity against human tumor cells or normal cells (Li, et al., 2013). It has been reported that some apocarotenoids isolated from Chenopodium album L.(family Chenopodiaceae) and Cestrum parqui L'Herrit (Solanaceae) can inhibit seed germination or shoot/root elongation of Lactuca sativa L. (family Asteraceae) by 20-30% at the concentration of 10⁻⁴ M while some other isolated apocarotenoids had no activity (DellaGreca, et al., 2004; D'Abrosa, et al., 2004). To date, there are no reports about the death or tissue damage caused by these compounds although weak inhibition activity was reported. (+)-3-Hydroxy-β-ionone is a synthetic compound (Perez, et al., 1996) and also isolated from both C. album and C. parqui (DellaGreca, et al., 2004; D'Abrosa, et al., 2004). This compound has never been reported to have any bioactivity.

Korean pine (Pinus koraiensis) of eastern Asia is a member of white pine group of Pinus L. (Pinaceae). It is often cultivated as timber or ornamental species in the temperate Northern Hemisphere. In some cases, the pines are unwanted species.

Crested floating heart (Nymphoides cristata) is native to Asia and was introduced to North America through the aquatic plant nursery trade (Burks, 2002). It is a rooted, floating-leaved dicotyledonous aquatic plant. The plant can quickly cover the water surface with a canopy of leaves, shading out the plants below. The plant is typically found rooted in the submersed sediments in shallow water with its leaves floating on the surface of the water. It can also grow in moist soils but is capable of a free-floating form for a period of time with tuberous propagules attached to the underside of the leaf (Willey, et al., 2011). The species can be reproduced by various vegetative methods, such as tubers, daughter plants, rhizomes, and fragmentation. Since 1996, the species has become a serious weed problem in the southeastern United States, from Florida and South Carolina to east Texas. The infestation in Lake Marion, South Carolina has rapidly increased from an initial find of approximately 20 acres in 2006 to over 2,000 acres in 2011 (Willey, et al., 2011). The bio-control by fish, mechanical harvesting, herbicides with fluridone, diquat, 2,4-D, or triclopyr were found ineffective (Willey, et al., 2011). Control with combinations of glyphosate and imazapyr or endothall alone was shown to be shorted-lived; numerous re-treatments were required because regrowth often occur within several weeks after the treatment (Willey, et al., 2011). The successful control of floating heart much depends on the elimination of tubers rather than foliage damage.

Palmer's pigweed, Palmer's amaranth or carelessweed (Amaranthus palmeri) of the pigweed family is native to the North American Southwest, from southern California to Texas and northern Mexico (Mosyakin & Robertson, 2004). It is a fast-growing and highly competitive invasive species. The species is naturalized in eastern North America, Europe, Australia, and other areas. The weed is considered a threat most specifically to the production of genetically modified cotton and soybean crops because the plant has developed resistance to glyphosate, a widely-used broad-spectrum herbicide (Leonard, 2008; Powers, 2008).

Alligator weed (Alternanthera philoxeroides) is another invasive member of the pigweed family. It is native to South America but has become an important invasive species in many parts of the world. The species can grow in a variety of habitats, it can survive on dry land, and it can also form dense tangled mats floating on the surface of a body of water and thus block waterways and threaten native species.

Nopal cactus (Opuntia ficus-indica) possibly native to Mexico is often cultivated as a fruit or vegetable crop in dry areas but is also considered as an invasive species in many parts of the world.

Kudzu (Pueraria lobata) is also known as Japanese arrowroot. It is native to Asia but becomes one of the most common invasive vine species throughout the southeastern

United States. Kudzu can be reproduced by seeds, runners that root at the nodes to form new plants or rhizomes. The plant can climb over trees or shrubs and grows so rapidly that it can cover and kill them by heavy shading (Everest, et al., 1999).

Chinese tallow (Triadica sebifera) is one of the most important invasive species in the forests and wetlands in the southeastern United States. Although manual and mechanical, environmental/cultural, chemical, and biological methods have been used, the control of this species has not been successful.

Hogwort (Croton capitatus var. lindheimeri) is an annual herbaceous plant also commonly known as woolly croton or Lindheimer's hogwort in the central and eastern United States (Lorenzi & Jeffery, 1987). The plant is poisonous to livestock and honey made from its nectar can be toxic to humans (Tveten, et al., 1997). Although it is a native plant to the United States, the plant is very invasive and becomes a nuisance for pastures and cultivated fields. Croton was controlled by mowing and manual removal, as no herbicide was available which would not also harm the planted forages (Kunz, et al., 2009).

Chaya (Cnidoscolus aconitifolius) native to Mexico is a fast-growing leafy shrub crop but become invasive in some areas particularly tropical islands.

Yaupon (Ilex vomitoria), also known as yaupon holly, is native to southeastern United States. The evergreen shrub species is adapted to a wide range of soils and climate conditions. It has been widely cultivated as a landscape species, particularly as a hedge plant. However, yaupon is aggressive and is capable of forming dense pure stands which limit grass and forb production, timber species seedling establishment, and species diversity. Therefore, the species is often considered an unwanted species in the forest or range management of the southeastern United States. Yaupon is easily top-killed by burning, but can sprout from the base (Mitchell, et al., 2005). It is recommended to control yaupon invasion with herbicides after prescribed burning (Mitchell, et al. 2005).

Sweetgum (Liquidambar styraciflua), also known as sweet gum, American storax, or redgum, is one of most common hardwoods in the southeastern United States. It also occurs in southern Mexico and Central America and is cultivated in many temperate parts of the world. The tree commonly grows in various habitats and in many cases the native species becomes invasive. Sweetgum is a major component of the hardwood understory throughout the native North America range, and its prevalence and its ability to sprout quickly, vigorously, and persistently make it one of the most serious competitors of pine seedlings (Wenger, et al., 1953). Also because sweetgum has less significant economic value, it is often considered an unwanted species in forest management in the southeastern United States.

Tree of heaven (Ailanthus altissima) is native to China. It has been grown for traditional Chinese medicine and as a host plant for the ailanthus silkmoth, which is used for silk production. It is a serious threat to the native ecosystems in the introduced areas in North America and Europe (Ding et al. 2006) (Ding, et al., 2006). The rapidly growing species has become one of the most important invasive tree species in North America.

Chinese privet (Ligustrum sinense) is a deciduous shrub native to China. It has invaded mesic forests throughout the southeastern United States during the past century (Harrington, et al., 2005). It is estimated that Chinese privet now occupies over one million hectares of land in the United States (Hanula, et al., 2009).

Red kidney or common bean (Phaseolus vulgaris) is an annual herbaceous plant that originated in Central and South America and is now cultivated in the world as a crop. In some cases, the bean is an unwanted species.

Peanut (Arachis hypogaea) is native to South America and now widely cultivated in warm regions throughout the world. In some cases, peanut is an unwanted species.

Shumard oak (Quercus shumardii) and Nuttall oak (Q. texana) are red oaks native to southeastern United States. The oaks are unwanted species in some cases. Sawtooth Oak (Quercus acutissima) is naturally distributed in Asia and has become potentially invasive in parts of North America.

Water lettuce (Pistia stratiotes) is one of the most productive aquatic invasive species. It is now commonly found in most tropical and subtropical fresh waterways in the world. Mechanical harvest and biological control are major management measures to control the species in the southeast United States.

Garlic (Allium sativum) native to Central Asia has been cultivated for several thousands of years. Garlic has escaped from cultivation in some areas of North America. In some cases, garlic is an unwanted species.

Water hyacinth (Eichhornia crassipes) is an aquatic species native to South America. It has become one of most prevalent invasive aquatic species in North America, Asia, Africa, Australia, and New Zealand. This free-floating plant commonly forms dense, interlocking mats due to its rapid reproductive rate and complex root structure (Mitchell, 1985). It reproduces both sexually and asexually. The species has caused significant ecological and socio-economic effects in the world.

Sorghum Moench is a genus of the subfamily Paniocoideae of family Poaceae. Sorghum ( S. bicolor ) is native to Africa and has been cultivated as an important crop worldwide for food, animal fodder, and alcohol production. The species becomes an invasive in some situations, e.g., Lake Mead National Park, Nevada, United States.

Johnsongrass (Sorghum halepense) is native to the Mediterranean region, and has been introduced to all continents except Antarctica. Through its rapid reproduction by rhizomes and seeds, the grass can quickly invade crop fields, pastures, disturbed sites, forest edges, and along streambanks The species was recognized as one of the six most damaging weeds in the United States by the turn of the 20th Century, and was the first weed targeted by the USDA for research on control methods (McWhorter, 1989). Recently, glyphosate-resistant Johnsongrass has evolved (Powles, et al., 2008; Bennett, 2008; Wila-Aiub, et al., 2007).

Giant reed (Arundo donax) is a large perennial grass species of the subfamily Arundinoideae of family Poaceae. It is native to western Asia and northern Africa and but commonly cultivated as an ornamental species or biofuel crop. It is a highly invasive species throughout warm coastal freshwaters of North America and often unwanted species in many parts of the warm regions of the world.

Golden bamboo (Phyllostachys aurea) is woody species of the subfamily Bambusoideae of family Poaceae. It is native to southern China. The bamboo has been commonly cultivated in the United States.

Proliferating bulrush (Isolepis prolifera) endemic to South Africa is an invasive species in North America and Australia.

American grasshopper or American bird grasshopper (Schistocerca americana) is native to the eastern United States, Mexico, and the Bahamas. The grasshopper can completely defoliate plants and can cause serious damage to crops or ornamental plants. There are occasional, localized outbreaks of this grasshopper; it is often referred to as a locust (Greenlee, et al., 2004). It is considered to be the most destructive grasshopper in Florida (Capinera, 1993). It is recommended to apply insecticides before the grasshoppers are adults because it is easier to kill the nymphs (Squitier, 2005).

Tenebrio molitor L. and Zophobas morio Fabricius are members of darkling beetles family (Tenebrionidae). Their larvae are known as mealworms and superworms, respectively. Tenebrio molitor is originated from Europe and Z. morio is native tropical regions of Central and South America. Both beetle species are invasive pests in most regions of the world.

In summary, the endocide applications are useful in control and management of invasive or unwanted species by inhibiting, eliminating, and preventing them, production of organic crops by selectively controlling the weeds, and management of healthy forests by inhibiting and eliminating invasive or unwanted species.

### A. Endocides

In some embodiments, the present invention relates to compositions containing endocides and methods of controlling the growth or reproduction of invasive or unwanted species. An endocide (endogenous biocide) is a biocide derived from an endogenous bioactive agent (e.g., secondary metabolite) that does not cause apparent poison in normal growth of the producing species but will poison or inhibit and even eliminate the parent species when induced in producing species. It can selectively eliminate the parent species (and possibly its closely-related species) when externally applied. In some embodiments, the dead tissues of species caused by an endocide will enhance the endocidal function against the species. The endocide can be developed as either a pure single entity (e.g. compound) or as a mixture of compounds (e.g., a fraction of extract, an extract, a dry or fresh matter of species). The endocides can be obtained in liquid or solid format from fresh or dried matter by any effective extraction methods (e.g., expression, distillation, solvent extraction, infusion, decoction, and percolation). For aquatic species, endocides are usually water soluble and can be dissolved in water in application.

In some embodiments, the endocide is a compound modified from an endogenous bioactive agent and/or endogenous endocide, thus the endocide is a compound not found in the species wherein a nonmodified endocide is naturally found and/or the endocide is not a naturally occurring compound. In some embodiments, the endocide is an analogue or derivative of a naturally occurring endogenous bioactive agent and/or endogenous endocide.

Endocides may have effects on the invasive or unwanted species in all or some growth stages and all or some tissues. Application of endocides can eliminate and inhibit the growth and reproduction of the invasive or unwanted species. The increasing endocidal concentration in a system can provide an effective method to prevent the growth, development, and reproduction of invasive or unwanted species.

### EXAMPLES

The following examples are included to demonstrate preferred embodiments of the invention. It should be appreciated by those of skill in the art that the techniques disclosed in the examples that follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Example 1

Elimination, Inhibition, and Prevention of Green Algae by EtOH Extracts of Muskgrass (Chara vulgaris L.)

General Experimental Procedures:

Preparation of Experimental Extracts: Experimental Cladophora sp., Pithophora roettleri (Roth) Wittrock, and C. vulgaris were collected from east Texas, United States. The whole plants of C. vulgaris were dried in an oven at 65° C. for 48 h. 2.5 kg of dried plant matter was ground to a coarse powder and extracted two times for 48 h each with 95% EtOH (15 L each time) at RT. The combined EtOH extracts were concentrated under reduced pressure and the total 31.2 g extracts were obtained. The treatment experiments were conducted in the greenhouse (30° C. during the day time and 20° C. at night).

Injection Experiment I: 100 g C. vulgaris, 10 g crested floating heart (Nymphoides cristata (Roxb.) Kuntze) (Menyanthaceae), and 2 g common bladderwort (Utricularia macrorhiza LeConte) (Lentibulariaceae) were placed in each of six plastic containers (23×23 cm, 2.7 L) with 1,500 mL of tap water each. 1.5 g C. vulgaris extracts were placed into the water of each of the three containers while three other containers received no treatment to serve as control. A week later, additional 1.5 g C. vulgaris extracts were placed into the water of each of the three treated containers. The response of each plant species was recorded daily after the first treatment for two weeks.

Injection Experiment II: Initially 2 g N. cristata, 3 g U. macrorhiza, and 2 g mixture of Cladophora sp. and P. roettleriwere in each of two plastic containers (14×15 cm, 0.68 L) with 300 mL of tap water each. 0.4 g C. vulgaris extracts were placed into the water of one container while another had no treatment to serve as control. On the third and fifth day after the treatment, additional 2 g mixture of Cladophora sp. and P. roettleri was placed in each container, respectively. The response of each plant species was recorded daily after the treatment for two weeks.

Spray Experiment: 10 g extracts were dissolved and suspended in nanopure H₂O and prepared as 200 mL experimental solution at the concentration of 5% C. vulgaris extracts. Two plots (35×15 cm each) of proliferating bulrush (Isolepis prolifera (Rottb.) R. Br.) (Cyperaceae) plants cultured in water container were selected for the experiment. The first plot served as control without any treatment, the second was sprayed with 20 mL 5% extracts. The plant status was documented and photographed weekly after the treatment for four weeks.

Results: In response to the injection of 1.5 g C. vulgaris extracts (at approximately 1% concentration of C. vulgaris extracts in the experimental solution, v/v), most cells of all three green algal species (C. vulgaris, Cladophora sp., and P. roettleri) lost green color and were separated within 48 h and all were dead within a week. At the same time, neither species of flowering plants ( N. cristata or U. macrorhiza) were injured or inhibited. These two flowering plant species had no injury after the additional 1.5 g C. vulgaris extracts was applied. Additional filamentous algae (Cladophora sp., and P. roettleri) added to the container treated with C. vulgaris extracts on the third and fifth day did not grow. After the spray treatment of 20 mL 5% C. vulgaris extracts, flowering plant species I. prolifera had no injury although C. vulgaris was significantly damaged.

### Example 2

Elimination and Inhibition of Seductive Entodon Moss (Entodon seductrix (Hedw.) Mull. Hal.) and Atrichum Moss (Atrichum angustatum (Bridel) Bruch & Schimper) by Their EtOH Extracts

General Experimental Procedures:

Preparation of Experimental Extracts: A mixture of seductive entodon moss (Entodon seductrix) (Entodontaceae) and atrichum moss (Atrichum angustatum) (Polytrichaceae) (each accounts for approximately 50% of the total biomass in dry weight) were collected from Nacogdoches, Tex. The whole plant mixture was dried in an oven at 65° C. for 48 h. 180 g of dried plant matter was ground to a coarse powder and extracted two times for 48 h each with 95% EtOH (1.5 L and 1.2 L, respectively) at RT. The combined EtOH extracts were concentrated under reduced pressure and the total 8.7 g extracts were obtained. 3 g extracts were dissolved and suspended in nanopure H₂O and prepared as 30 mL experimental solution at the concentration of 10% extracts with 1% surfactant Tergitol® 15-S-9 (Sigma-Aldrich Co., St. Louis, Mo., United States) (v:v).

Spray Experiment: Three plots of mixture of both species in 30×45 cm each were selected for the experiment. The first plot served as control without any treatment, the second was sprayed with 1% Tergitol® 15-S-9 Surfactant in water solution, and the third one was sprayed with 10% EtOH extracts of mosses with 1% Tergitol®. The plant status was documented and photographed weekly after the treatment for four weeks.

Results: The plants in both control and 1% surfactant Tergitol® treatment plots had no significant changes during the four weeks of experiments. Both seductive entodon moss and atrichum moss responded to 10% EtOH extracts of mosses with approximately 1% Tergitol® on the second day after the treatments. Both moss species were dead within the four weeks.

### Example 3

Elimination and Inhibition of Giant Salvinia (Salvinia molesta D. S. Mitchell) Plants by Water Extracts of Shredded Fresh Matter of Giant Salvinia

General Experimental Procedures:

Extracts Preparation: 22 kg of fresh plants of giant salvinia at tertiary growth stage was shredded, blended, and then placed in a 50 L container with 22 L of tap water in the greenhouse (30° C. during the day time and 20° C. at night). On the seventh day of extraction, a total of 35.5 L of water extracts were collected. The experimental solution is water extracts of S. molesta with 0.5% surfactant Dyne-Amic® (methyl esters of C16-C18 fatty acids, polyalkyleneoxide modified polydimethylsiloxane, and alkylphenol ethoxylate 99%, Helena Chemical Company, Collierville, TN, United States) (v:v).

Greenhouse Tests: A total of 27 healthy and untreated living plants of S. molesta (in tertiary stage, approximately 8 g in fresh weight each) were cultured and tested in nine plastic containers (14×15 cm, 0.68 L) with three plants each in the greenhouse. The first group which included three containers with three plants each served as control without any treatment; each of three containers in a second group were sprayed with 10 mL water extracts of S. molesta; and each of three containers in a third group were sprayed with 10 mL water extracts of S. molesta with 0.5% Dyne-Amic®. A week later, a second application was made to the last two containers. The living biomass of each S. molesta plant was weighed at the end of the 3-week experiment.

Field Tests: About 150 m² of untreated S. molesta (in the tertiary stage) in the field were sprayed with 30 L of water extracts of S. molesta with 0.5% Dyne-Amic®. The percentage of control of the salvinia plants was estimated two weeks later.

Results: During the greenhouse tests, water extracts of S. molesta showed significant inhibition activity against S. molesta. Three days after application of the water extracts, at least part of the leaf blades in most leaves of the treated plants turned yellow or brown. Two weeks later, the biomass of green tissues of the plants treated with the water extracts was only 43.1% of that in control which had increased by 122.2% with the weeks. Of the nine plants treated with water extracts with 0.5% Dyne-Amic®, three plants were totally dead without any new growth, and six plants had only terminal buds in green but no growth was seen during the observation. In the field tests, about 70% of the treated S. molesta were killed or had significant injury after one foliar application of water extracts with 0.5% DyneAmic®.

### Example 4

Phytotoxicity of Compounds Isolated from the Dried Matter of Giant Salvinia (Salvinia molesta D. S. Mitchell) on Giant Salvinia

General Experimental Procedures:

Compounds Preparation: The whole plants of S. molesta were collected. Air-dried plant material (19.8 kg) was ground to a coarse powder and extracted 48 hrs with 95% EtOH (130 L×2) at RT. The combined EtOH extracts were concentrated to give a residue (640 g) under reduced pressure. The residue was then suspended in MEOH/H₂O (2,500 mL, 1:1, v/v) and extracted successively with EtOAc. The EtOAc-soluble extract (113 g) was applied to a column of Diaion HP-20 eluting with H₂O, MEOH -H₂O (30:70, 45:55, 60:40, and 80:20), and MEOH to give five fractions: F30 (30% methanol elution, 30 g), F45 (45% methanol elution, 18 g), F60 (60% methanol elution, 17.6 g), F80 (80% methanol elution, 10.3 g), and F100 (methanol elution, 10.6 g). Faction F80 (10.3 g) was separated by silica gel column chromatography eluted with a CH₂Cl₂/MeOH gradient (15:1, 10:1, 5:1, 2:1 and 0:1, v/v, each 4.0 L) to afford 6 fractions F8a-F8f. F8b was subjected to an ODS column, eluted with a gradient of MEOH/H₂O (from 40:60 to 90:10), to give three subfractions, F8b1-F8b3. F8b2 was subjected to a silica gel column, eluted with a gradient of hexane/EtOAc (from 4:1 to 0:1), to give three fractions F8b2a-F8b2c. Compounds (+)-3-hydroxy-β-ionone (compound 1) (8 mg) and (3R,6R,7E)-3-hydroxy-4,7-megastigmadien-9-one (compound 2) (5.0 mg) were purified by preparative HPLC from fraction F8b2b by preparative HPLC (MeOH/H₂O, 70:30, v/v). F8c was subjected to a silica gel column, eluted with a gradient of hexane/acetone (from 10:1 to 2:1), to yield compounds annuionone D (compound 3) (6.6 mg) and dehydrovomifoliol (compound 4) (10.9 mg). NMR experiments were performed on a JEOL ECS-400 and a Bruker Avance 700 NMR instrument. NMR data were reported as δ (ppm) values and referenced to the solvent used. HRESIMS were acquired on an electrospray instrument (MDS Sciex Pulsar Qstar, Ontario, Canada). Octadecyl-functionalized silica gel, silica gel, Diaion HP-20, and TLC plates were purchased from Aldrich Chemical Co. HPLC analysis was performed on a Hewlett Packard Series 1100 with a HP 1100 diode array detector using a SB-C18 ODS column (250×4.6 mm, 5 μM, Agilent). Preparative HPLC was performed with an Acuflow Series III pump connected with an Acutect 500 UV/VIS detector using an Econosil ODS column (250×22 mm, 10 μM, Alltech).

Bioassays: Each of the four isolated compounds was prepared as 50 μL experimental solution with nanopure H₂O at the 1% concentration. A total of 24 healthy and untreated living plants of S. molesta (in tertiary stage, approximately 5 g in fresh weight each) were cultured and tested in eight plastic containers (14×15 cm, 0.68 L) with three plants in each container in the greenhouse (30° C. during the day time and 20° C. at night). The three plants in the first container served as control without any treatment, three plants in the second container were treated with 1% DMSO, three plants in the third container were treated with 5% DMSO, three plants in the fourth container were treated with 0.5% Dyne-Amic®, and the plants in each of the other four containers were treated with each of the four testing isolates, respectively. For each of the three plant in the 0.5% Dyne-Amic® treatment, 8 μL of 0.5% Dyne-Amic® was applied on the lower surface of each of the two mature leaf blades close to the terminal bud by pipet and 8 μL of 0.5% Dyne-Amic® was applied on the upper surface (with trichomes) of each of the two other mature leaf blades close to the terminal bud by pipet. For all three plants in each of the DMSO or testing isolates treatment containers, 8 μL of each experimental solution was applied on the lower surface of each of the two mature leaf blades close to the terminal bud by pipet. The leaf surfaces of the experimental plants were checked daily by a ×60 portable microscope linked to an iPhone™.

Results: The leaves of S. molesta without any treatment (control), 1% DMSO, or 0.5% Dyne-Amic® on the low leaf surfaces had no observable changes during the one week of experiment. The plant leaves treated with 5% DMSO on the lower leaf surfaces had slight injury by the end of experiment, However, all six leaves of S. molesta treated with 0.5% Dyne-Amic® on the upper leaf surfaces had obvious trichome damage within 24 h and the tissues in the Dyne-Amic® contact area were dead by the end. Surfactant Dyne-Amic® showed no phyotoxicity against giant salvinia, but exposure to released endocide because of Dyne-Amic® application to the trichomes on upper leaf surfaces inhibited growth and even destroyed the leaf blades.

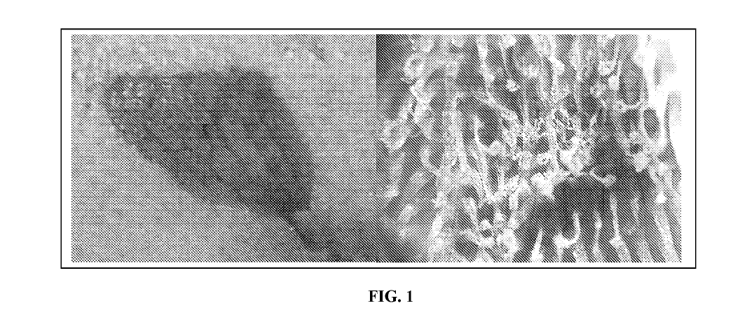

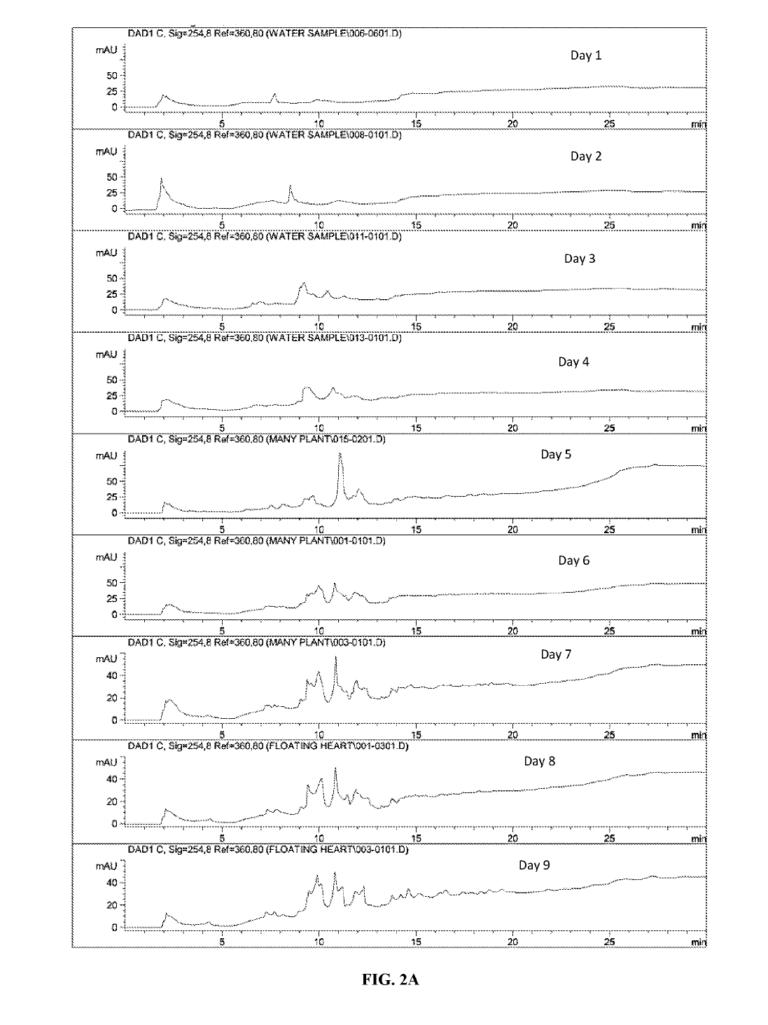

The six leaf blades treated with compound 1 ((+)-3-hydroxy-β-ionone) at the amount of 8 μL/leaf had significant injury within 12 h of the treatments (FIG. 1 and Table 1), and two leaves were dead by the end of experiment. The leaves treated with compound 2 ((3R,6R,7E)-3-hydroxy-4,7-megastigmadien-9-one), compound 3 (annuionone D), or compound 4 (dehydrovomifoliol) at the amount of 8 μL/leaf had no or slight injury during the two weeks of observation.

TABLE 1
Bioactivity of four compounds isolated from S. molesta against the
producing species

| | | | Activity |
|---|---|---|---|
| | | | against |
| Compound | | | Giant |
| No. | Name | Structure | Salvinia |
| 1 | (+)-3-Hydroxy- β-ionone | 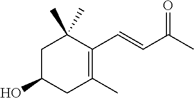 | Potent activity |
| 2 | (3R,6R,7E)-3- Hydroxy-4,7- megastigmadien- 9-one | 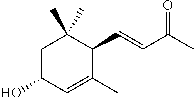 | Weak activity |
| 3 | Annuionone D | 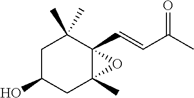 | No activity |
| 4 | Dehydrovomifoliol | 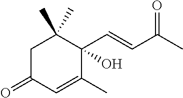 | No activity |

### Example 5

Prevention of Giant Salvinia (Salvinia molesta D. S. Mitchell) Growth by Its Dried Matter

General Experimental Procedures: Air-dried whole plants of S. molesta were ground to a coarse powder and placed in nylon net bags (called “tea bags”). Each of three containers had 400 g living healthy plants of S. molesta in all growth stages (primary, secondary, and tertiary stages) in 25 L of tap water with a bag of 400 g S. molesta dried matter at the bottom. The experiment was conducted in the greenhouse (30° C. during the day time and 20° C. at night). All plants were dead by the end of the second week and totally decomposed within six months. Then each of the three containers was refilled with tap water to 25 L and was used to culture 110 g healthy young and mature S. molesta plants (10 g in primary stage and 100 g in tertiary stage). The same amount of S. molesta plants were also placed in three other containers with 25 L of tap water each to serve as control. Each of the six containers was maintained at 25 L water level in the next six months and the experiments were conducted in the greenhouse (30° C. during the day time and 20° C. at night).

Results: Both young and mature S. molesta plants had significant growth and total fresh biomass increased to 246.9±54.2 g at average from 110 g in the control group during the first three months of experiments. In all three containers previously treated by 400 g “tea bags”, the young S. molesta plants in primary stage initially grew slightly but soon became unhealthy within two weeks and all were dead by the end of three months. In these containers, all mature S. molesta plants became unhealthy after two weeks of culture and root-like submerged leaves were dead. Although young leaves develop from some terminal buds, all plants were eventually dead by the end of three months. Further, no S. molesta growth was observed in these “tea bags” treatment containers in over the subsequent three months of experiments.

### Example 6

Inhibition of Seed Germination of Korean Pine (Pinus koraiensis Siebold & Zucc.) by Its Seed EtOH Extracts

General Experimental Procedures:

Extracts Preparation: Seeds of Korean pine (Pinus koraiensis Siebold & Zucc.) (Pinaceae) was purchased from F.W. Schumacher Co, Inc. in Sandwich, Mass., United States. 156 g dried P. koraiensis seeds were ground to coarse powders and extracted two times for 48 h with 95% EtOH (600 mL each time) at RT. Extracts were evaporated under reduced pressure, and 13 g EtOH extracts were obtained. 5 g EtOH extracts were dissolved and suspended in nanopure H₂O and prepared as 100 mL experimental solution at the concentration of 5%.

Extracts Yield of Experimental Seeds: Based on the seed weight and extraction rate (8.34%, in dry weight) of the above extraction method, it is estimated that the plant matter used in the soaking treatment (30 P. koraiensis seeds) could produce 1.05 g EtOH extracts. To further reveal the actual amount of the EtOH extracts contained in the plant matter, a more effective extraction of 30 P. koraiensis seeds (12.6 g) was performed using a ASE 2000 Accelerated Solvent Extractor (60° C., 1500 psi, 30 min static time, 100% volume flush, 120 s purge, and 2 cycles). According to this extraction rate, 30 P. koraiensis seeds contain at least 1.21 g EtOH extracts.

Soaking Treatments and Germination Tests: 270 P. koraiensis seeds in total were selected and 30 seeds in a plastic container (14×15 cm, 0.68 L) were subjected to one of the following three treatments with three replications per treatment: stored in 4° C. and then directly sowed in the pots in greenhouse (control), soaked in 15 mL nanopure H₂O at RT for five weeks before sowing in the pots, and soaked in a 15 mL 5% solution of P. koraiensis extracts (0.75 g extracts) at RT for five weeks before sowing in the pots. All experimental seeds were sowed in the pots with Miracle Grow Potting Mix soil in a greenhouse (30° C. during the day time and 20° C. at night). The seed germination number of each treatment was recorded weekly throughout the experimental period.

Results: By the end of the ninth week, 34.5% seeds without any treatment germinated vs. 2.2% germination among the seeds treated by water soaking for five weeks. There was and no germination among the seeds treated by 5% P. koraiensis extracts for five weeks and all of the treated seeds lost viability.

### Example 7

### Elimination and Prevention of Crested Floating Heart (Nymphoides Cristata (Roxb.) Kuntze) by Its EtOH Extracts

General Experimental Procedures:

Extracts Preparation: The whole plants of N. cristata heart were collected from Texas, United States. The plants were dried in an oven at 65° C. for 48 h. The oven-dried plant matter (3,600 g) was ground to a coarse powder and extracted with 95% EtOH at RT twice (each with 20 L and 12 L, respectively) for 48 h each time. The combined EtOH extracts were concentrated under reduced pressure to yield 420 g of final extracts. 100 g extracts were dissolved and suspended in nanopure H₂O and prepared as 1,000 mL experimental solution at the concentration of 10%. Of the 1,000 mL 10% experimental extracts, 300 mL was prepared as the 10% extracts solution with 1% surfactant Dyne-Amic® (v:v), 150 mL was further diluted into 300 mL with H₂O and then was prepared as the 5% extracts solution with 0.5% Dyne-Amic® (v:v), and 100 mL was further diluted into 400 mL with H₂O and then was prepared as the 2.5% extracts solution with 0.5% Dyne-Amic® (v:v).

Foliar Spray: Each of the five containers had 300 g of living healthy plants of N. cristata (with a mixture of mature and young leaves, tubers, daughter plants, rhizomes, and fragmentation) in 25 L of tap water in the greenhouse (30° C. during the day time and 20° C. at night). Three containers served as controls: one had no treatment, the second one received foliar treatment of 5% EtOH in the amount of 100 mL on each of the first and second days, respectively, and the third one received 1% Dyne-Amic® foliar treatment in the amount of 100 mL on each of the first and second days, respectively. Each of the three treatment containers received foliar spray treatment with 10% EtOH extracts with 1% Dyne-Amic®, 5% EtOH extracts with 0.5% Dyne-Amic®, or 2.5% EtOH extracts with 0.5% Dyne-Amic®, in the amount of 100 mL on each of the first and second days, respectively. Living biomass of N. cristata plants in each of the containers were weighed weekly after the treatment for six weeks.

Results: During the six weeks of experiments, no plant death or injury was observed in any plants in the containers of control, 5% EtOH, or 1% Dyne-Amic®. The plants in the foliar application of 10% EtOH extracts with 1% Dyne-Amic® started to die on the second day of the treatment and all plants including mature and young leaves, tubers, daughter plants, rhizomes, and fragments in this container were dead by the 4^{th} day. On the 5^{th} day of the treatment, 150 g additional living N. cristata plants were placed in this treatment container and all were dead on the next day. The plants in the foliar applications of 5% EtOH extracts with 0.5% Dyne-Amic® or 2.5% EtOH extracts with 0.5% Dyne-Amic® had slower responses to the treatments. By the end of the 4^{th} week, all plants that were treated by 5% EtOH extracts with 0.5% Dyne-Amic® were dead. Then 88.34% of the plants in the container treated by 2.5% EtOH extracts with 0.5% Dyne-Amic® were dead with only 35 g of living plants left.

### Example 8

Production of Active Water Extracts from Whole Fresh Matter of Crested Floating Heart (Nymphoides cristata (Roxb.) Kuntze)

General Experimental Procedures:

Extracts Preparation: The 10 kg of whole fresh plants of N. cristata was placed in each of the three 50 L containers in the greenhouse (30° C. during the day time and 20° C. at night) and 40 L of tap water was added to each container. During the nine days of extraction, approximately a total of 48 L of H₂O extracts was collected from each container.

HPLC analysis of daily chemical changes: 100 mL of H₂O extracts was collected daily from the bottom of each of the containers for nine days. After filtration, the H₂O extracts samples were analyzed by HPLC. The HPLC chromatographs of the H₂O extracts were established by Agilent 1100 HPLC system coupled to an Agilent 1100 diode array detector, and an Eclipse XDB-C18 column (4.6×150 mm, 3.5 μM) at a flow rate of 0.6 mL/min. A gradient elution was performed by using H₂O (A) and CH₃CN (B) as mobile phases. Elution was performed according to the following conditions: 2% B at time 0, linear increase to 98% B in 22 min, and hold 98% B for 8 min. The column temperature was maintained at 23° C. The HPLC chromatogram was standardized on retention times and peak intensities of the peaks observed at a wavelength of 254 nm and 280 nm. The injection volume was 50 μL for all analyses. The total chemical contents of the H₂O extracts were estimated by the total peak areas of daily samples.

Bioassays: 400 mL of the water extracts of N. cristata was collected on day 5 of extraction. Of this sample, 200 mL was prepared as the H₂O extracts solution with 0.5% Dyne-Amic® (v:v). The remaining 200 mL was autoclaved at 121° C. with a pressure of 103.42 kPa (15 psi) using sterilmatic sterilizer (Market Forge Industries Inc., Everett, Mass.) for 30 min. The autoclaved sample was then prepared as the sterilized H₂O extracts with 0.5% Dyne-Amic® (v:v). Each of the three containers had 200 g of living healthy plants of N. cristata (with a mixture of mature and young leaves, tubers, daughter plants, rhizomes, and fragmentation) in 25 L of tap water in the greenhouse (30° C. during the day time and 20° C. at night). One container served as control (without any treatment), one received the foliar application of 200 mL of H₂O extracts of crested floating heart with Dyne-Amic®, and the last container had foliar application of the autoclaved 200 mL of H₂O extracts of N. cristata with Dyne-Amic®. Living biomass of N. cristata plants in each of the containers were weighed weekly after the treatment for six weeks.

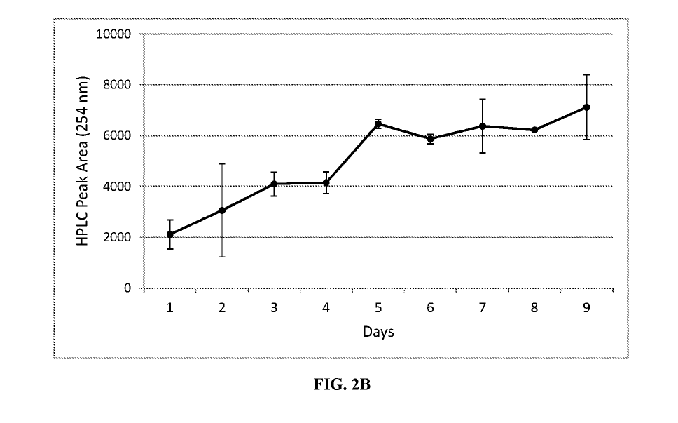

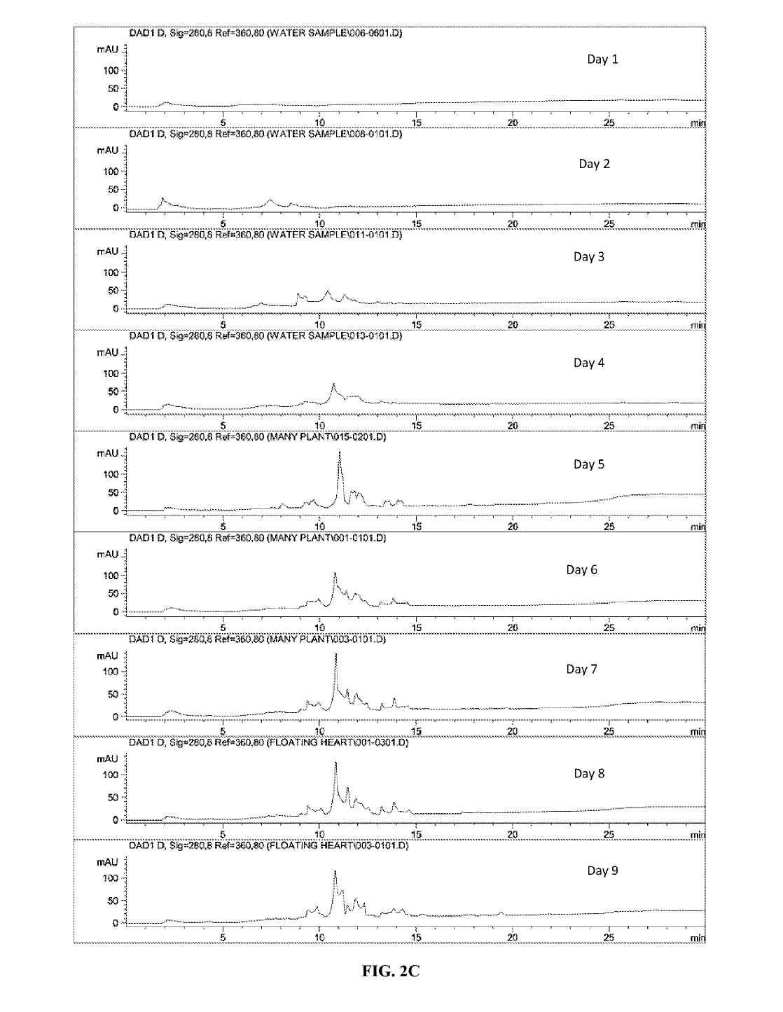

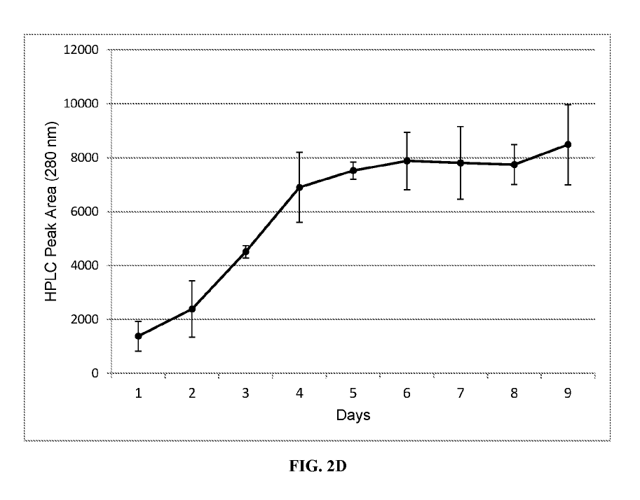

Results: According to daily HPLC chromatographic analyses at both 254 and 280 nm, the total chemical diversity and chemical levels in the H₂O extracts from the whole plants were much higher on day 5 than those in the previous four days and were stabilized thereafter (FIG. 2). The HPLC analysis shows that there are no significant changes in chemical constituents in H₂O extracts before and after sterilization. The plants treated with either sterilized or nonsterilized H₂O extracts of N. cristata plants with 0.5% Dyne-Amic® had significant injury on the third day of the foliar treatment. By the end of the fifth week, all plants treated with nonsterilized H₂O extracts were dead and more than 75% of the plants treated with sterilized H₂O extracts were dead in comparison with the healthy plants in control.

### Example 9

Production of Active Water Extracts from Shredded Fresh Matter of Crested Floating Heart (Nymphoides cristata (Roxb.) Kuntze)

General Experimental Procedures:

Extracts Preparation: 1 kg of whole fresh plants of N. cristata was shredded, blended, and placed in each of the three 5 L containers at RT and 4 L of tap water was added to the container. During the nine days of extraction, approximately total 4.9 L of H₂O extracts were collected from each container.

HPLC analysis of daily chemical changes: 10 mL of H₂O extracts were collected daily from the bottom of the container for nine days. After filtration, the H₂O extracts samples were analyzed by HPLC. The HPLC chromatographs of the H₂O extracts were established by Agilent 1100 HPLC system coupled to an Agilent 1100 diode array detector, and an Eclipse XDB-C18 column (4.6×150 mm, 3.5 μM) at a flow rate of 0.6 mL/min. A gradient elution was performed by using H₂O (A) and CH₃CN (B) as mobile phases. Elution was performed according to the following conditions: 2% B at time 0, linear increase to 98% B in 22 min, and hold 98% B for 8 min. The column temperature was maintained at 23° C. The HPLC chromatogram was standardized on retention times and peak intensities of the peaks observed at a wavelength of 254 nm and 280 nm. The injection volume was 50 μL for all analyses. The total chemical contents of the H₂O extracts were estimated by the total peak areas of daily samples.

Bioassays: 200 mL of the H₂Oextracts of N. cristata collected on the day 1 of extraction and was prepared as the H₂O extracts with 0.5% Dyne-Amic® (v:v). Each of the two containers had 200 g of living healthy plants of N. cristata (with a mixture of mature and young leaves, tubers, daughter plants, rhizomes, and fragmentation) in 25 L of tap water in the greenhouse (30° C. during the day time and 20° C. at night). One container served as control (without any treatment), one received the foliar application of 200 mL of H₂O extracts of N. cristata with Dyne-Amic. Living biomass of N. cristata plants in each of the containers were weighed weekly after the treatment for six weeks.

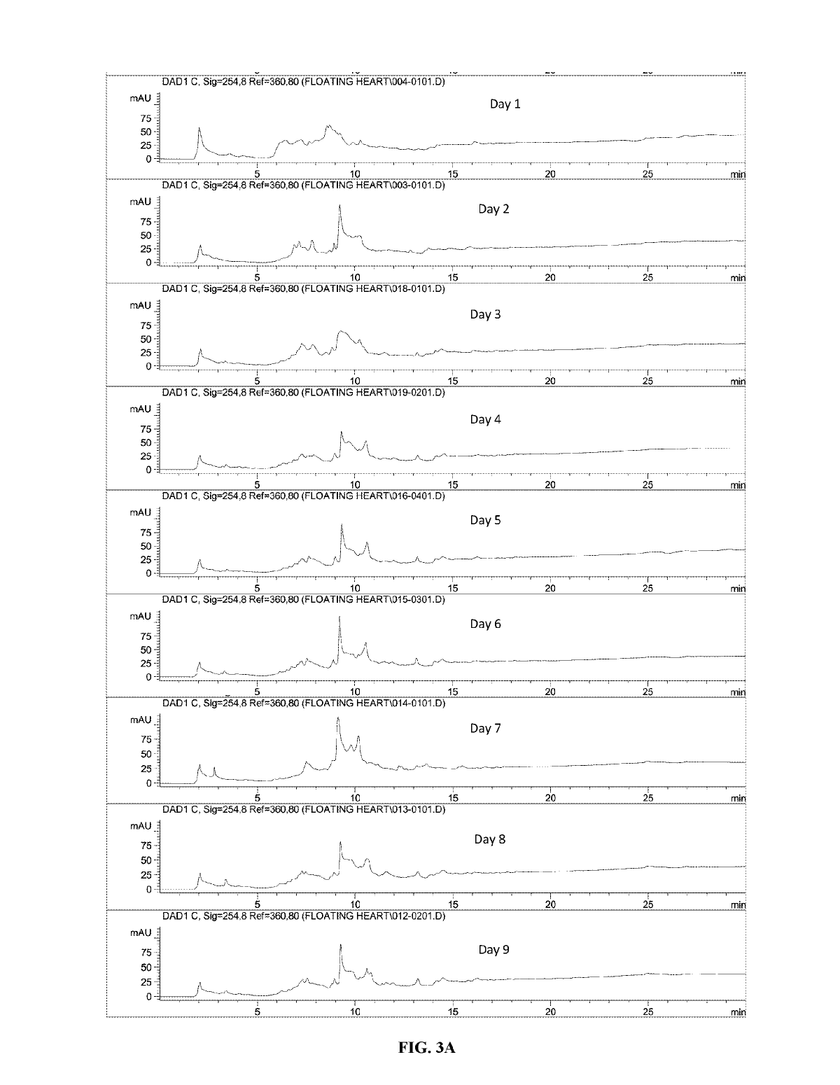

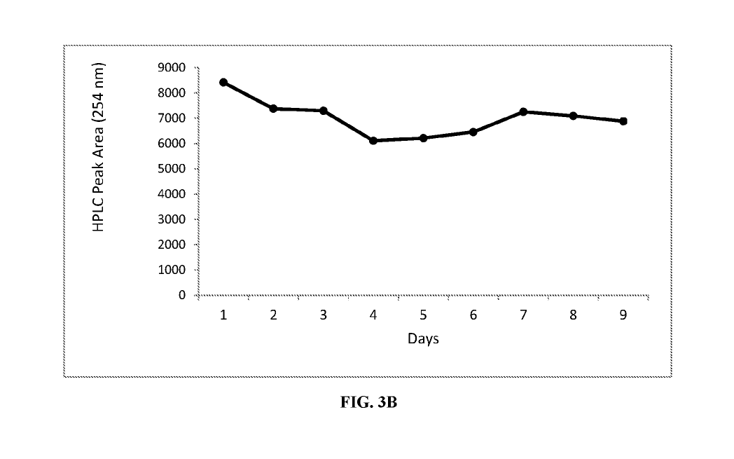

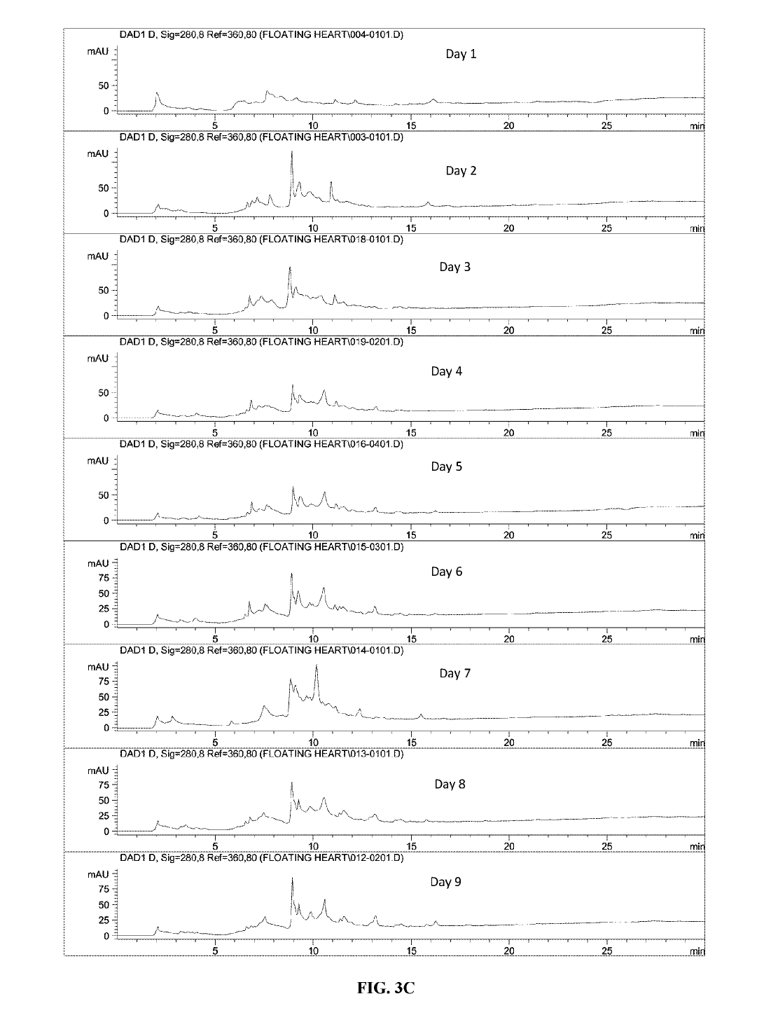

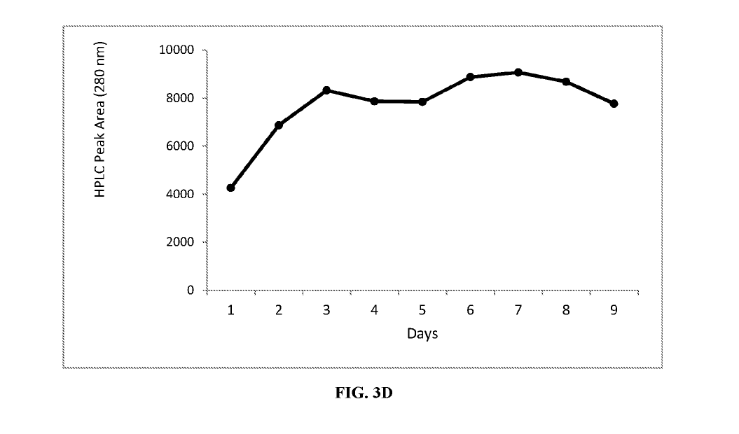

Results: According to daily HPLC chromatographic analyses at both 254 and 280 nm, the total chemical diversity and levels in the H₂O extracts reached relatively stable point on day 3, much quicker than those in the whole plant extraction (see Example 8) (FIG. 3). The plants treated with H₂O extracts of N. cristata from the first day of collection with Dyne-Amic® had significant injury on the third day of the foliar treatment. By the end of the 4^{th} week, all plants in these containers were dead in comparison with the healthy plants in control.

### Example 10

Phytotoxicity of Crested Floating Heart (Nymphoides cristata (Roxb.) Kuntze) EtOH Extracts

General Experimental Procedures:

Extracts Preparation: The EtOH extracts of the whole plants of N. cristata were prepared as described in the Example 7. 100 g extracts were fractionated by Si-gel column with a gradient of n-Hexane/Acetone (8:1 to 1:3) to get four fractions: A (12.6 g), B (18.4 g), C (16.9 g), and D (22.3 g). Fraction A of the N. cristata EtOH extracts was prepared in 1% experimental solution with nanopure H₂O.

Bioassays: 10 μL 1% EtOH extracts of N. cristata were applied by pipet on the three locations of per upper leaf surface of the intact N. cristata plants. The treated leaves were evaluated and photographed for two weeks.

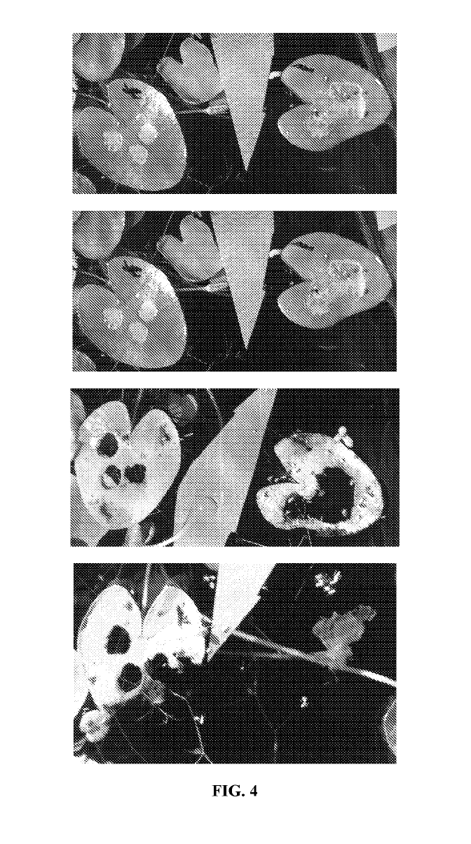

Results: The application of 10 μL fraction A of EtOH extracts of N. cristata can kill the plant within two weeks (FIG. 4).

### Example 11

Selective Toxicity of EtOH and Water Extracts of Crested Floating Heart (Nymphoides cristata (Roxb.) Kuntze) against Crested Floating Heart over Giant Salvinia (Salvinia molesta D. S. Mitchell), Carolina Mosquito Fern (Azolla caroliniana Willd), Least Duckweed (Lemna minuta Kunth), Brazilian watermeal (Wolffia brasiliensis Weddell), and Water Lettuce (Pistia stratiotes L.)

General Experimental Procedures:

Preparation of the H₂O extracts of N. cristata: 10 kg of whole fresh plants of N. cristata was placed in each of three 50 L containers in the greenhouse (30° C. during the day time and 20° C. at night) and 40 L of tap water was added to each container. During the nine days of extraction, approximately a total of 48 L of H₂O extracts was collected from each container. The experimental H₂O extracts were obtained from the containers on the fifth day. 200 mL of the H₂O extracts were prepared as the H₂O extracts with 0.5% Dyne-Amic® (v:v).

Preparation of the EtOH extracts of N. cristata: The whole plants of N. cristata were collected from East Texas. The plants were dried in an oven at 65° C. for 48 h. The oven-dried plant matter (3,600 g) was ground to a coarse powder and extracted with 95% EtOH at RT twice (each with 20 L and 12 L, respectively) for 48 h each time. The combined EtOH extracts were concentrated under reduced pressure to yield 420 g final extracts. 200 mL of 2.5% EtOH extracts with 0.5% Dyne-Amic® (v:v) and 200 mL of 5% EtOH extracts with 0.5% Dyne-Amic® (v:v) were prepared separately.

Selectivity Tests: Each of six containers had 300 g living healthy plants of N. cristata (with mixtures of mature and young leaves, tubers, daughter plants, rhizomes, and fragmentation), 15 g S. molesta of the tertiary stage, 5 g S. molesta of the primary stage, 5 g A. caroliniana, three plants (approximately 30 g) of water lettuce (Pistia stratiotes L., Araceae), and 5 g mixture of least duckweed (Lemna minuta, Araceae) and Brazilian watermeal (Wolffia brasiliensis Weddell, Araceae) in 25 L of tap water in the greenhouse (30° C. during the day and 20° C. at night). One container served as control without any treatment. Four treatment containers each received either foliar spray treatment with H₂O extracts, H₂O extracts with Dyne-Amic®, 2.5% EtOH extracts with 0.5% Dyne-Amic®, or 5% EtOH extracts with 0.5% Dyne-Amic®, in the amount of 100 mL on each of the first and second days, respectively. For another container, a total of 400 mL (200 mL each of the first and second days) of H₂O extracts (without surfactant) was slowly injected into the water (approximately 5 cm from the surface) by a pipette. Living biomass of N. cristata in each of the containers were weighed weekly after the treatment for six weeks.

Results: During the six weeks of experiments, no death or injury of any species was observed in any plants in the control. In the foliar treatments of H₂O extracts with Dyne-Amic®, 2.5% EtOH extracts with 0.5% Dyne-Amic®, or 5% EtOH extracts with 0.5% Dyne-Amic®, all plants of S. molesta, A. caroliniana, and P. stratiotes sunk into the water and died during the first three days of the experiments. All N. cristata plants in these three treatments were dead although some dead leaves were still green in color and floated on the water surface by the end of the second week. At the end of experiment, all plants of N. cristata, S. molesta, and P. stratiotes were dead and decomposed but L. minuta plants grew well in all three treatments with W. brasililensis survived in the container treated with H₂O extracts with 0.5% Dyne-Amic®.

In both foliar application and injection treatments with the H₂O extracts (without surfactant), all duckweed and W. brasiliensis grew well. In the foliar treatment with 200 mL of the H₂O extracts (without surfactant), three plants of N. cristata were dead and a few others had some injury and approximately 30% of A. caroliniana plants were dead by the end of second week. Some plants of both S. molesta and P. stratiotes had some injury but soon had new growth during the experiment. All N. cristata plants in the treatment of injection of 400 mL of H₂O extracts (without surfactant) were dead except one plant by the end of the second week of experiment. All other species in this treatment were still green in color with significant injury in all submerged tissues of S. molesta, P. stratiotes, and A. caroliniana. However, during the third week, new plants had soon reproduced from these injured plants.

It is possible that the observed effects of giant salvinia and water lettuce caused by the foliar applications of the extracts of crested floating heart may occur because the extracts damaged some trichomes in these species and the damaged trichomes release endocidal chemicals in the these species sufficient to kill themselves.

### Example 12

Selective Toxicity of EtOH Extracts of Crested Floating Heart (Nymphoides cristata (Roxb.) Kuntze) against Crested Floating Heart over Muskgrass (Chara vulgaris L.) and Bladderwort (Utricularia macrorhiza LeConte)

General Experimental Procedures:

Extracts Preparation: The whole plants of N. cristata were collected from East Texas. The plants were dried in an oven at 65° C. for 48 h. The oven-dried plant matter (70.3 g) was ground to a coarse powder and extracted with 95% EtOH at RT twice (each with 1,000 mL each) for 48 h each time. The combined EtOH extracts were concentrated under reduced pressure to yield 4.5 g final extracts.

Selectivity Tests: The treatment experiments were conducted in the greenhouse (30° C. during the day time and 20° C. at night).

Injection Experiment I: 60 g C vulgaris, 10 g crested floating heart (Nymphoides cristata), and 2 g common bladderwort (Utricularia macrorhiza) were placed in each of six plastic containers (23×23 cm, 2.7 L) with 1,200 mL of tap water each. 1.5 g N. cristata extracts were placed into the water of each of the three containers while three other containers received no treatment to serve as control. Living biomass of each species in each of the containers were weighed 48 h after the treatment.

Results: All leaves and stems of the plants of N. cristata treated by N. cristata extracts were dead within 48 h of the treatment and only one or two rhizomes were still alive (2.13±2.23 g) in comparison with the vigorous plants in the control group (with average living biomass at 11±0.5 g). The biomass weight of C vulgaris did not show significant difference between N. cristata extracts treatment and control (59.3±2.03 g vs. 59.5±13.5 g, respectively) but about 40-50% of the C vulgaris plants lost green color. There is no measurable or observable difference for U. macrorhiza between the N. cristata extracts treatment and control.

### Example 13

Elimination and Prohibition of Giant Salvinia (Salvinia molesta) by Water Extracts of Crested Floating Heart (Nymphoides cristata) in the Field Tests

General Experimental Procedures: 30 L of the H₂O extracts from Example 8 were prepared as H₂O extracts with 0.5% Dyne-Amic® (v:v). 50 m² of giant salvinia (tertiary stage) was sprayed twice with 15 L each on the first and 6^{th} day of the experiment, respectively. Seedlings of buttonbush (Cephalanthus occidentalis L.) (family Rubiaceae) and bald cypress (Taxodium distichum (L.) Rich. var. distichum) (family Cupressaceae) in the lot were also sprayed. The percentage of control of the salvinia plants on surface layer was estimated by the end of the 4^{th} week.

Results: By the end of the experiment, over 90% of giant salvinia on the surface layer were dead and both buttonbush and bald cypress seedlings had no significant injury following the two treatments of H₂O extracts of crested floating heart. It is possible that the observed effects of giant salvinia caused by the foliar applications of the extracts of crested floating heart is mainly because the extracts damaged some trichomes in the species and the damaged trichomes released sufficient endocidal chemicals to kill the plants themselves.

### Example 14

Elimination and Inhibition of Palmer's Pigweed (Amaranthus palmeri S. Wats.) by Its EtOH Extracts

General Experimental Procedures:

Extracts Preparation: The whole plants of Palmer's pigweed (Amaranthus palmeri) were collected from a soybean field in the central Louisiana, United States where A. palmeri survived from a recent glyphosate application. The plants were dried in an oven at 65° C. for 48 h. 3,200 g of dried plant matter was ground to a coarse powder and extracted two times for 48 h each with 95% EtOH (20 L and 12 L, respectively) at RT. The combined EtOH extracts were concentrated under reduced pressure and a total of 66 g extracts were obtained. 30 g extracts were dissolved and suspended in nanopure H₂O and prepared as a 300 mL experimental solution at the concentration of 10% extracts. Before treatment, 300 mL 10% water solution was prepared as the 10% extracts with 1% surfactant Tergitol® 15-S-9 (Sigma-Aldrich Co., St. Louis, Mo., United States) (v:v).

Foliar Sprays: 20 healthy glyphosate-resistant plants (c. 30 cm foliage height) of Palmer's pigweed in the field (in the site of plant matter collection) were selected for the experiment. 10 plants served as control without any treatment while the other 10 plants were sprayed with 100 mL 10% EtOH extracts of pigweeds with 1% Tergitol® 15-S-9 twice in the first month. In each treatment, the plants of big-rooted morning glory or wild potato vine (Ipomoea pandurata (L.) G.F.W. Mey.) (Convolvulaceae) associated with the pigweed were also treated. The plant heights and living biomass of plants in control or treatment were measured by the end of the two-month experiment.

Results: Some leaves and flower spikes of the 10 treated pigweed plants with 10% EtOH extracts of pigweeds with 1% Tergitol® were injured five days after the treatments. The EtOH extracts from glyphosate-resistant A. palmeri can eliminate glyphosate-resistant A. palmeri on the same site within 40 days. At the same dosage, the extracts had no significant damage on the associated I. pandurata. The foliage height of the plants in control reached 52 cm at average and all produced spikes of seeds.

### Example 15

Phytotoxicity of EtOH Extracts of Palmer's Pigweed (Amaranthus palmeri S. Wats.) on Palmer's Pigweed

General Experimental Procedures:

Extracts Preparation: EtOH extracts were prepared from glyphosate-resistant plants of Palmer's pigweed (A. palmeri) in central Louisiana, United States (see Example 14). 1 g EtOH extracts of A. palmeri were prepared in 10 mL experimental solution with nanopure H₂O at the concentration of 10%.

Bioassays: The experimental plants were 3-week-old A. palmeri seedlings germinated from the seeds collected from the above described glyphosate-resistant plants. The seedlings were grown in pots with Miracle Grow Potting Mix soil in the greenhouse (30° C. during the day time and 20° C. at night). The intact seedling plants of 3-week old Q. texana and 2-month-old L. styraciflua grown in pots in greenhouse were also tested in this experiment. 10 μL 0.5% glyphosate and 10% EtOH extracts of A. palmeri were applied seprately by pipet on the upper or lower leaf surfaces of three plants of each species, respectively. For each plant species, three upper leaves and three lower leaves were treated separately. The leaf surfaces of the experimental plants were checked daily for two weeks by a ×60 portable microscope linked to an iPhone™.

Results: Of the three testing species, only A. palmeri had no injury by 10 μL 0.5% glyphosate. The tissues in the leaf spots of A. palmeri treated by 10 μL 10% EtOH extracts of A. palmeri with either upper or lower surface applications were totally destroyed within two weeks. Both Q. texana and L. styraciflua seedlings had not been affected by the EtOH extracts of A. palmeri with either upper or lower surface applications.

### Example 16

Elimination and Inhibition of Alligator Weed (Alternanthera philoxeroides Griseb.) by Its EtOH Extracts

General Experimental Procedures:

Extracts Preparation: The whole plants of alligator weed (Alternanthera philoxeroides Griseb.) were collected from Nacogdoches, Tex. The plants were dried in an oven at 65° C. for 48 h. 750 g of dried plant matter was ground to a coarse powder and extracted two times for 48 h each with 95% EtOH (12 L and 10 L, respectively) at RT. The combined EtOH extracts were concentrated under reduced pressure and the total 43 g extracts were obtained. 30 g extracts were dissolved and suspended in nanopure H₂O and prepared as 300 mL experimental solution at the concentration of 10% with 0.25% Dyne-Amic® (Helena Chemical Company, Collierville, Tenn., United States) (v:v) and 0.125% Kinetin® (proprietary blend of polyalkyleneoxide modified polydimethylsiloxane 99%, Helena Chemical Company, Collierville, Tenn., United States) (v:v).

Foliar Sprays: Foliar application of 30 mL alligator weed extracts with surfactant was made on 0.25 m² of alligator weed plants (22 plants) in the field. The foliar applications were also on T sebifera and a species knotweed (Polygonum sp.) at the same time. The status of the test plants were documented and photographed daily after the treatment.

Results: The treated A. philoxeroides plants had significant injury with two plant deaths five days after being treated with 10% EtOH extracts of alligator weed extract with surfactants. No leaf injury was found on either T. sebifera or Polygonum sp.

### Example 17

Elimination and Inhibition of Nopal Cactus (Opuntia ficus-indica (L.) Mill.) Stems by Their EtOH Extracts

General Experimental Procedures:

Extracts Preparation: The fleshy oval stems (pads or paddles) of nopal cactus (Opuntia ficus-indica (L.) Mill.) (Cactaceae) (300 g in dry weight) were ground to a coarse powder and extracted two times for 48 h each with 95% EtOH (1.2 L each time) at RT. The combined extracts were concentrated to give 16.6 g under reduced pressure. The 5 g extracts were dissolved in nanopure H₂O and prepared as 100 mL experimental solution at the concentration of 5% EtOH extracts of cactus.

Extracts Yield of Experimental Plant Matter: Based on the plant matter weight and extraction rate (5.54%, in dry weight) of the above extraction method, it is estimated that the plant matter used for soaking treatment (six O. ficus-indica stems) could produce 4.93 g EtOH extracts.

Soaking Experiment: 12 pieces of O. ficus-indica stems (15-17 cm) were prepared and subjected to two treatments. Six O. ficus-indica stems were cultivated in 100 mL nanopure H₂O to serve as control and six stems were cultivated in 100 mL 5% EtOH extracts of O. ficus-indica (5 g extracts) for 12 days at RT.

Growth and Propagation Tests: Each experimental O. ficus-indica stems was placed in a one-gallon pot with Miracle Grow Potting Mix soil in the greenhouse. The living status of individuals was recorded once every week throughout the experimental period.

Results: By the end of second month, all stems of O. ficus-indica in the control group were alive while only two of the six stems treated with O. ficus-indica extracts survived.

### Example 18

Inhibition and Elimination of Broccoli (Brassica oleracea L.) by Its Seed EtOH Extracts

General Experimental Procedure:

Preparation of Seed Extracts: The seeds of Brassica oleracea L. (Brassicaceae) were dried in an oven at 65° C. for 48 h. 120 g dried seeds were ground to coarse powder and were extracted two times for 48 h each with 95% EtOH (400 mL each time) at RT. Extracts were evaporated under reduced pressure. 4 g EtOH extracts were obtained and then stored in 4° C. 1 g B. oleracea seed extracts were dissolved in nanopure H₂O and prepared as 200 mL experimental solution at the concentration of 5%.

Extracts Yield of Experimental Plant Matter: Based on the plant matter weight and extraction rate (3.34%, in dry weight) of the above extraction method, it is estimated that the plant matter used in the soaking treatment (300 B. oleracea seeds) could produce 0.03 g EtOH extracts. To further reveal the actual amount of the EtOH extracts contained in the plant matter, a more effective extraction of small smaller sample (0.88 g) was performed using a ASE 2000 Accelerated Solvent Extractor (60° C., 1500 psi, 30 min static time, 100% volume flush, 120 s purge, and 2 cycles). According to this extraction rate, 300 B. oleracea seeds produced 0.1 g EtOH extracts.

Soaking Treatments and Germination Tests: 2,700 B. oleracea sound seeds were selected and 300 seeds in a Petri dish were subjected to one of the following soaking treatments at RT with three replications per treatment: a 10 mL nanopure H₂O for 48 h, a 10 mL 5% solution of B. oleracea seed extracts (0.5 g extracts) for 48 h, and a 10 mL 5% solution of B. oleracea seed extracts (0.5 g extracts) for two weeks. Seed germination in each dish was surveyed by the end of soaking treatment. Then the individual seeds were removed from the treatment solution and sowed in a germination box with soil (50 seeds per box) in the greenhouse (30° C. during the day time and 20° C. at night). The number of germinated individuals was recorded once every week throughout the 4-week experimental period.

Results: In the water soaking treatment, B. oleracea seeds started to germinate soon and approximately 88.5% seeds had germinated within 48 h. But there was no seed germination in both extracts treatments by the end of soaking experiment (48 hours or two weeks). By the end of four weeks of germination culture in the soil, only 58.7% seedlings developed from the B. oleracea seeds soaked in water and about 30% could not survive after germination because of the newly developed shoots were damaged during the seed sowing process. After removal of the B. oleracea seed extracts, 67.8% and 0.2% of B. oleracea seeds developed seedlings after being soaked in 5% B. oleracea seed extracts for 48 h or two weeks, respectively. All ungerminated seeds in the extracts treatments lost viability.

### Example 19

Elimination and Inhibition of Kudzu (Pueraria lobata (Wild.) Ohwi) by Its EtOH Extracts

General Experimental Procedures:

Extracts Preparation: The whole plants of Kudzu (Pueraria lobata) were collected from Nacogdoches, Tex. The plants were dried in an oven at 65° C. for 48 h. 4,000 g of dried plant matter was ground to a coarse powder and extracted two times for 48 h each with 95% EtOH (20 L and 12 L, respectively) at RT. The combined EtOH extracts were concentrated under reduced pressure and a total of 142.5 g extracts were obtained. 100 g extracts were dissolved and suspended in H₂O and prepared as 1,000 mL experimental solution at the concentration of 10% extracts. 25 g extracts were dissolved and suspended in nanopure H₂O and prepared as 500 mL experimental solution at the concentration of 5% extracts.

Foliar Sprays: Three plots (0.5 m² each) of kudzu plants on the ground in the field were selected for the foliar applications. One plot served as control without any treatment, one was treated by 150 mL 5% kudzu extracts, and the third plot was treated with 150 mL 10% kudzu extracts. Foliar application of 150 mL 10% EtOH extracts of kudzu was also made on some nearby species including water elm (Planes aquatica J. F. Gmel.) (Ulmaceae), Japanese honeysuckle (Lonicera japonica Thunb.) (Caprifoliaceae), and P. aurea. The plant status was documented and photographed daily after the treatment.

Results: Pueraria lobata EtOH extracts had significant effects on kudzu plants. 5% EtOH extracts killed more than 50% of the plants a week after the treatment while 10% EtOH extracts eliminated most of the treated plants at the same time period. At the same dosage, Pueraria lobata extracts did not impact on any other species including P. aquatica, L. japonica, and P. aurea.

### Example 20

Elimination and Inhibition of Seedlings of Chinese Tallow (Triadica sebifera (L.) Small) by the EtOH Extracts of Chinese Tallow Stems

General Experimental Procedures:

Extracts Preparation: The stems of Chinese tallow (Triadica sebifera) were collected from Nacogdoches, Texas and were dried in an oven at 65° C. for 48 h. 400 g dried stems were ground to coarse powders and each were extracted two times for 48 h with 95% EtOH (2 L and 2 L, respectively) at RT. After evaporated under reduced pressure 41 g EtOH extracts were obtained. 30 g of each extract was dissolved and suspended in nanopure H₂O and then prepared as 300 mL experimental solutions at the concentration of 10% extracts. 100 mL of solution was prepared as 10% EtOH extracts with 0.25% Inlet™ (polyalkoxylated and non-alkoxylated aliphatics and derivatives 90%, Helena Chemical Company, Collierville, Tenn., United States) (v:v) and 0.125% mL Kinetin® (proprietary blend of polyalkyleneoxide modified polydimethylsiloxane 99%, Helena Chemical Company, Collierville, Tenn., United States) (v:v).

Foliar Sprays: Triadica sebifera seedlings (<10 cm in height, approximately three weeks old, germinated from seeds) in the field were selected for the experiment. Six seedlings served as control (without any treatment), six seedlings were sprayed with 15 mL of 10% EtOH extracts of T. sebifera stems two times on the 1^{st} and 3^{rd} days, respectively, and six seedlings were sprayed with 15 mL of 10% EtOH extracts of T. sebifera stems with surfactants two times on the 1^{st} and 3^{rd} days, respectively. The same foliar applications were also applied on the seedlings of Nuttall oak or Texas red oak (Quercus texana Buckley) (Fagaceae), Japanese honeysuckle (Lonicera japonica Thunb.) (Caprifoliaceae), Chinese privet (Ligustrum sinense Lour.) (Oleaceae), muscadine grape (Vitis rotundifolia Michx.) (Vitaceae), and sugarberry (Celtis laevigata Willdenow) (Cannabaceae). Plant growth and survival status were documented and photographed daily for two months after the treatments.

Results: During the two months of foliar treatment experiments, all six seedlings of T. sebifera in the control group grew well. However, two of seedlings of T sebifera were significantly injured and four were killed by the EtOH extracts of the T. sebifera stems with surfactants. During the same period, a treated seedling of Chinese privet grew well. Of the seedlings treated with the EtOH extracts of the T. sebifera stems (without surfactants), two were dead within days and others were significantly injured. A newly emerged oak seedling showed no damage from the extracts.

### Example 21

Elimination and Inhibition of Coppiced Plants and Saplings of Chinese Tallow (Triadica sebifera (L.) Small) by the EtOH Extracts of Chinese Tallow Leaves and Stems

General Experimental Procedures:

Extracts Preparation: The leaves and stems of Chinese tallow (Triadica sebifera) were collected from Nacogdoches, Tex. and were dried in an oven at 65° C. for 48 h. 14 kg dried leaves and stems were ground to coarse powders and each were extracted two times for 48 h with 95% EtOH (40 L and 24 L, respectively) at RT. Extracts were evaporated under reduced pressure. 646 g EtOH extracts were obtained. The treatment experiments were conducted in a field in East Texas.

Foliar Applications to Coppiced Plants: 10 g of extracts were dissolved and suspended in nanopure H₂O and prepared as 100 mL experimental solution at the concentration of 10% extracts with 1% vegetable (soybean) oil (Great Value®, Walmart) (v:v). 12 young coppiced plants (shoots of about 60 cm in height) of T. sebifera in the field were selected for the experiment. Four plants served as control (without any treatment), four treated with 50 mL soybean oil only each, and four plants were sprayed with 50 mL of 10% EtOH extracts with vegetable oil two times on the 1^{st} and 3^{rd} days. The same foliar applications were also applied on the seedlings of Nuttall's oak or Texas red oak, Japanese honeysuckle, Chinese privet, muscadine grape, and sugarberry. Plant growth and survival status were documented and photographed daily for three months after the treatments.

Hack and Squirt Applications to Saplings: approximately 400 g T sebifera EtOH extracts were dissolved and suspended in bark oil EC Blue (UAP Distribution, Inc., Greeley, Colo.) to prepare 2,000 mL experimental solution with 20% extracts. 30 saplings (1-2 m tall, with DBH 10-20 mm) in the field were randomly classified into three groups with 10 plants each. All plants were hacked twice using a hatchet. The first group served as control with no treatment, each of the second group had 5 mL bark oil squirted into the hack with a squirt bottle, and each of the third group was sprayed with 5 mL 20% T. sebifera EtOH extracts squirted into the hack spot with a squirt bottle. The plant status was evaluated and photographed monthly after the treatment.

Results: During the three months of coppiced plants experiments, all four plants of T. sebifera in the control group grew well. Among the four coppiced plants treated with EtOH extracts of the T. sebifera leaves and stems with soybean oil, most of the leaves fell with one dead stem within 11 weeks. During the experiments, other plant species showed no damage by the extracts. By the end of the second month of the experiment, all 10 plants treated with T. sebifera extracts in the hack and squirt applications were significantly injured with six plants dead above ground. During the same time period, the trees in the control had no significant change, while those treated with bark oil had about 10-20% of the leaves turn yellow or brown.

### Example 22

Phytotoxicity of Fractions and Compound Isolated from Leaves and Stems of Chinese Tallow (Triadica sebifera (L.) Small) on Chinese Tallow Seedlings

General Experimental Procedures:

Extraction and Isolation: The leaves and stems of T. sebifera were collected from Nacogdoches, Tex., United States and were dried in an oven at 65° C. for 48 h. 11 kg dried leaves and stems were ground to coarse powders and each were extracted two times for 48 h with 95% EtOH (40 L and 24 L, respectively) at RT. Extracts were evaporated under reduced pressure. 410 g EtOH extracts were obtained. The extracts were suspended in MEOH -H₂O (1L, 1:1, v/v), and then partitioned successively with hexanes and EtOAc. Three fractions were obtained, named hexane fraction (97.8 g), EtOAc fraction (31.9 g) and H₂O fraction (220 g). 0.4 g hexane fraction was further separated by HPLC (Zorbax SB-C18 column, CH₃CN/H₂O:45/55 and 98/2, detection 210 nm) to give five subfractions: F45-1 (12.5 mg), F45-2 (3.8 mg), F45-3 (4.7 mg), F45-4 (8.2 mg), and F100 (67 mg). NMR experiments were performed on a JEOL ECS-400. NMR data were reported as δ (ppm) values and referenced to the solvent used. HRESIMS were acquired on an electrospray instrument (MDS Sciex Pulsar Qstar, Ontario, Canada).

Bioassays: The experimental plants were 4-month-old T. sebifera seedlings grown in pots with Miracle Grow Potting Mix soil in the greenhouse (30° C. during the day time and 20° C. at night) with about 30 seedlings on each 2-gallon pot. Each of the three fractions and five subfractions from hexane fractions was prepared as 50 μL experimental solution with nanopure H₂O at 5% concentration each. For each testing sample, 10 μL of each experimental solution was applied by pipet on the upper surface of each of the three randomly selected mature leaves and the lower surface of each of three additional randomly selected mature leaves. On each seedling, the untreated leaves served as controls. For active hexane fraction, foliar spray of 0.5, 1, 2.5, and 5% concentrations were conducted with a dosage of 20 mL each on 50% plants of each pot (about 15 seedlings each). The remaining 50% untreated plants on each pot served as controls. The foliar treatments were replicated three times. The same foliar applications of the 5% hexane fraction were also applied on at least three seedlings of the following species at the dosage of 10 mL per plant: Loblolly pine (Pinus taeda L.) (Pinaceae), muscadine grape (Vitis rotundifolia Michx.) (Vitaceae), waxmyrtle (Myrica heterophylla Raf.) (Myricaceae), sumac (Rhus aromatics L.) (Anacardiaceae), Bosc's panicagrass (Dichanthelium boscii (Poir.) Gould & C. A. Clark) (Poaceae), and tick-trefoil (Desmodium sp.) (Fabaceae). The leaf surfaces of the experimental plants were checked daily for two weeks by a ×60 portable microscope linked to an iPhone™.

Results: The untreated leaves or seedlings that served as controls had normal growth during the two weeks of experimental period. In both droplet test of intact leaf and foliar spray experiments, hexane fraction of the extracts was found more active than the extracts and other fractions in the foliar spray. The seedlings treated by foliar spray of 1% and higher concentrations of hexane fraction were injured within several hours and killed within several days. Among the hexane fraction, F45-3 and F45-4 were found more active than the others. 5,6,7,8-Tetramethoxycoumarin (1.4 mg, t_{R} 11 min) was purified from subfraction F45-3 by HPLC (Zorbax SB-C18 column, CH₃CN/H₂O : 45/55, detection 280 nm). In the droplet test, this compound showed endocidal activity against T. sebifera. None of the seedlings of the testing species except T. sebifera had any injury by the 5% hexane fraction of T. sebifera.

### Example 23

Inhibition of Seed Germination of Chinese Tallow (Triadica sebifera (L.) Small) by Its EtOH Extracts

General Experimental Procedure:

Preparation of Leaf and Stem Extracts: The leaves and stems of T. sebifera were collected from Nacogdoches, Texas, United States and were dried in an oven at 65° C. for 48 h. 11 kg dried leaves and stems were ground to coarse powders and each were extracted two times for 48 h with 95% EtOH (40 L and 24 L, respectively) at RT. Extracts were evaporated under reduced pressure. 410 g EtOH extracts were obtained and then stored in 4° C.

Preparation of Seed Extracts: The seeds of T. sebifera were collected from Nacogdoches, Texas, United States and were dried in an oven at 65° C. for 48 h. 110 g dried seeds were ground to coarse powders and extracted two times for 48 h with 95% EtOH (500 mL and 400 mL, respectively) at RT. The EtOH extracts were evaporated under reduced pressure. 6.3 g extracts were obtained and then stored in 4° C.

Extracts Yield of Experimental Seeds: Based on the seed weight and extraction rate (5.73%, in dry weight) of the above extraction method, it is estimated that the plant matter used in the soaking treatment (60 T. sebifera seeds) could produce 0.41 g EtOH extracts. To further reveal the actual amount of the EtOH extracts contained in the plant matter, a more effective extraction of 60 seeds (7.1 g) was performed using a ASE 2000 Accelerated Solvent Extractor (60° C., 1500 psi, 30 min static time, 100% volume flush, 120 s purge, and 2 cycles). According to this extraction rate, 60 T. sebifera seeds contain at least 2.11 g EtOH extracts.

Soaking Treatments: Both leaf and stem extracts and seed extracts were prepared as experimental solution with nanopure H₂O at 5% concentration each. 60 T. sebifera seeds were prepared and subjected to one of the following soaking treatments in Petri dishes at RT with three replications per treatment: (1) control: without soaking treatment, (2) water-24 h: soaked in 30 mL nanopure H₂O for 24 h, (3) water-6 weeks: soaked in 30 mL nanopure H₂O for six weeks, (4) 5% leaf and stem extracts-6 weeks: soaked in a 30 mL 5% solution of EtOH extracts of T sebifera leaves and stems for six weeks, and (5) 5% seed extracts-6 weeks: soaked in a 30 mL 5% solution of EtOH extracts of T. sebifera seeds (1.5 g extracts) for six weeks.

Germination Test: Seeds were sowed in 2-gallon pots with Miracle Grow Potting Mix soil in the greenhouse (30° C. during the day time and 20° C. at night). The seed germination was surveyed every week throughout the experimental period.

Results: No seedling germinated during the eight weeks of experiment from the T. sebifera seeds soaked in a 5% solution of T. sebifera leaf and stem extracts. For the seeds soaked in a 5% solution of T. sebifera seed extracts for six weeks, 20% were germinated. For the seeds soaked in water for six weeks, the germination rate was 57.8%. The seeds soaked in nanopure H₂O for 24 h 28.9% germination with pleiocotyly observed for 1.9% of seedlings. The seeds soaked without soaking treatment had 40.6% germination and no pleiocotyly was observed in any germinated seedlings.

### Example 24

Impacts of EtOH Extracts of Chinese Tallow (Triadica sebifera (L.) Small) Stems and Leaves on Some other Plant Species

General Experimental Procedures:

Extracts Preparation: The EtOH extracts of the stems and leaves of T. sebifera were prepared as described in the above experiment. EtOH extracts of T. sebifera were prepared in 1% experimental solution with nanopure H₂O.

Bioassays: The intact seedling plants of T. sebifera, Q. texana, and L. styraciflua grown in the greenhouse were tested in this experiment. 10 μL 1% EtOH extracts of T. sebifera were applied by pipet on the upper or lower leaf surfaces of the intact plants. For each plant species, three upper leaves and three lower leaves were treated separately. The leaf surfaces of the experimental plants were checked daily for two weeks by a ×60 portable microscope linked to an iPhone™.

Results: Among all three tested species, only T sebifera leaves were damaged by either upper or lower leaf surce treatment with 10 μL 1% EtOH extracts of T. sebifera stems and leaves. Neither Q. texana nor L. styraciflua had any injury following the treatments.

### Example 25

Elimination and Inhibition of Hogwort (Croton capitatus var. lindheimeri (Engelm. & Gray) Muell.-Arg.) by Its EtOH Extracts

General Experimental Procedures:

Extracts Preparation: The whole plants of hogwort (Croton capitatus var. lindheimeri) were collected from Nacogdoches, Texas. The plant sample was dried in an oven at 65° C. for 48 h. 2,000 g dried plant matter was ground to a coarse powder and extracted two times for 48 h each with 95% EtOH (20 L and 12 L, respectively) at RT. The combined EtOH extracts were concentrated under reduced pressure and a total of 53 g extracts were obtained. 15 g of extracts were dissolved and suspended in nanopure H₂O and prepared as 150 mL experimental solution at the concentration of 10% extracts with 1% Tergitol® 15-S-9 (Sigma-Aldrich Co., St. Louis, Mo., United States) (v:v).

Foliar Sprays: In the field, 10 C. capitatus var. lindheimeri plants (about 50 cm in height) were selected for the experiments. Of the plants, five individuals served as control without any treatment. Five plants were sprayed with the C. capitatus var. lindheimeri extracts with 1% Tergitol® at the amount 15 mL per plant. The same foliar applications were also applied to five plants nearby of the following species: three-seeded mercury (Acalypha rhomboidea Raf.), another native weed of the same spurge family (Eurphorbiaceae) in North America; cultivated monocots bermudagrass (Cynodon dactylon (L.) Pers.) (Poaceae); and turmeric (Curcuma longa L.) (Zingiberaceae). The status of each treated plant was evaluated and photographed every daily after the treatments.

Results: During the four weeks of observations, the five C. capitatus var. lindheimeri plants in the control group grow normally. For the five C. capitatus var. lindheimeri plants treated with 10% extracts with 1% Tergitol®, most leaves folded and had significant injury on the second day of the treatments. By the end of the first week after the treatments, two plants were dead and the other three plants had leaves that had wilted and had turned yellow (vs. the green leaves of the plants in the control group). However, during the experiments the treated A. rhomboidea and monocots had no visible injury caused by the C. capitatus var. lindheimeri extracts treatment.

### Example 26

Elimination and Inhibition of Chaya (Cnidoscolus aconitifolius (Mill.) I. M. Johnst.) by Its EtOH Extracts

General Experimental Procedures:

Extracts Preparation: The stems and leaves of chaya (Cnidoscolus aconitifolius (Mill.) I. M. Johnst.) (Eurphorbiaceae) (400 g in dry weight) were ground to a coarse powder and extracted two times for 48 h each with 95% EtOH (2.5 L each time) at RT. The combined extracts were concentrated to give 24.6 g under reduced pressure. The 5 g extracts were dissolved in nanopure H₂O and prepared as 100 mL experimental solution at the concentration of 5% EtOH extracts of C. aconitifolius.

Soaking Experiment: The soaking treatment experiments were conducted in the laboratory. 12 pieces of C. aconitifolius stems (12-14 cm long) with leaves were prepared and subjected to two treatments. Six pieces of stems were cultivated in 100 mL nanopure H₂O to serve as control and six were cultivated in 100 mL 5% EtOH extracts of C. aconitifolius for 12 days at RT.

Growth and Propagation Tests: Each experimental stem was placed in one-gallon pots with Miracle Grow Potting Mix soil in the greenhouse. The living status of individuals was recorded once every week throughout the experimental period.

Results: By the end of second month, two of the six stems of C. aconitifolius in the control group were alive while none under the treatment with C. aconitifolius extracts survived.

### Example 27

Inhibition and Elimination of Yaupon (Ilex vomitoria Sol. Ex Alton.) by EtOH Extracts of Yaupon Leaves and Stems

General Experimental Procedures:

Extract Preparation: The leaves and stems of yaupon (Ilex vomitoria) were collected from Nacogdoches, Tex. The leaves and stems were dried in an oven at 65° C. for 48 h, separately. The dried leaf and stem samples (3,300 g) were ground to a coarse powder and extracted two times for 48 h each with 95% EtOH (30 L and 23 L, respectively) at RT. The combined EtOH extracts were concentrated under reduced pressure and a total of 265 g extracts were obtained.

Foliar Sprays: 10 g extracts was prepared as 100 mL experimental solution with nanopure H₂O at the concentration of 10% extracts with 1% Firezone surfactant (Helena Chemical Company, Collierville, Tenn., United States). 10 plants of I. vomitoria with a diameter at base of <10 mm were selected for foliar treatments. Five plants without any treatment served as control and each of the other five plants was sprayed with 20 mL I. vomitoria EtOH extracts with 1% Firezone.

Other Treatments: 225 g of the extracts were dissolved and suspended in bark oil EC Blue (UAP Distribution, Inc., Greeley, Colo.) and prepared as 900 mL experimental solution at the concentration of 25% leaf and stem extracts of I. vomitoria. The treatment experiments were conducted in the field in Nacogdoches, Tex.

Hack and Squirt Applications: 15 plants of I. vomitoria with a diameter at base ranging from 10 to 20 mm were selected for hack and squirt application. Five plants without any treatment served as control. Five plants were cut in the trunk using a hatchet and each was squirted with 8 mL I. vomitoria EtOH extracts with a squirt bottle. Five plants had the hack and squirt application with bark oil only.

Cut Stump Treatments: 15 I. vomitoria plants were cut down at about 15 cm above the ground. Five of them without treatment were used as control. Five were treated with I. vomitoria EtOH extracts onto the cut stumps at the amount of 8 mL per stump. Another five plants were treated with bark oil only at the amount of 8 mL per stump. The plant status was evaluated and photographed weekly after the treatments.

Results: By the end of four weeks of experiments, the I. vomitoria plants in control (without any treatments) or treated with oil in the hack and squirt applications had no observable changes. Some leaves of the plants treated by the foliar applications of 10% I. vomitoria extracts with 1% Firezone had injuries. In the hack and squirt treatments, all five I. vomitoria plants treated with I. vomitoria extracts with bark oil had terminal shoots and some leaves were dead or had significant damage by the end of four weeks and all except one were dead by February next year. No sprouts had come out from any stumps treated by the I. vomitoria extracts with bark oil by February next year.

### Example 28

Inhibition and Elimination of Yaupon (Ilex vomitoria Sol. Ex Alton.) by t-BuOH Fraction of EtOH Extracts of Yaupon Fruits

General Experimental Procedures:

Extracts Preparation: The ripen fruits of yaupon (Ilex vomitoria) were collected from a single tree in Nacogdoches, Tex. The fruits were dried in an oven at 65° C. for 48 h, separately. The dried fruits samples (7.5 kg) were ground to a coarse powder and extracted three times for 48 h each with 20 L 95% EtOH at RT. The combined EtOH extracts were concentrated under reduced pressure and a total of 430 g extracts were obtained. The extracts were suspended in H₂O and partitioned with EtOAc first and then t-BuOH and obtained three fractions: H₂O fraction (335 g), EtOAc-soluble fraction (42 g) and t-BuOH-soluble fraction (53 g). The 5 g each of the extracts, H₂O fraction, EtOAc fraction, and t-BuOH fraction were dissolved in nanopure H₂O separately and prepared as 50 mL experimental solution at the concentration of 10%, respectively.

Bioassays: The experiment was conducted in the greenhouse (30° C. during the day time and 20° C. at night). The experimental plants were 6-month-old I. vomitoria plants propagated from cuttings. Each experimental solution (extracts, H₂O fraction, EtOAc fraction, and t-BuOH fraction) was applied on three spots of the upper surface of each of three randomly selected mature leaves per plant by pipet at the dosage of 10 μL each spot, respectively. Three untreated leaves per plant served as controls. The leaf surfaces of the experimental plants were checked daily for two weeks by a x×60 portable microscope linked to an iPhone™.

Foliar Sprays: The experiment plant was a mature tree in the field where the fruits were collected for extraction in this example. Each experimental solution (extracts, H₂O fraction, EtOAc fraction, and t-BuOH fraction) was sprayed on each of the three randomly selected 30-cm long branches by spray bottle at the dosage of 10 mL, respectively. Three untreated stems with leaves served as controls. The leaf surfaces of the experimental plants were checked daily for two weeks by a ×60 portable microscope linked to an iPhone™.

Results: The t-BuOH fraction of the EtOH extracts of I. vomitoria fruits was found most active in the I. vomitoria leaf bioassays, following by the EtOAc fraction and then the whole extracts while the H₂O fraction was not active. All leaf spots treated by 10 μL t-BuOH fraction turned brown within 24 h and whole leaves were dead within nine days. The foliar sprays of branch (leaves and stems) in the field showed a similar result. The terminal buds and shoots of the three branches sprayed with 10 mL t-BuOH fraction each were all dead within two weeks.

### Example 29

Inhibition and Elimination of Sweetgum (Liquidambar styraciflua L.) by Its EtOH Extracts

General Experimental Procedures:

Extracts Preparation: The leaves and stems of Sweetgum (Liquidambar styraciflua) were collected from Nacogdoches, Tex., United States. The leaves and stems were dried in an oven at 65° C. for 48 h. The dried leaf and stem samples (2,200 g) were ground to a coarse powder and extracted two times for 48 h each with 95% EtOH (20 L and 12 L, respectively) at RT. The combined EtOH extracts were concentrated under reduced pressure and a total of 183 g extracts were obtained. 25 g of the extracts were dissolved and suspended in bark oil EC Blue (UAP Distribution, Inc., Greeley, Colo.) and prepared as 100 mL experimental solution at the concentration of 25% leaf and stem extracts.

Hack and Squirt Applications: this experiment was conducted in the field in Nacogdoches, Tex. Nine plants of L. styraciflua in the field with diameter at breast height (DBH) ranging from 20-45 mm were selected for hack and squirt application. Three trees without any treatment served as control. Three trees were cut in the trunk using a hatchet and each was squirted with 5 mL L. styraciflua EtOH extracts with a squirt bottle. Three trees had the hack and squirt application with bark oil only.

Cut Stump Treatments: the experiment was conducted in the greenhouse (30° C. during the day time and 20° C. at night). Nine plants were cut down at about 19 cm above the ground. Three of them without treatment were used as control. Three were treated with L. styraciflua EtOH extracts onto the cut stumps at the amount of 5 mL per stump. Another three were treated with bark oil only at the amount of 5 mL per stump.

Basal Treatments: the experiment was conducted in the greenhouse (30° C. during the day time and 20° C. at night). Nine trees were cut down at about 19 cm above the ground. Three plants without treatment were used as control. Three plants were sprayed with L. styraciflua EtOH extracts on the lower 40 cm of the trunk at the amount of 5 mL per tree. Three were sprayed with bark oil only at the amount of 5 mL per tree. The plant status was evaluated and photographed every two weeks after the treatment.

Results: By the end of four weeks, two of the L. styraciflua plants treated with hack and squirt applications of L. styraciflua extracts and bark oil had some leaves dead and fallen. At the same time, no sprouts came out from any stumps treated by the L. styraciflua extracts with bark oil in comparison with 2-5 sprouts from each of the stumps in control. In the basal treatments, the plants in control had normal development including a few leaves turned into yellow color. Each of the three plants treated with L. styraciflua extracts with bark oil had injured terminal shoot and leaves and more leaves that had turned directly into brown or black color with about 20% more fallen leaves than those treated with oil only.

### Example 30

Inhibition of Tree of Heaven (Ailanthus altissima (P. Mill.) Swingle) by Its EtOH Extracts

General Experimental Procedures:

Extracts Preparation: The leaves and stems of tree of heaven (Ailanthus altissima) were collected from Nacogdoches, Tex. The leaves and stems were dried in an oven at 65° C. for 48 h. The dried leaf and stem samples (8,500 g) were ground to a coarse powder and extracted two times for 48 h each with 95% EtOH (32 L and 24 L, respectively) at RT. The combined EtOH extracts were concentrated under reduced pressure and a total of 415 g extracts were obtained. 60 g of the extracts were dissolved and suspended in bark oil EC Blue (UAP Distribution, Inc., Greeley, Colo.) and prepared as 300 mL experimental solution at the concentration of 20% leaf and stem extracts. The treatment experiments were conducted in the field of the plant matter collection site.

Hack and Squirt Applications: nine plants of A. altissima in the field with diameter at breast height (DBH) ranging from 20-45 mm were selected for hack and squirt application. Three trees without any treatment served as control. Three A. altissima trees were cut in the trunk using a hatchet and each was squirted with 5 mL tree of heaven EtOH extracts with a squirt bottle. Three trees had the hack and squirt application with bark oil only.

Cut Stump Treatments: Nine A. altissima trees were cut down at about 19 cm above the ground. Three of them without treatment were used as control. Three A. altissima trees were treated with A. altissima EtOH extracts onto the cut stumps at the amount of 5 mL per stump. Another three were treated with bark oil only at the amount of 5 mL per stump.

Basal Treatments: The basal bark application group had nine plants. Three without any treatment were used as control. Three were sprayed with A. altissima EtOH extracts on the lower 40 cm of the trunk at the amount of 5 mL per tree. Three were sprayed with bark oil only at the amount of 5 mL per tree. Plant status was evaluated and photographed every two weeks after the treatment.

Results: By the end of fourth week after the treatments, no coppice growth was seen from A. altissima stumps treated with A. altissima extracts in the cut stump experiments. At the same time, about 57% of the leaves of all three A. altissima trees in the hack and squirt treatment with A. altissima extracts had turned yellow or fallen in comparison with 50% in the trees treated with oil or 0% in the trees in control. Also at the same time, about 87% of the leaves of all three trees in the basal bark applications of A. altissima extracts had turned yellow or fallen in comparison with 10% in the trees treated with oil or 0% in the trees in control.

### Example 31

Elimination and Inhibition of Chinese Privet (Ligustrum sinense Lour.) by Its EtOH Extracts

General Experimental Procedures:

Extract Preparation: The fruits of Chinese privet (Ligustrum sinense Lour.) (Oleaceae) were collected from Nacogdoches, Texas. The fruits were dried in an oven at 65° C. for 48 h, separately. 400 g dried fruits were ground to a coarse powder and extracted two times for 48 h each with 95% EtOH (2 L and 1 L, respectively) at RT. The combined EtOH extracts were concentrated under reduced pressure and a total of 32 g L. sinense extracts were obtained. 20 g of extracts were dissolved and suspended in nanopure H₂O and prepared as 200 mL experimental solution at the concentration of 10% extracts with 0.25% Dyne-Amic® (Helena Chemical Company, Collierville, Tenn., United States) (v:v) and 0.125% Kinetin® (Helena Chemical Company, Collierville, Tenn., United States) (v:v).

Cut Stump Treatments: The treatment experiments were conducted in the field of the plant matter collection site. 10 L. sinense plants (2.5 to 3 m in height, approximately 5 cm in basal diameter) were cut 15 cm from the ground. A 3 cm long and 1 cm wide hole was made in the center of each stump. Five stumps served as control and each received 10 mL of tap water injection into the hole. Each of the other five stumps received 10 mL of L. sinense extracts with surfactants injection. Two additional applications of the same amount were made on the second and fifth day. The regrowth of plants in control or treatment was measured monthly for six months.

Results: All treated L. sinense stumps had about 2 weeks delayed coppice growth than those in control by the end of the two months after the treatments. Four months later, stumps in control group had 13.5 coppices with 283.5 cm in height at average while stumps in treatment had 3.5 coppices with 97.8 cm in height at average. Of the five treated L. sinense stump, one had no coppice growth during the six months of observation.

### Example 32

Inhibition on Seed Germination of Red Kidney Bean (Phaseolus vulgaris L.) by Its Seed EtOH Extracts

General Experimental Procedures:

Extracts Preparation: 906 g dried red kidney bean (Phaseolus vulgaris L.) (Fabaceae) were ground to coarse powders and extracted two times for 48 h with 95% EtOH (4 L and 3 L, respectively) at RT. Extracts were evaporated under reduced pressure, and 7.1 g EtOH extracts were obtained. 7.1 g EtOH extracts were dissolved and suspended in nanopure H₂O and prepared as 140 mL experimental solution at the concentration of 5%. Then 20 mL 5% EtOH extracts was diluted to 100 mL and prepared as 100 mL experimental solution at the concentration of 1%.

Extracts Yield of Experimental Plant Matter: Based on the plant matter weight and extraction rate (0.79%, in dry weight) of the above extraction method, it is estimated that the plant matter used in the soaking treatment (30 beans) could produce 0.13 g EtOH extracts. To further reveal the actual amount of the EtOH extracts contained in the plant matter, a more effective extraction of 30 beans (16.9 g) was performed using a ASE 2000 Accelerated Solvent Extractor (60° C., 1500 psi, 30 min static time, 100% volume flush, 120 s purge, and 2 cycles). According to this extraction rate, 30 beans contain at least 0.9 g EtOH extracts.

Soaking Treatments and Germination Tests: The treatment experiments were conducted in the laboratory under RT. 270 beans were prepared and subjected to one of the three treatments for four days. (1) 30 beans were placed in a Petri dish with 30 mL nanopure H₂O; (2) 30 beans were placed in a Petri dish with 30 mL 1% EtOH extracts (0.3 g extracts); (3) 30 beans were placed in a Petri dish with 30 mL 5% EtOH extracts (1.5 g extracts). Each experiment had three replications. The germination of the beans was recorded every day throughout the experimental period.

Results: Germination of P. vulgaris beans was inhibited and delayed by the bean extracts. More than 70% of beans did not germinate and lost viability after being soaked in a 5% solution of P. vulgaris extracts for four days.

### Example 33

Inhibition on Seed Germination of Peanut (Arachis hypogaea L.) by Its Seed EtOH Extracts

General Experimental Procedures:

Extracts Preparation: The experimental peanut (Arachis hypogaea L.) (Fabaceae) was purchased from Royal Oak Peanuts/Hope & Harmony Farms, Drewryville, Va. 500 g dried pod shell and 1,500 g dried seeds (nuts) without shell were ground separately to coarse powders and extracted two times for 48 h with 95% EtOH (4.5 L and 2.5 L each, respectively) at RT. Extracts were evaporated under reduced pressure, and 23.4 g shell extracts and 31.2 g seed extracts were obtained. 10 g each of the EtOH extracts were dissolved and suspended in nanopure H₂O and prepared separately as 200 mL experimental solution at the concentration of 5%.

Extracts Yield of Experimental Plant Matter: Based on the plant matter weight and extraction rate (4.68% for shell and 2.08% for seeds, in dry weight) of the above extraction method, it is estimated that the plant matter used in the soaking treatment (30 A. hypogaea fruits) could produce 0.52 g shell EtOH extracts and 0.73 g seed EtOH extracts. To further reveal the actual amount of the EtOH extracts contained in the plant matter, a more effective extraction of small samples (8 g shells and 7.6 g seeds) was performed using a ASE 2000 Accelerated Solvent Extractor (60° C., 1500 psi, 30 min static time, 100% volume flush, 120 s purge, and 2 cycles). According to this extraction rate, 30 A. hypogaea fruits contain at least 0.83 g shell EtOH extracts and 12.47 g seed EtOH extracts.

Soaking Treatments and Germination Tests: 360 seeds in total were prepared and 30 seeds in a plastic container (14×15 cm, 0.68 L) were subjected to one of four treatments for one week with three replications per treatment: (1) control: without any treatment and the seeds were directly sowed in the pots at the greenhouse; (2) soaked in 60 mL nanopure H₂O; (3) soaked in a 60 mL 5% solution of A. hypogaea shell extracts (3 g shell extract); and (4) soaked in a 60 mL 5% solution of A. hypogaea seed extracts (3 g seed extracts). All experimental seeds were sowed in the pots with Miracle Grow Potting Mix soil in greenhouse (30° C. during the day time and 20° C. at night). The seed germination was recorded weekly throughout the experimental period of three months.

Statistical Analysis: The data were analyzed by SPSS 13.0 for Windows (SPSS, Inc., Chicago, Ill.). ANOVA with Duncan post-hoc analysis was used to compare the means of the control and treatment groups.

Results: By the end of four weeks after sowing in the pots, the A. hypogaea seeds without any treatment had 73.3% germination rate average. The seed soaked in water for a week had about 22.3% germination rate average. The seeds soaked in a 5% solution of A. hypogaea shell extracts or seed extracts had only 7.7% or no germination, respectively. The ungerminated seeds in these two treatments lost viability and never germinated in the next six months of observation.

### Example 34

Inhibition on Acorn Germination of Shumard Oak (Quercus shumardii Buckley) and Nuttall Oak (Q. texana Buckley) by EtOH Extracts of Shumard Oak Acorns

General Experimental Procedures:

Extracts Preparation: The acorns of Quercus shumardii were collected from Nacogdoches, Tex., United States and were dried in an oven at 65° C. for 48 h. 1.2 kg of dried acorns were ground to coarse powders and extracted two times for 48 h with 95% EtOH (4.8 L and 4 L, respectively) at RT. Extracts were evaporated under reduced pressure. 61 g EtOH extracts were obtained. 25 g extracts were dissolved and suspended in nanopure H₂O and prepared as 500 mL experimental solution at the concentration of 5% EtOH extracts of acorns of Q. shumardii. 45 mL 5% EtOH extracts of acorns was diluted to 450 ml and prepared as 450 mL experimental solution at the concentration of 0.5% EtOH extracts of acorns.

Extracts Yield of Experimental Acorns: Based on the acorn weight and extraction rate (5.09%, in dry weight) of the above extraction method, it is estimated that the plant matter used in the soaking treatment (30 Q. shumardii acorns) could produce 12.22 g EtOH extracts. To further reveal the actual amount of the EtOH extracts contained in the plant matter, a more effective extraction of a small sample (24 g) was performed using a ASE 2000 Accelerated Solvent Extractor (60° C., 1500 psi, 30 min static time, 100% volume flush, 120 s purge, and 2 cycles). According to this extraction rate, 30 Q. shumardii acorns contain at least 18.96 g EtOH extracts.

Soaking Treatments: The treatment experiments were conducted in the laboratory. 270 acorns from each species of Q. shumardii and Q. texana were prepared and each group consisting of 30 acorns in a plastic container (14×15 cm, 0.68 L) were subjected to one of the three soaking treatments for 48 h at RT: 150 mL nanopure H₂O (as control), a 150 mL 0.5% solution of EtOH extracts of Q. shumardii acorns (0.75 g acorn extracts), and a 150 mL 5% solution of EtOH extracts of Q. shumardii acorns (7.5 g acorn extracts). Each treatment included three replicates.

Germination Tests: The 30 soaked acorns in each replicate per treatment were placed in the germination box with moist sand. Acorns were considered germinated when the radical protruded through the pericarp. The number of germinated individuals and the length of the radical were recorded once every week throughout the experimental period of 11 weeks. The percentage of germination and the mean germination time were determined for each replicate. Statistical Analysis: The data were analyzed by SPSS 13.0 for Windows (SPSS, Inc., Chicago, Ill.). ANOVA with Duncan post-hoc analysis was used to compare the means of the control and treatment groups.

Results: The germination rates of both Q. shumardii and Q. texana acorns soaked in a 5% solution of EtOH extracts of Q. shumardii acorns were significantly decreased in comparison with those soaked in a 0.5% solution of EtOH extracts of Q. shumardii acorns or control. By the end of the eleventh week, about 45.7% of Q. shumardii acorns germinated after treatment with 5% Q. shumardii extracts in comparison with a 63.3% germination rate of acorns soaked in water. At the same time, 50% of Q. texana acorns germinated after treatment with 5% Q. shumardii extracts in comparison with 75.7% germination rate of acorns soaked in water. The ungerminated acorns in all treatments lost viability and never germinated in the next six months of observation.

### Example 35

Phytotoxicity of EtOH Extracts of Shumard Oak (Quercus shumardii Buckley) Acorns on Shumard Oak, Nuttall Oak (Q. texana Buckley), and Swamp Chestnut Oak (Q. michauxii Nutt.)

General Experimental Procedures:

Extracts Preparation: 1 g EtOH extracts of Shumard oak (Quercus shumardii) acorns (see Example 34) were prepared in 10 mL experimental solution with nanopure H₂O at the concentration of 10%.

Bioassays: The experimental oaks were 3-week-old seedlings of Q. shumardii, Nuttall oak (Q. texana), and swamp chestnut oak (Q. michauxii) germinated from the seeds collected from Nacogdoches, Tex, United States. The seedlings were grown in pots with Miracle Grow Potting Mix soil in the greenhouse (30° C. during the day time and 20° C. at night). 10% EtOH extracts of Q. shumardii acorns were applied seprately by pipet on the upper or lower leaf surfaces of three plants of each species. For each plant species, three upper leaves and three lower leaves were treated separately. The leaf surfaces of the experimental plants were checked daily for two weeks by a ×60 portable microscope linked to an iPhone™.

Results: The leaves of all three testing oak species had significant tissues damaged by 10 μL 10% EtOH extracts of Q. shumardii acorns when applied on lower leaf surfaces. In Q. michauxii, application of 10 μL 10% EtOH extracts of Q. shumardii acorns on upper leaf surfaces also caused some tissue damages, but less serious than by lower leaf surface application. However, both Q. texana and Q. michauxii leaves were not affected by applications of 10 μL 10% EtOH extracts of Q. shumardii on upper leaf surfaces.

### Example 36

Inhibition on Acorn Germination of Nuttall Oak (Quercus texana Buckley) by EtOH Extracts of Different Parts of Nuttall Oak Acorns

General Experimental Procedures:

Extracts Preparation: The acorns of Nuttall oak (Quercus texana) were collected from Nacogdoches, Tex., United States. Some acorns were separated into the pericarp and the embryo parts. Three samples (whole acorns, pericarps, and embryos) were dried in an oven at 65° C. for 48 h. The dried samples were ground and obtained 300 g whole acorns, 340 g pericarps, and 240 g embryos. Each sample was extracted two times for 48 h each with 95% EtOH (1,500 mL each time) at RT. The combined EtOH extracts were concentrated to give three extracts: 16.0 g whole acorn extracts, 15.2 g acorn pericarp extracts, and 15.1 g acorn embryo extracts under reduced pressure. 15 g of each extract were dissolved in nanopure H₂O and prepared as 300 mL experimental solution at the concentration of 5% EtOH extracts of Q. texana.

Extracts Yield of Experimental Plant Matter: Based on the plant matter weight and extraction rate (5.34% for whole acorns, 4.47% for acorn pericarps, and 6.30% for embryos, in dry weight) of the above extraction method, it is estimated that the plant matter used in the soaking treatment (15 Q. texana acorns) could produce 0.80 g EtOH extracts of whole acorns or 0.4 g EtOH extracts of acorn pericarps and 0.4 g EtOH extracts of acorn embryos.

Soaking Treatments: The treatment experiments were conducted in the laboratory. 180 acorns and 180 embryos of Q. texana were prepared and each group consisting of 15 acorns or embryos in a plastic container (14×15 cm, 0.68 L) were subjected to one of four soaking treatments for 48 h at RT: 15 mL nanopure H₂O (as control), 15 mL 5% solution of EtOH extracts of Q. texana acorns (0.75 g whole acorn extracts), 15 mL 5% solution of EtOH extracts of Q. texana acorn pericarp (0.75 g pericarp extract), and a 15 mL 5% solution of EtOH extracts of Q. texana acorn embryos (0.75 g embryo extract). Each treatment included three replicates.

Germination Tests: The soaked acorns or embryos in each treatment were sowed in the pots with Miracle Grow Potting Mix soil in the greenhouse. The number of germinated individuals and the height of the seedlings were recorded once every week throughout the experimental period.

Statistical Analysis: The data were analyzed by SPSS 13.0 for Windows (SPSS, Inc., Chicago, Ill.). ANOVA with Duncan post-hoc analysis was used to compare the means of the control and treatment groups.

Results: By the end of 10 weeks of planting, the germination rates (73.3-91.1%) of the acorn embryos of Q. texana had no significant difference among the treatments of water, extracts of Q. texana whole acorns, and extracts of Q. texana acorn pericarps but all were significantly higher than the embryos treated with extracts of Q. texana acorn embryos (48.9%) or whole acorns of Q. texana in any treatment (48.9-57.8%). This shows that the endocidal ingredients in acorns may be primarily stored in embryos rather than pericarps. The ungerminated acorns or embryos in all treatments lost viability and never germinated in the next six months of observation. The height growth of seedlings in different treatments exhibited a similar pattern.

### Example 37

Inhibition on Acorn Germination of Sawtooth Oak (Quercus acutissima Carruth) by Its Acorn EtOH Extracts

General Experimental Procedures:

Extracts Preparation: The acorns of sawtooth oak (Quercus acutissima Carruth). (350 g in dry weight) were ground to a coarse powder and extracted two times for 48 h each with 95% EtOH (1 L each time) at RT. The combined extracts were concentrated to yield 13 g under reduced pressure. The 10 g extracts were dissolved in nanopure H₂O and prepared as 200 mL experimental solution at the concentration of 5% EtOH extracts of acorns.

Extracts Yield of Experimental Acorns: Based on the acorn weight and extraction rate (3.72%, in dry weight) of the above extraction method, it is estimated that the plant matter used in the soaking treatment (25 Q. acutissima acorns) could produce 5.8 g EtOH extracts. To further reveal the actual amount of the EtOH extracts contained in the plant matter, a more effective extraction of a small sample (20 g) was performed using a ASE 2000 Accelerated Solvent Extractor (60° C., 1500 psi, 30 min static time, 100% volume flush, 120 s purge, and 2 cycles). According to this extraction rate, 25 Q. acutissima acorns contain at least 11.69 g EtOH extracts.

Soaking Treatments: The treatment experiments were conducted in the laboratory and greenhouse. 75 healthy acorns of Q. acutissima were selected with 25 in a plastic container (14×15 cm, 0.68 L). The acorns were subjected to one of the three treatments for two weeks at RT: control (without any treatment), soaked in 200 mL nanopure H₂O, and soaked in a 200 mL 5% solution of Q. acutissima acorn EtOH extracts (10 g extract).

Germination Tests: The experimental acorns were planted in 1-gallon pots with Miracle Grow Potting Mix soil with three acorns each. The number of germinated individuals was recorded once every week throughout the experimental period.

Results: 24 seedlings had germinated from the 25 acorns without any soaking treatment within eight weeks. By the same time, 16 seedlings germinated from the 25 acorns under the water soaking treatment, and only one seedling germinated from the 25 acorns soaked in a 5% solution of EtOH extracts of Q. acutissima acorns. The ungerminated acorns in this treatment lost viability and never germinated in the next three months of observation.

### Example 38

Phytotoxicity of EtOH Extracts of Water Lettuce (Pistia stratiotes L.) on Water Lettuce General Experimental Procedures:

Extracts Preparation: Whole plants of water lettuce (Pistia stratiotes L.) (Araceae) were collected from Texas, United States. The plants were dried in an oven at 50° C. for 48 h. 20 g dried plant matter was ground to a coarse powder and extracted three times for 48 h each with 95% EtOH (1 L each time) at RT. The combined EtOH extracts were concentrated under reduced pressure and a total of 160 mg extracts was obtained. 50 mg extracts were dissolved and suspended in nanopure H₂O and prepared as 500 mL experimental solutions at the concentration of 10% (v:v).

Bioassays: The experiment was conducted in the greenhouse (30° C. during the day time and 20° C. at night). The experimental solution was applied on upper and lower surfaces of three 6-month-old plants (three spots each side per leaf, three leaves per plant) by pipet at the dosage of 10 μL each spot. Three untreated leaves per plant served as controls. The leaf surfaces of the experimental plants were checked daily for two weeks by a ×60 portable microscope linked to an iPhone™.

Results: The leaves of P. stratiotes responded to the treatment of P. stratiotes extracts, particularly applications on lower leaf surface within 24 h. By the three days, the leaf spots treated by P. stratiotes extracts on both sides turned brown in color.

### Example 39

Inhibition on Clove Germination of Garlic (Allium sativum L.) by Its Fresh Clove Juice

General Experimental Procedures:

Extracts Preparation: The total of 105 cloves of garlic (Allium sativum L.) (Amaryllidaceae) were carefully collected and subjected to 5 treatments. Each of the five treatments included three replicates with 5 or 10 cloves in each replication.

Soaking Treatment and Germination Tests: All experiments were conducted under RT with three replicates: (1) 5 cloves were placed in a Petri dish without water; (2) 5 cloves were placed in a Petri dish and grown in 30 mL nanopure H₂O; (3) 10 cloves were placed in a Petri dish and grown in 30 mL nanopure H₂O; (4) 5 cloves and 5 shredded cloves with 30 mL nanopure H₂O were added to a Petri dish; (5) 5 cloves and 5 shredded beans of P. vulgaris with 30 mL nanopure H₂O were added to a Petri dish. The length of roots and shoots were measured daily for 12 days.

Statistical Analysis: The data were analyzed by SPSS 13.0 for Windows (SPSS, Inc., Chicago, Ill.). ANOVA with Duncan post-hoc analysis was used to compare the means of the control and treatment groups.

Results: Both shoot and root development of A. sativum was totally inhibited by shredded A. sativum cloves. The shredded beans of P. vulgaris had less significant impact on A. sativum growth.

### Example 40

Elimination and Inhibition of Water Hyacinth (Eichhornia crassipes (Mart.) Solms) by Its EtOH Extracts

General Experimental Procedures:

Extract Preparation: The whole plants of water hyacinth (Eichhornia crassipes (Mart.) Solms) (Pontederiaceae) were collected from Lake Sam Rayburn, Tex. The plants were dried in an oven at 65° C. for 48 h. 2,400 g of dried plant matter was ground to a coarse powder and extracted two times for 48 h each with 95% EtOH (15 L and 12 L, respectively) at RT. The combined EtOH extracts were concentrated under reduced pressure and a total of 104 g extracts were obtained. 60 g extracts were dissolved and suspended in water and prepared as 600 mL experimental solutions with nanopure H₂O at the concentration of 10% extracts with 0.25% Dyne-Amic® (Helena Chemical Company, Collierville, Tenn., United States) (v:v) and 0.125% Kinetin® (Helena Chemical Company, Collierville, Tenn., United States) (v:v).

Foliar Sprays: Each of the six containers had three healthy mature plants of water hyacinth in 25 L of tap water in the greenhouse (30° C. during the day and 20° C. at night). Three containers served as controls without any treatment, and the other three received foliar application of 10% EtOH extracts of water hyacinth with surfactants in the amount of 30 mL each. For these three treatment containers, each had two additional treatments in the same amount on the second and third weeks. Foliar application of 90 mL 10% EtOH extracts of water hyacinth with surfactants was also made on S. molesta (at the tertiary stage) and seedlings of sweetgum (L. styraciflua) and swamp chestnut oak (Q. michauxii), bald cypress (T. distichum), and loblolly pine (P. taeda). The plant status was documented and photographed daily after the treatment.

Results: During the experiments, E. crassipes plants in control grew well. After treatment by EtOH extracts of E. crassipes with surfactants, E. crassipes plants had significant injury. By the end of the third week, most leaves and spongy and bulbous stalks of E. crassipes were dead. The extracts did not show inhibition activity on any other test species.

### Example 41

Inhibition on Seed Germination of Sorghum (Sorghum bicolor (L.) Moench) by Its Seed EtOH Extracts

General Experimental Procedures:

Extracts Preparation: The 2 kg of seeds of sorghum (Sorghum bicolor (L.) Moench) (Poaceae) were purchased from Wicked Whitetails (Elko, Minn., United States). 1 kg seeds were dried in an oven at 65° C. for 48 h. The dried plant matter was ground to a coarse powder and extracted two times for 48 h each with 95% EtOH (6 L and 12 L, respectively) at RT. The combined EtOH extracts were concentrated under reduced pressure and a total of 52 g extracts were obtained. 3 g extracts were dissolved and suspended in nanopure H₂O and prepared as 60 mL experimental solutions at the concentration of 5% extracts. 6 g extracts were dissolved and suspended in nanopure H₂O and prepared as 60 mL experimental solutions at the concentration of 10% extracts.

Extracts Yield of Experimental Seeds: Based on the seed weight and extraction rate (5.2%, in fresh weight) of the above extraction method, it is estimated that the plant matter used in the soaking treatment (300 S. bicolor seeds) could produce 0.36 g EtOH extracts. To further reveal the actual amount of the EtOH extracts contained in the plant matter, a more effective extraction of a small sample (6.9 g) was performed using a ASE 2000 Accelerated Solvent Extractor (60° C., 1500 psi, 30 min static time, 100% volume flush, 120 s purge, and 2 cycles). According to this extraction rate, 300 S. bicolor seeds contain at least 0.4 g EtOH extracts.

Soaking Treatments and Germination Tests: All experiments were conducted under RT. 2,700 sound seeds were selected and placed in nine Petri dishes with 300 seeds each. The seeds in each Petri dish were subjected to one of the following three treatments for 72 hours with three replications per treatment: soaked with 20 mL nanopure H₂O (control), soaked with a 20 mL 5% solution of EtOH extracts of S. bicolor seeds (1 g extract), and soaked with a 20 mL 10% solution of EtOH extracts of S. bicolor seeds (2 g extracts). The seed germination was surveyed 72 h after the treatment.

Statistical Analysis: The data were analyzed by SPSS 13.0 for Windows (SPSS, Inc., Chicago, Ill.). ANOVA with Duncan post-hoc analysis was used to compare the means of the control and treatment groups.

Results: The germination rates of S. bicolor seeds significantly decreased with the increasing concentration of the EtOH extracts of S. bicolor seeds. After 72 h of soaking treatment, 93.7% (±1.35), 56.1% (±2.7), and 18.0% (±3.48%) of seeds had germinated in the treatment of water, 5% EtOH extracts of S. bicolor seeds, and 10% EtOH extracts of S. bicolor seeds, respectively.

### Example 42

Phytotoxicity of EtOH Extracts of Sorghum (Sorghum bicolor (L.) Moench) on Sorghum

General Experimental Procedures:

Extracts Preparation: The seeds of sorghum (Sorghum bicolor) were collected from Nacogdoches, Tex., United States. The seeds were sowed in pots in the greenhouse (30° C. during the day time and 20° C. at night). The whole plants of six three-month-old seedlings (before flowering) were harvested and dried in an oven at 65° C. for 48 h. 80 g dried ground matter of S. bicolor was extracted 3 times for 48 h each with 95% EtOH (2.5 L each time) at RT. The combined EtOH extracts were concentrated under reduced pressure and a total of 4.4 g extracts were obtained. 1 g extracts were dissolved and suspended in nanopure H₂O and prepared as 20 mL experimental solutions at the concentration of 5% extracts.

Bioassays: Four-month-old S. bicolor seedlings were tested for phytotoxicity assays in the greenhouse. Also, three other species of Poaceae, including mature plants of A. donax and P. aurea were tested in the field. The experimental solution of 5% S. bicolor extracts was applied on upper and lower surfaces of leaves (three spots each side per leaf, three leaves per plant) of three plants of each species by pipet at the dosage of 10 μL each spot. Three untreated leaves per plant served as controls. The leaf surfaces of the experimental plants were checked daily for two weeks by a ×60 portable microscope linked to an iPhone™.

Results: By the end of the experiment, each of the testing S. bicolor leaf spot and its surrounding area (2-3 times of the spot in size each) were significantly damaged by 5% S. bicolor extracts on either upper or low surface and about 30% of the test leaf spots of S. halepense were somewhat damaged by the application on lower leaf surfaces. About 25.9% of A. donax leaf spots treated with 5% S. bicolor extracts on upper leaf surfaces were somewhat damaged but damage was primarily limited to the treating spot. The S. bicolor extracts had no effects on the leaves of S. halepense when applied on upper leaf surfaces, A. donax on lower leaf surfaces, and P. aurea on either upper or lower surfaces.

### Example 43

Inhibition of Johnsongrass (Sorghum halepense (L.) Pers.) by its EtOH Extracts General Experimental Procedures:

Extract Preparation: (1) Extracts for Foliar Treatment: The whole plants of Johnsongrass (Sorghum halepense) were collected from Nacogdoches, Tex. The plants were dried in an oven at 65° C. for 48 h. 3,600 g of dried plant matter was ground to a coarse powder and extracted two times for 48 h each with 95% EtOH (20 L and 12 L, respectively) at RT. The combined EtOH extracts were concentrated under reduced pressure and the total 110 g extracts were obtained. 30 g extracts were dissolved and suspended in nanopure H₂O and prepared as 100 mL experimental solutions at the concentration of 10% with 1% Tergitol® 15-S-9 (Sigma-Aldrich Co., St. Louis, Mo., United States) (v:v). (2) Extracts for Bioassays: 800 g dried ground matter of S. halepense was extracted 3 times for 48 h each with 95% EtOH (3 L each time) at RT. The combined EtOH extracts were concentrated under reduced pressure and a total of 46 g extracts were obtained. 1 g extracts were dissolved and suspended in nanopure H₂O and prepared as 20 mL experimental solutions at the concentration of 5% extracts.

Foliar Sprays: Three S. halepense plants were sprayed with 10 mL of the experimental solution twice each. The plant status was documented and photographed weekly after the treatment.

Bioassays: The phytotoxicity experiment for four species of Poaceae was conducted in the greenhouse (30° C. during the day time and 20° C. at night) or field. Four-month-old S. bicolor seedlings in the greenhouse and mature plants of A. donax, P. aurea, S. bicolor, and S. halepense in the field were selected for the bioassays. The experimental solution of 5% S. halepense extracts was applied on upper and lower surfaces (three spots each side per leaf, three leaves per plant) of three plants each species by pipet at the dosage of 10 μL each spot. Three untreated leaves per plant served as controls. The leaf surfaces of the experimental plants were checked daily for two weeks by a ×60 portable microscope linked to an iPhone™.

Results: The S. halepense plants showed significant injury to the leaves within two weeks after the foliar treatment with S. halepense extracts and no new growth was observed during the six weeks of investigation. In bioassays, S. halepense extracts showed toxicity on S. halepense and S. bicolor within 48 h. All leaf spots and their surrounding areas (usually 5 times or more of the spot in size each) were significantly damaged by the application of S. halepense extracts. S. halepense extracts did not show any effects on either A. donax or P. aurea.

### Example 44

Inhibition of Giant Reed (Arundo donax L.) by Its EtOH Extracts

General Experimental Procedures:

Extracts Preparation: The rhizomes of giant reed (Arundo donax L.) (Poaceae) was collected from Nacogdoches, Tex., United States. The plant matter was dried in an oven at 65° C. for 48 h. 3.5 kg dried plant matter was ground to a coarse powder and extracted three times for 48 h each with 95% EtOH (10 L each time) at RT. The combined extracts were concentrated to yield 53 g under reduced pressure. 1.25, 2.5, and 5 g A. donax extracts were dissolved and suspended in nanopure H₂O separately and prepared as 100 mL experimental solutions at the concentration of 1.25, 2.5, and 5% (v:v), respectively. 15 g A. donax extracts were dissolved and suspended in nanopure H₂O and prepared as 150 mL experimental solutions at the concentration of 10% (v:v).

Foliar Sprays: Each of three plants of A. donax in the field were sprayed with 15 mL 10% A. donax EtOH extracts and three plants received no treatment. The plant status was documented and photographed daily after the treatment.

Bioassays: 15 plants of A. donax in the field were selected for the experiment. Each concentration of 1.25, 2.5, 5, and 10% A. donax EtOH was applied on three spots of both the upper surface and lower surface of each of the three randomly selected mature leaves per plant by pipet at the dosage of 10 μL each spot. Three untreated plants served as controls. The leaf surfaces of the experimental plants were checked daily for two weeks by a ×60 portable microscope linked to an iPhone™.

Results: Leaves of A. donax treated with A. donax extracts at 2.5% or above concentrations showed some damage within 24 h of treatment in both foliar spray and bioassays of intact plants. By the of the two week experiment, the tissues in each leaf spot and its surrounding area (several times of the spot in size each) treated by all concentrations of A. donax extracts on either upper or low surface were totally killed.

### Example 45

Inhibition of Golden Bamboo (Phyllostachys aurea Carr. ex A. & C. Rivière) by Its EtOH Extracts

General Experimental Procedures:

Extracts Preparation: The aerial part of plants of golden bamboo (Phyllostachys aurea Rivière & C.Rivière) (Poaceae) was collected from Nacogdoches, Tex., United States. The plant matter was dried in an oven at 65° C. for 48 h. 800 g dried plant matter was ground to a coarse powder and extracted two times for 48 h each with 95% EtOH (8 L each time) at RT. The combined EtOH extracts were concentrated under reduced pressure and a total of 25.6 g extracts were obtained. EtOH extracts of giant reed (A. donax) were from the experiment of Example 44. 15 g P. aurea and A. donax extracts were separately dissolved and suspended in nanopure H₂O and prepared as 150 mL experimental solutions at the concentration of 5% (v:v).

Cut Stump (Culm) Treatments: Nine P. aurea plants with about 5 cm in culm diameter were cut down at about 100 cm above the ground. Three culms without treatment were used as control. Three culms were treated with A. donax EtOH extracts onto the cut culms at the amount of 5 mL per culm. The remaining three culms were treated with 10% P. aurea EtOH extracts onto the cut culms at the amount of 5 mL per culm. The plant status was evaluated and photographed weekly after the treatments.

Results: The culms in both control and A. donax extracts treatment had no observable changes a week after the treatments. By the same time, all three culms treated with P. aurea EtOH extracts had significant damage. The tissues in the first nodes from the culm cut and adjacent 2-3 cm areas in this treatment turned from normal green into brown and soon died.

### Example 46

Elimination and Inhibition of Proliferating Bulrush (Isolepis prolifera (Rottb.) R. Br.) by Its EtOH Extracts

General Experimental Procedures:

Extracts Preparation: Whole plants of proliferating bulrush (Isolepis prolifera (Rottb.) R. Br.) (Cyperaceae) were collected from Texas, United States. The plants were dried in an oven at 65° C. for 48 h. 12 g dried plant matter was ground to a coarse powder and extracted two times for 48 h each with 95% EtOH (150 mL each time) at RT. The combined EtOH extracts were concentrated under reduced pressure and a total 0.72 g extracts were obtained. 0.7 g extracts were dissolved and suspended in nanopure H₂O and prepared as 14 mL experimental solutions at the concentration of 5% (v:v).

Foliar Sprays: One plot (35 cm×15 cm) of plants of I. prolifera was sprayed with 14 mL of the extracts by foliar spray. The plant status was documented and photographed weekly after the treatment.

Results: The terminal shoots of all testing plants of I. prolifera turned brown and lost viability to reproduce and about 40% were dead within two weeks of the treatment with I. prolifera extracts.

### Example 47

Elimination and Inhibition of American Grasshopper (Schistocerca americana Drury) by its EtOH Extracts

General Experimental Procedures:

Extracts Preparation: Adults of American grasshopper (Schistocerca americana Drury) were collected from Nacogdoches, Tex. The whole insects were frozen for 6 h and then were dried in an oven at 65° C. for 48 h. The dried insects (64 g) were ground to a coarse powder and extracted two times for 48 h each with 95% EtOH (0.7 L and 0.5 L, respectively) at RT. The combined EtOH extracts were concentrated under reduced pressure and a total of 3.5 g grasshopper extracts were obtained. 2.25 g extracts were dissolved and suspended in nanopure H₂O and prepared as 22.5 mL experimental solution at the concentration of 10% extracts.

Bioassays: The experiment included 60 living grasshopper adults, cultured and treated in plastic containers (34×27 cm) in the laboratory at RT. 30 grasshoppers served as control with 10 insects in each of the three containers and the insects in each control container were sprayed with 7.5 mL of H₂O only. 30 grasshoppers with 10 insects in each of the three containers were sprayed with 7.5 mL of 10% EtOH extracts. In both control and treatment containers, insects were fed with lettuce purchased from the local grocery store. Survival status was documented and photographed daily after the treatment.

Results: All 30 S. americana in control survived for seven days. In all three treatment replications, however, all S. americana quickly responded to 10% EtOH S. americana extracts. The insects became inactive soon after the treatments and all were dead within 24 h.

### Example 48

Elimination and Inhibition of Mealworm (Tenebrio molitor L.) and Superworm (Zophobas morio Fabricius) Larvae by Their EtOH Extracts

General Experimental Procedures: The experimental larvae of both T. molitor and Z. morio were purchased from reptilefood.com.

Preparation of T molitor extracts: Lot T15813: 550 T. molitor larvae (51.4 g in fresh weight) were dried in an oven at 55° C. for 24 h to obtain 15.2 g dried matter. The dried matter was ground to a coarse powder and extracted three times for 24 h each with 100 mL 95% EtOH each time at RT. The combined EtOH extracts were concentrated under reduced pressure to produce 1.47 g extracts with the yield of about 2.7 mg extracts per worm.

Preparation of T. molitor extracts: Lot T15911: 1,500 T. molitor larvae (118.7 g in fresh weight) were dried in an oven at 55° C. for 24 h to obtain 55.2 g dried matter. The dried matter was ground to a coarse powder and extracted three times for 24 h each with 100 mL 95% EtOH each time at RT. The combined EtOH extracts were concentrated under reduced pressure to produce 5.67 g extracts with the yield of about 3.8 mg extracts per worm.

Preparation of Z. morio extracts: Lot Z15721: 100 Z. morio larvae (66.14 gin fresh weight) were dried in an oven at 55° C. for 24 h to obtain 24.2 g dried matter. The dried matter was ground to a coarse powder and extracted three times for 24 h each with 100 mL 95% EtOH each time at RT. The combined EtOH extracts were concentrated under reduced pressure to produce 2.03 g extracts with the yield of about 20.3 mg extracts per worm.

Preparation of Z. morio extracts: Lot Z15911: 300 Z. morio larvae (61.2 gin fresh weight) were dried in an oven at 55° C. for 24 h to obtain 27.5 g dried matter. The dried matter was ground to a coarse powder and extracted three times for 24 h each with 100 mL 95% EtOH each time at RT. The combined EtOH extracts were concentrated under reduced pressure to produce 2.59 g extracts with the yield of about 8.63 mg extracts per worm.

Spray experiment of T. molitor extracts (T15813): 360 mg T molitor extracts were dissolved and suspended in H₂O and prepared as 7.2 mL experimental solution at the concentration of 5% extracts. The larvae of T. molitor (T15813) and Z. morio (Z15721) were cultured separately in plastic containers fed with fresh apples purchased from the local grocery store. 90 larvae of each species were sprayed with 3.6 mL H₂O only to serve as controls. 90 larvae of each species were sprayed with 3.6 mL of 5% T. molitor extracts (2 mg T. molitor extracts per worm). Survival status of each worm was documented and photographed 24 h after the treatment.

Dermal contact experiment of T. molitor and Z. morio extracts: Randomly selected 10 active larvae of T. molitor or Z. morio cultured in a petri dish were subjected to one of the following applications on the worm body with a pipettor: 10 μL H₂O per worm (control), 1, 2, 3, 5, 10, or 20 mg T. molitor extracts (T15813 or T15911) or Z. morio extracts (Z15721 or Z15911) per worm of T. molitor and Z. morio. Each experiment had three replications. Survival status of each worm was documented and photographed 24 h after the treatment.

Impact of T. molitor extracts (T15813) on red imported fire ant: Red imported fire ants (S. invicta) were collected at Nacogdoches, Tex., United States. 1,000 ants (approximately 1 g in fresh weight) were put in 5 L plastic beaker and sprayed with 1 mL 5% T. molitor extracts. Another 1,000 ants in 5 L plastic beaker were sprayed with nanopure H₂O as control. The ant viability of the treatment and control were observed for 24 h.

Statistical Analysis: The data were analyzed by SPSS 13.0 for Windows (SPSS, Inc., Chicago, Ill.). ANOVA with Duncan post-hoc analysis was used to compare the means of the control and treatment groups.

Results: During these experiments, all worms of each species in control were actively alive at 24 h after the treatment. By the same time, 35.6% of T. molitor and 10% of Z. morio worms that were sprayed with 3.6 mL 5% T. molitor extracts were dead. The spray dosage (2 mg per worm or 21.4 μg per mg of fresh worm body weight) was lower than the extraction yield per T. molitor worm (2.7 mg). During the 24 h of dermal contact experiments, the larvae of each species was more susceptible to its own extracts than to the other at the same dosage. In response to the extracts of the same species, larval fatality of each species increased with application dosage. 33-40% of T molitor and 37-97% of Z. morio were dead when treated with the same species extracts at the dosage equivalent to the extraction yield per worm. Effects of the extracts also depend on the body weight of the testing worm. Adult beetles of T. molitor were also susceptible to the extracts of both species, particularly at higher dosage (5 mg per worm). The 5% T. molitor extracts (at the dosage of 50 μg per mg of fresh ant body weight, about 2.34 times of spray dosage in T. molitor) had no effects on viability of the red imported fire ant (S. invicta) compared with the control experiment during the 24 h of observation.

### Example 49

### Growth Differences of Four Aquatic Plant Species in Water Culture of Pure Population and in Mixed Population

General Experimental Procedures:

Bioassay: The experiments were conducted in greenhouse (30° C. during the day time and 20° C. at night) with four aquatic plant species that are non-closely related species to each other but often grow together in nature. The healthy plants of giant salvinia (S. molesta) (10 g primary stage and 100 g tertiary stage), water lettuce (P. stratiotes) (20 g), water hyacinth (E. crassipes) (100 g), and Parrot feather (Myriophyllum aquaticum (Vell.) Verdc., Haloragaceae) (50 g) were cultured with only plants of the same species (pure culture) or mixed population in containers with 25 L tap water for 3 months. Each experiment had three replications for a total 15 containers. By the end of three months, biomass of living plants in each container was measured.

Statistical Analysis: The data were analyzed by SPSS 13.0 for Windows (SPSS, Inc., Chicago, Ill.). ANOVA with Duncan post-hoc analysis was used to compare the means of the control and treatment groups.

Results: During the three months of observation, all species of P. stratiotes, E. crassipes, and M. aquaticum experienced significant decrease in living biomass in pure culture. S. molesta had growth in living biomass possibly because of the addition of 10 g of primary stage plants which were shown to be less affected by salvinia endocide than plants in the tertiary stage. During the three months of experiments, living biomass of S. molesta, water lettuce (P. stratiotes L., Araceae), water hyacinth (Eichhornia crassipes (Mart.) Solms, Pontederiaceae), and Parrot feather (Myriophyllum aquaticum (Vell.) Verdc., Haloragaceae) in the mixed culture of four species increased by 76.2%, 127.6%, 133.3%, and 664%, respectively, in comparison to plants in pure, single species culture.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents that are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
Ascunce, et al., “Global invasion history of the fire ant Solenopsis invicta.” Science. 331:1066-1068, 2011.
Barrett, “Waterweed invasions.” Sci. Amer. 261:90-97, 1989.
Bennett, “Glyphosate-resistant Johnsongrass in Mid-South.” ed: Delta Farm Press, 2008.
Burks, “Nymphoides cristata-Snowflakes in sunny Florida.” Aquatics. 8-10, 2002.
Capinera, “Differentiation of nymphal instars in Schistocerca americana (Orthoptera: Acrididae).” Florida Entomol. 76:175-9, 1993.
D'Abrosa, et al., “Structure elucidation and phytotoxicity of C13 nor-isoprenoids from Cestrum parqui.” Phytochemistry 65:497-505, 2004.
DellaGreca, et al., “Isolation and phyototococity of apocarotenoids from Chenopodium album.” J. Nat. Prod. 67:1492-1495, 2004.
Ding, et al., “Assessing potential biological control of the invasive plant, tree-of-heaven, Ailanthus altissima.” Biocontrol Sci. Technol. 16:547-66, 2006.
Everest, et al., “Kudzu in Alabama: history, uses, and control” Alabama Cooperative Extension System; 1999.
Greenlee & Harrison, “Development of respiratory function in the American locust Schistocerca americana I. Across-instar effects.” J. Exper. Biol. 207:497-508, 2004.
Hanula, et al., “Chinese privet (Ligustrum sinense) removal and its effect on native plant communities of riparian forests.” Invasive P1 Sci Manag. 2:292-300, 2009.
Harrington & Miller, “Effects of application rate, timing, and formulation of glyphosate and triclopyr on control of Chinese privet (Ligustrum sinense).” Weed Technol. 19:47-54, 2005.
Kunz, et al., “Warm-season forages for free-ranging white-tailed deer in south Texas.” Texas J. Agric. Nat. Resour. 22:7-16, 2009.
Leonard, “Monsanto's bane: the evil pigweed.” Salon Com, 2008.
Li, et al., “Cytotoxic compounds from invasive giant salvinia (Salvinia molesta) against human tumor cells.” Bioorg. Med. Chem. Lett. 23:6682-6687, 2013.
Lorenzi & Jeffery, “Weeds of the United States and Their Control,” Van Nostrand Reinhold Company Inc., New York, 1987. McWhorter, “History, biology, and control of johnsongrass.” Rev. Weed Sci. 4:85-121, 1989. Merrill, Flora of North America 2007.
Mitchell, “Surface-floating aquatic macrophytes.” In: Denny P, editor. The ecology and management of African wetland vegetation. Dordrecht: Dr. W. Junk Publishers; p. 109-24, 1985.

Mitchell, et al., “Managing yaupon with fire and herbicides in the Texas post oak savannah.” Publications from USDA-ARS/UNL Faculty. Paper 201; 2005.
Mosyakin & Robertson, Flora of North America, 2004.
Pérez, et al., “Absolute structures of two new C₁₃-norisoprenoids from Apollonias barbujana. J. Nat. Prod. 59:69-72, 1996.
Powles, “Evolved glyphosate-resistant weeds around the world: lessons to be learnt.” Pest Manag. Sci. 64:360-5, 2008.
Squitier, “American grasshopper, Schistocerca americana (Drury)” (Insects: Orthoptera: Acrididae). In: Extension UoFI, editor. 2005.
Tveten & Tveten, “Wildflowers of Houston & Southeast Texas,” University of Texas Press, Austin, 1997.
Vila-Aiub, et al., “Evolution of glyphosate-resistant Johnsongrass (Sorghum halepense) in glyphosate-resistant soybean.” Weed Sci. 55:566-71, 2007.
Wenger, “The sprouting of sweetgum in relation to season of cutting and carbohydrate content.” Pl. Physiol. 28(1):35-49, 1953.
Willey & Langeland, “Aquatic Weeds: Crested floating heart (Nymphoides cristata).” In: Extension UoFI, editor 2011.

1.-54. (canceled)

55. A method of controlling an unwanted species comprising applying a composition comprising an endocide to the species, a derivative thereof, and/or an analogue thereof, wherein the endocide is derived from the same unwanted species and/or a closely related species.

56. The method of claim 55, wherein the unwanted species is resistant to a pesticide, herbicide, drug, or chemical treatment used to control the species.

57. The method of claim 55, wherein growth is halted, reproduction is halted, spread is halted, and/or the unwanted species is eliminated.

58. The method of claim 55, wherein the endocide is a natural pesticide.

59. The method of claim 55, wherein the endocide is fresh matter, dry matter, decomposed matter, a liquid part, a water extract, an aqueous extract, an organic extract, a dry extract, a solubilized extract, or a fraction or derivative thereof of the unwanted species and/or a closely related species.

60. The method of claim 55, wherein the growth, reproduction, or spread is halted within 1 month and/or is halted for at least 1 year.

61. The method of claims 55, wherein the composition comprising the endocide is applied topically to an unwanted species, sprayed onto an unwanted species, spread around an unwanted species, and/or dissolved in water surrounding an unwanted species.

62. The method of claim 61, wherein the composition is applied to a trichome of an unwanted plant species.

63. The method of claim 55, wherein the composition contains about 0.01 to about 0.5% by weight of the endocide.

64. The method of claim 55, further comprising applying a secondary agent.

65. The method of claim 64, wherein the secondary agent is an endocide from a second species.

66. The method of claim 55, wherein the endocide is,6,7,8-tetramethoxycoumarin and/or a compound of a formula selected from a group consisting of:

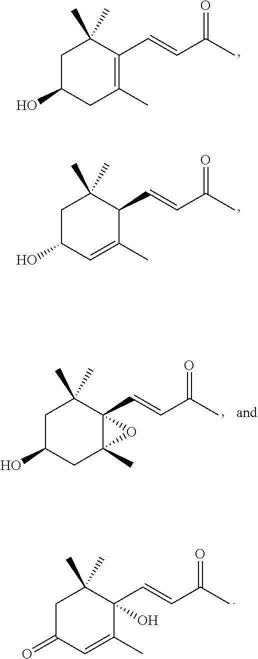

67. A composition for controlling an unwanted species comprising an endocide, wherein the endocide is derived from the same species and/or a closely related species.

68. The composition of claim 67, wherein the unwanted species is resistant to a pesticide, herbicide, drug, or chemical treatment used to control the species.

69. The composition of claim 67, wherein the endocide is a natural pesticide.

70. The composition of claim 67, wherein the endocide is fresh matter, dry matter, decomposed matter, a liquid part, a water extract, an aqueous extract, an organic extract, a dry extract, a solubilized extract, or a fraction or derivative thereof of the unwanted species and/or a closely related species.

71. The composition of claim 67, wherein the endocide is 5,6,7,8-tetramethoxycoumarin and/or a compound of a formula selected from a group consisting of:

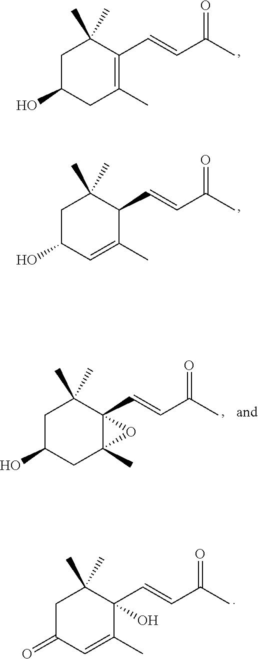

72. The composition of claim 67, wherein the endocide is a derivative and/or an analogue of a naturally occurring endocide.

73. The composition claim 67, wherein the composition further comprises a secondary agent.

74. A compound of a formula selected from a group consisting of:: [chemical structure]
